(19) United States
(12) Patent Application Publication
(10) Pub. No.: US 2008/0228470 A1
(43) Pub. Date: Sep. 18, 2008

(54) Signal separating device, signal separating method, and computer program

(76) Inventor: Atsuo Hiroe, Kanagawa (JP)

Correspondence Address: William S. Frommer, Esq.;FROMMER LAWRENCE & HAUG LLP, 745 Fifth Avenue, New York, NY, 10151, US

(21) Appl. No.: 12/070,496

(22) Filed: Feb. 19, 2008

(30) Foreign Application Priority Data
Feb. 21, 2007 (JP) 2007-041455
Dec. 20, 2007 (JP) 2007-328516

(51) Int. Cl. G10L 11/00; G10L 21/00

(52) U.S. Cl. 704/200; 704/203; 704/E21.001; 704/E11.001

(57) ABSTRACT

A signal separating device that is inputted with signals formed by mixing plural signals and separates the signals into individual signals includes a signal converting unit that converts input signals into signals in the time-frequency domain and generates observation spectrograms and a signal separating unit that generates separated results from the observation spectrograms generated by the signal converting unit. The signal separating unit interprets the observation spectrograms as observation signals subjected to convolutive mixtures in the time-frequency domain and generates separated results by executing processing for solving convolutive mixtures in the time-frequency domain.

### CROSS-REFERENCES TO RELATED APPLICATIONS

The present invention contains subject matter related to Japanese Patent Applications JP 2007-041455 and JP 2007-328516 filed in the Japanese Patent Office on Feb. 21, 2007 and Dec. 20, 2007, respectively, the entire contents of which being incorporated herein by reference.

### BACKGROUND OF THE INVENTION

1. Field of the Invention

The present invention relates to a signal separating device, a signal separating method, and a computer program, and, more particularly to a signal separating device, a signal separating method, and a computer program for separating a signal formed by mixing plural signals into the respective signals using an independent component analysis (ICA).

2. Description of the Related Art

A method of an independent component analysis (ICA) for separating and restoring, when plural original signals are linearly mixed with unknown coefficients, the original signals using only statistical independence attracts attention in the field of signal processing. By applying this independent component analysis, for example, even in a situation in which a speaking person and a microphone are apart from each other and the microphone records sound other than voice of the speaking person, it is possible to separate and restore sound signals.

The ICA is a kind of multivariate analysis and means a method of separating multidimensional signals using a statistical characteristic of signals. Concerning details of the ICA, please refer to, for example, “Nyumon Dokuritsu Seibun Bunseki” (“An Introduction to the Independent Component Analysis”, Noboru Murata, Tokyo Denki University Press).

First, a method of separating, in the time-frequency domain, signals formed by mixing plural signals (in particular, sound signals) using the independent component analysis in the time-frequency domain is explained. Then, problems of the method are explained. As shown in FIG. 1, there is a situation in which different sounds are emitted from N sound sources (signal sources) and are observed with n microphones (sensors). When the sounds (original signals) emitted from the plural sound sources reach the microphones, the sounds acquired by the microphones include direct waves and reflected waves and time delays and the like based on distances between the respective sound sources and the microphones occur. Therefore, signals observed with certain one microphone j (1≦j≦n) (observation signals) are represented as an equation formed by summing up convolutions between original signals and transfer functions for all the sound sources as indicated by Equation [1.1] shown below (hereinafter referred to as “convolutive mixtures”). Observation signals for all the microphones 1 to n are represented by one equation as indicated by Equation [1.2] below. Here, x(t) and s(t) are column vectors having xₖ(t) and sₖ(t) as elements, respectively. A^{[1]} is an n×N matrix having aₖⱼ as an element (in the following explanation, n=N).

$$\begin{matrix}{x}_{k} ( t ) = {\sum }_{j = 1}^{N} {\sum }_{l = 0}^{L} {a}_{kj} ( l ) {s}_{j} ( t - l ) = {\sum }_{j = 1}^{N} \{ {a}_{kj} * {s}_{j} \} & [ 1.1 ] \\ x ( t ) = {A}^{[ 0 ]} s ( t ) + … + {A}^{[ L ]} s ( t - L ) & [ 1.2 ]\end{matrix}$$

with the proviso

$$s ( t ) = [ \begin{matrix}{s}_{1} ( t ) \\ ⋮ \\ {s}_{N} ( t )\end{matrix} ] , x ( t ) = [ \begin{matrix}{x}_{1} ( t ) \\ ⋮ \\ {x}_{n} ( t )\end{matrix} ] , {A}^{[ l ]} = [ \begin{matrix}{a}_{11} ( l ) & … & {a}_{1 N} ( l ) \\ ⋮ & ⋰ & ⋮ \\ {a}_{n 1} ( l ) & … & {a}_{nN} ( l )\end{matrix} ] \qquad [ 1.3 ]$$

As a method of solving such convolutive mixtures, the following two methods are known:

(1) a method of directly solving convolutive mixtures in the time domain (time domain deconvolution); and
(2) a method of converting an observation signal into the time-frequency domain and solving convolutive mixtures as an instantaneous mixing problem.

The respective methods are explained below.

(1) The method of directly solving convolutive mixtures in the time domain (time domain deconvolution)

In order to solve the convolution of Equation [1.2], an equation of convolutive mixtures of observation signals like Equation [2.1] shown below is prepared.

$$\begin{matrix}y ( t ) = {W}^{[ 0 ]} x ( t ) + … + {W}^{[ {L}^{′} ]} x ( t - {L}^{′} ) & [ 2.1 ] \\ Δ {W}^{[ τ ]} = {W}^{[ τ ]} + {R}^{[ 0 ]} {W}^{[ τ ]} + … + {R}^{[ τ ]} {W}^{[ 0 ]} & [ 2.2 ] \\ {R}^{[ l ]} = {E}_{t} [ ϕ ( t ) {y ( t - l )}^{T} ] & [ 2.3 ] \\ {W}^{[ τ ]} ← {W}^{[ τ ]} + ηΔ {W}^{[ τ ]} & [ 2.4 ]\end{matrix}$$

The equation of convolutive mixtures of observation signals like Equation [2.1] is prepared and separation matrixes W^{[0]} to W^{[L′]} are determined (in the following equations, W^{[0]} to W^{[L′]} are collectively referred to as separation filters) such that y₁(t) to yₙ(t), which are components of separated results y(t), are most independent over t. For this purpose, Equations [2.1] to [2.4] a reiterated until the separation matrix and the separated results converge (in the following explanation, such iteration is referred to as “learning”. An equation for updating the separation matrix, an equation for calculating ΔW, and the like are referred to as “learning rules”). In Equation [2.3], Eₜ[ ] represents a mean over t. φ of the equation is a function called a score function or an activation function. Concerning details of an equation for solving convolutive mixtures in the time domain, please refer to, for example, “Independent Component Analysis” (Aapo Hyvarinenn, et. al, 2001 John Wiley & Sons, Inc.), 19.2: Blind Separation of Convolutive Mixtures, 19.2.3: Natural Gradient Methods).

(2) The Method of Converting Observation Signals into the Time-Frequency Domain and Solving Convolutive Mixtures as an Instantaneous Mixing Problem

It is known that convolutive mixtures in the time domain are represented by instantaneous mixtures in the time-frequency domain. An analysis that makes use of the characteristic is an ICA (Independent Component Analysis) in the time-frequency domain. Concerning the time-frequency domain ICA itself, please refer to, for example, “Independent Component Analysis” (Aapo Hyvarinenn, et. al, 2001 John Wiley & Sons, Inc., 19.2. 4: “Fourier Transform Methods”) and JP-A-2006-238409 “APPARATUS AND METHOD FOR SEPARATING AUDIO SIGNALS”).

In the independent component analysis in the time-frequency domain, A and s(t) are not directly estimated from x(t) in Equation [1.2] but x(t) is converted in signals in the time-frequency domain and signals corresponding to A and s(t) are estimated in the time-frequency domain. In the following explanation, points related to the present invention are mainly explained. When both sides of Equation [1.2] are subjected to short-time Fourier transform, Equation [3.1] shown below is approximately obtained. Signal vectors x(t) and s(t) subjected to short-time Fourier transform with a window having length L are represented as X(ω,t) and S(ω,t), respectively, and a matrix A(t) subjected to short-time Fourier transform is represented as A(ω). Then, Equation [1.2] in the time domain can be represented by Equation [3.1] in the time-frequency domain shown below. Here, ω indicates the frequency bin index (1≦ω≦M) and t indicates the frame index (1≦t≦T). In the independent component analysis in the time-frequency domain, S(ω,t) and A(ω) in Equation [3.1] are estimated in the time-frequency domain.

$$\begin{matrix}X ( ω , t ) = A ( ω ) S ( ω , t ) & [ 3.1 ] \\ X ( ω , t ) = [ \begin{matrix}{X}_{1} ( ω , t ) \\ ⋮ \\ {X}_{n} ( ω , t )\end{matrix} ] & [ 3.2 ] \\ A ( ω ) = [ \begin{matrix}{A}_{11} ( ω ) & … & {A}_{1 n} ( ω ) \\ ⋮ & ⋰ & ⋮ \\ {A}_{n 1} ( ω ) & … & {A}_{nn} ( ω )\end{matrix} ] & [ 3.3 ] \\ S ( ω , t ) = [ \begin{matrix}{S}_{1} ( ω , t ) \\ ⋮ \\ {S}_{n} ( ω , t )\end{matrix} ] & [ 3.4 ] \\ Y ( ω , t ) = W ( ω ) X ( ω , t ) & [ 3.5 ]\end{matrix}$$

In Equation [3.1], ω is the frequency bin index and t is the frame index. When ω is fixed, this equation can be regarded as instantaneous mixtures. To separate observation signals, an equation like Equation [3.5] is prepared and a separation matrix W(ω) is determined such that respective components of Y(ω,t) are most independent.

The number of frequency bins is originally identical with the length L of the window. The frequency bins represent frequency components obtained by equally dividing a frequency −R/2 to R/2 (R is a sampling frequency) into L. A negative frequency component is a complex conjugate of a positive frequency component and can be calculated as X(−ω)=conj(X(ω)) (conj(·) is a complex conjugate). To estimate S(ω,t) and A(ω) in the time-frequency domain, first, an equation like Equation (4) shown below is considered. In Equation [3.5], Y(ω,t) represents a column vector having Yk(ω,t) obtained by subjecting yk(t) to short-time Fourier transform using the window having length L. W(ω) represents a matrix of n rows×n columns (a separation matrix) having wij(ω) as an element.

In the time-frequency domain ICA in the past, a problem in that “which component is separated into which channel” is different for each of frequency bins, i.e., a so-called permutation problem occurs. This problem has been nearly solved in JP-A-2006-238409 “APPARATUS AND METHOD FOR SEPARATING AUDIO SIGNALS”, which is a patent application by the inventor.

The present invention is a the oritical development of JP-A-2006-238409. Therefore, characteristics of JP-A-2006-238409 are explained below.

In the past, i.e., before the method described in JP-A-2006-238409 is disclosed, [3.5] as an equation for each of frequency bins is used as an equation for separation in the time-frequency domain and the separation matrix W[ω] for maximizing independence for each of frequency bins is calculated.

In other words, W(ω) with which Y1(ω,t) to Yn(ω,t) are statistically independent (actually, their independence is maximum) when ω is fixed and t is changed is calculated. As described later, there is indeterminacy of permutation and scaling in the independent component analysis in the time-frequency domain. Therefore, there is a solution other than W(ω)=A(ω)⁻¹. When statistically independent Y1(ω,1) to Yn(ω,t) are obtained for all ω's, it is possible to obtain separated signals y(t) in the time domain by subjecting Y1(ω, 1) to Yn(ω,t) to inverse Fourier transform.

An overview of the independent component analysis in the past in the time-frequency domain is explained. Source signals independent from one another emitted by n sound sources are represented as s1 to sn and a vector having the original signals as elements is represented as s. Observation signals x observed with a set of microphones are obtained by applying convolutive mixtures in Equation [1.2] to the original signal s. Short-time Fourier transform is applied to the observation signals x to obtain signals X in the time-frequency domain. When an element of X is represented as Xk(ω,t), Xk(ω,t) takes a complex value. A diagram representing |Xk(ω,t)|, which is the absolute value of Xk(ω,t), as shading of a color is called spectrogram. The spectrogram is, for example, a diagram representing |Xk(ω, t)|, which is the absolute value of Xk(ω,t), as shading of a color with the abscissa set as t (frame index) and the ordinate set as ω (a frequency bin number). Separated signals Y are obtained by multiplying respective frequency bins of the signals X with W(ω). Separated signals y in the time domain are obtained by subjecting the separated signals Y to inverse Fourier transform.

However, in the independent component analysis in the time-frequency domain described above, the separation processing for signals is performed for each of the frequency bins and a relation among the frequency bins is not taken into account. Therefore, even if the separation itself is successful, it is likely that inconsistency of scaling and inconsistency of separation destinations occur among the frequency bins. The inconsistency of scaling can be solved by a method of estimating observation signals for each of sound sources. On the other hand, the inconsistency of separation destinations means, for example, a phenomenon in which, whereas signals deriving from S1 appear in Y1 at ω=1, signals deriving from S2 appear in Y1 at ω=2. This is called a problem of permutation.

On the other hand, in JP-A-2006-238409, a method of calculating a separation matrix w, which maximizes independence in the whole spectrograms, using Equation [4.4] shown below, which is an equation representing separation in the whole spectrograms, is adopted.

$$\begin{matrix}X ( t ) = [ \begin{matrix}{X}_{1} ( 1 , t ) \\ ⋮ \\ {X}_{1} ( M , t ) \\ ⋮ \\ {X}_{n} ( 1 , t ) \\ ⋮ \\ {X}_{n} ( M , t )\end{matrix} ] = [ \begin{matrix}{X}_{1} ( t ) \\ ⋮ \\ {X}_{n} ( t )\end{matrix} ] & [ 4.1 ] \\ Y ( t ) = [ \begin{matrix}{Y}_{1} ( 1 , t ) \\ ⋮ \\ {Y}_{1} ( M , t ) \\ ⋮ \\ {Y}_{n} ( 1 , t ) \\ ⋮ \\ {Y}_{n} ( M , t )\end{matrix} ] = [ \begin{matrix}{Y}_{1} ( t ) \\ ⋮ \\ {Y}_{n} ( t )\end{matrix} ] & [ 4.2 ] \\ W = [ \begin{matrix}{w}_{11} ( 1 ) & & 0 & & {w}_{1 n} ( 1 ) & & 0 \\ & ⋰ & & ⋯ & & ⋰ & \\ 0 & & {w}_{11} ( M ) & & 0 & & {w}_{1 n} ( M ) \\ & ⋮ & & ⋰ & & ⋮ & \\ {w}_{n 1} ( 1 ) & & 0 & & {w}_{nn} ( 1 ) & & 0 \\ & ⋰ & & ⋯ & & ⋰ & \\ 0 & & {w}_{n 1} ( M ) & & 0 & & {w}_{nn} ( M )\end{matrix} ] & [ 4.3 ] \\ Y ( t ) = WX ( t ) & [ 4.4 ] \\ \begin{matrix}I ( Y ) = {\sum }_{k = 1}^{n} H ( {Y}_{k} ) - H ( Y ) \\ = {\sum }_{k = 1}^{n} {E}_{t} [ - log P ( {Y}_{k} ( t ) ) ] - log \vert det ( W ) \vert - H ( X )\end{matrix} & [ 4.5 ]\end{matrix}$$

Specifically, Kullback-Leiblar information I(Y) represented by Equation [4.5] is introduced as independence in all the spectrograms to calculate a separation matrix W that minimizes I(Y). As a scale for representing independence and an algorithm for maximizing independence in the independent component analysis, there are various variations. As one method of representing independence and maximizing independence, there is Kullback-Leiblar information (KL information). The Kullback-Leiblar information I(Y) is an amount obtained by subtracting joint entropy of all spectrograms from a sum of entropies for each of the spectrograms. When all the spectrograms are independent from one another, the KL information I(Y) is minimized (ideally, 0).

As described above, the KL information I(Y) is defined as indicated by Equation [4.5]. In Equation [4.5], H(Yₖ) represents entropy for one spectrogram concerning each of channels and H(Y) represents joint entropy for one spectrogram concerning all the channels. A relation between H(Yₖ) and H(Y) at the case n=2 is shown in FIG. 2. In FIG. 2, P(Yₖ(t)) is a probability density function of Yₖ(t) and H(Yₖ) is entropy for one spectrogram concerning each of channels. The KL information I(Y) is an amount obtained by subtracting joint entropy 13 of all the spectrograms from a sum of entropies 11 and 12 for each of the spectrograms. When all the spectrograms are independent from one another, the KL information I(K) is minimized (ideally, 0).

To minimize the KL information I(Y) in all the spectrograms, Equations [5.1] to [5.3] are repeated until W and Y converge.

$$\begin{matrix}Y ( t ) = WX ( t ) ( t = 1 , … , T ) & [ 5.1 ] \\ Δ W ( ω ) = \{ I + {E}_{t} [ {ϕ}_{ω} ( Y ( t ) ) {Y ( ω , t )}^{H} ] \} W ( ω ) & [ 5.2 ] \\ W ← W + ηΔ W & [ 5.3 ] \\ W ( ω ) = [ \begin{matrix}{w}_{11} ( ω ) & … & {w}_{1 n} ( ω ) \\ ⋮ & ⋰ & ⋮ \\ {w}_{n 1} ( ω ) & … & {w}_{nn} ( ω )\end{matrix} ] & [ 5.4 ] \\ Y ( ω , t ) = [ \begin{matrix}{Y}_{1} ( ω , t ) \\ ⋮ \\ {Y}_{n} ( ω , t )\end{matrix} ] & [ 5.5 ] \\ {ϕ}_{ω} ( T ( t ) ) = [ \begin{matrix}{ϕ}_{1 ω} ( Y ( t ) ) \\ ⋮ \\ {ϕ}_{n ω} ( {Y}_{n} ( t ) )\end{matrix} ] & [ 5.6 ] \\ {ϕ}_{k ω} ( {Y}_{k} ( t ) ) = \frac{\partial }{\partial {Y}_{k} ( ω , t )} log P ( {Y}_{k} ( t ) ) & [ 5.7 ]\end{matrix}$$

ΔW(ω), W(ω), and Y(ω,t) in Equation [5.3] are submatrixes obtained by extracting elements corresponding to the ωth frequency bin from ΔW, W, and Y(t), respectively. This makes it possible to obtain separated results without the permutation problem.

However, in the two method of solving convolutive mixtures:

(1) a method of directly solving convolutive mixtures in the time domain (time domain deconvolution); and
(2) a method of converting an observation signal into the time-frequency domain and solving convolutive mixtures as an instantaneous mixing problem,
there are problems described below.

(1) The Method of Directly Solving Convolutive Mixtures in the Time Domain (Time Domain Deconvolution)

This method has a problem in that convergence is slow. As a reason of the slow convergence, for example, the entire waveform changes when a coefficient of a separation filter changes or computational cost of an update formula of the separation filter is proportional to the square of the number of taps L′. Therefore, when the number of taps L′ of the separation filter is large, it is difficult to separate a signal in practical time unless a value as close as possible to a convergent value is calculated in advance as an initial value of the separation filter. To cope with reverberation in an actual environment, the number of taps at least in an order of several thousands is necessary. Therefore, computational cost of the square of several thousands is necessary in the method (1).

(2) The Method of Converting an Observation Signal into the Time-Frequency Domain and Solving Convolutive Mixtures as an Instantaneous Mixing Problem

In this method, there is a problem in that there is tradeoff between a window length of short-time Fourier transform (STFT) and separation accuracy. When observation signals include long reverberation, i.e., convolutive mixtures with a large number of taps, it is necessary to increase the window length of STFT (i.e., the number of taps) in order to represent the reverberation with instantaneous mixtures in the time-frequency domain. (When window length<reverberation length, since reverberation extends over plural frames, the reverberation may not be able to be represented by instantaneous mixtures.) However, it is known that, when the window length is set too long, separation accuracy falls. Concerning the tradeoff, please refer to, for example, the following documents:

JP-A-2003-271168 “METHOD, DEVICE AND PROGRAM FOR EXTRACTING SIGNAL, AND RECORDING MEDIUM RECORDED WITH THE PROGRAM”;

“Blind source separation using SSB Subbabd”, S. Araki, R. Aichner, S. Makino, T. Nishikawa, and H. Saruwatari, Acoustical Society of Japan Transaction, March 2002, pp. 619 to 620; and

“Optimization on the Number of Subband in Blind Source Separation with Subband ICA”, T. Nishikawa, S. Araki, S. Makino, and H. Saruwatari, Acoustical Society of Japan Transaction, March 2001, pp. 569 to 570.

The separation accuracy falls when the window length is set long because, as the window length set longer (i.e., the number of taps is set larger), a change in the temporal direction of a generated spectrogram, i.e., a change in a temporal envelope becomes more gentle. In the time-frequency domain ICA, observation signals are separated with attention directed to independence among envelopes. However, independence among gentle envelopes tends to be calculated rather low compared with independence among envelopes that suddenly change. In other words, it is likely that even envelopes deriving from different sound sources are judged as “being correlated”. As a result, the separation accuracy falls.

As described above, a problem in (2) the method of converting observation signals into the time-frequency domain and solving convolutive mixtures as an instantaneous mixing problem is that there is tradeoff between the window length of short-time Fourier transform (STFT) and the separation accuracy. A result of an experiment performed by the inventor concerning the tradeoff between the window length and the separation accuracy is described below. FIG. 3 is a graph in which a relation between the window length of STFT and the separation accuracy of the time-frequency domain ICA is plotted.

In FIG. 3, the abscissa indicates the window length (64, 128, 256, 512, 1024, 2048, and 4096) of STFT and the ordinate indicates signal-interference-ratio (SIR), which is a scale of the separation accuracy. A solid line indicates an SIR of a result obtained by separating observation signals using the method disclosed in JP-A-2006-238409 as (2) the method of converting observation signals into the time-frequency domain and solving convolutive mixtures as an instantaneous mixing problem (details of the experiment are described later). A graph in an upper part of FIG. 3 indicates an SIR on a waveform basis and a graph in a lower part of FIG. 3 indicates an SIR on a frequency bin basis. FIG. 4 is a graph representing the window length on the abscissa as an actual number of seconds. It is seen that there is a peak of the separation accuracy in the middle in both the graphs. (In the SIR on a waveform basis, there is a peak at the window length of 1024 and, in the SIR on a frequency bin basis, there is a peak at the window length of 512).

In the time-frequency domain ICA, there is a problem in that, even if the window of STFT is set long to cope with long reverberation, when the window length exceeds a certain degree, separation performance falls to the contrary.

In summary, in both the methods that are methods of the independent component analysis (ICA), i.e., (1) a method of directly solving convolutive mixtures in the time domain (time domain deconvolution) and (2) a method of converting observation signals into the time-frequency domain and solving convolutive mixtures as an instantaneous mixing problem, there is a problem in that the separation accuracy is insufficient for convolutive mixtures with a large number of taps.

There is Serviere, C. “Separation of speech signals under reverberant conditions” In Proc. EUSIPCO04, pp. 1693 to 1696 (2004) concerning a technique that discloses processing for coping with an assumption that when STFT is performed by using a window shorter than a reverberation length, convolution still remains on a spectrogram.

In Serviere, C. “Separation of speech signals under reverberant conditions” In Proc. EUSIPCO04, pp. 1693 to 1696 (2004), considering that observation signals are convolutive mixtures on the time-frequency domain, an algorithm of deconvolution in the time-frequency domain is proposed as a method of solving convolutive mixtures. This is processing close to the method of “directly solving convolutive mixtures in the time-frequency domain”. However, the algorithm disclosed in this document is limited to a case of two inputs and two outputs, i.e., two output sound sources for sound signals and two microphones as input units. In this document, separation and deconvolution are individually performed for each of frequency bins. A problem in that “which component is separated into which channel” is different for each of frequency bins, i.e., a so-called permutation problem occurs.

As described above, there are several techniques in the past that disclose processing for separating a sound signal formed by mixing plural signals. However, in the signal separation processing for realizing highly accurate separation processing for each of signals using the independent component analysis (ICA), under the present situation, sufficient measures against the problems (1) reverberation exceeding a window length (i.e., the length of an analysis frame), (2) the permutation problem, and (3) inputs and outputs more than two inputs and two outputs, have not been presented.

### SUMMARY OF THE INVENTION

Therefore, it is desirable to provide a signal separating device, a signal separating method, and a computer program that realize highly accurate separation processing for each of signals in sound signals formed by mixing plural signals using an independent component analysis (ICA). In particular, it is desirable to provide a signal separating device, a signal separating method, and a computer program in which separation accuracy for convolutive mixtures with a large number of taps is improved.

According to an embodiment of the present invention, there is provided a signal separating device that is inputted with a signal formed by mixing plural signals and separates the signal into individual signals, the signal separating device including:

signal converting means for converting an input signal into the time-frequency domain and generating observation spectrograms; and

signal separating means for generating separated results from the observation spectrograms generated by the signal converting means, wherein

the signal separating means interprets the observation spectrograms as observation signals subjected to convolutive mixtures in the time-frequency domain and generates separated results by executing processing for solving convolutive mixtures in the time-frequency domain.

It is preferable that the signal converting means executes processing for executing short-time Fourier transform (STFT) on the input signal to convert the input signal into the time-frequency domain and generating observation spectrograms.

It is preferable that the signal separating means sets separated signals Y(t) of a frame number (t) as convolutive mixtures of observation signals X(t−L′) to X(t) and generates separated results according to processing for improving independence of respective individual signal components Y1(t) to Yn(t) included in the separated signals Y(t).

It is preferable that the signal separating means generates separated results by performing, as the processing for improving independence of the respective individual signal components Y1(t) to Yn(t) included in the separated signals Y(t), update processing for a separation matrix for applying Kullback-Leiblar information I(Y) as an independence measure and minimizing the Kullback-Leiblar information I(Y).

It is preferable that the signal separating means generates a first separated results according to processing for applying an instantaneous mixing ICA (Independent Component Analysis) to the observation spectrograms, executes processing for removing zero or more unnecessary channels judged as corresponding to none of sound sources from the first separated results, and executes processing for solving convolutive mixtures in the time-frequency domain on the observation spectrograms remaining after the removal processing to generate separated results.

It is preferable that the processing for applying an instantaneous mixing ICA to the observation spectrograms is processing for generating separated signals in the time-frequency domain from observation signals in the time-frequency domain and a separation matrix, correcting the separation matrix until the generated separated signals in the time-frequency domain and a separation matrix calculated with a multidimensional score function derived from a multidimensional probability density function nearly converge, and applying the corrected separation matrix to generate separated signals in the time-frequency domain.

According to another embodiment of the present invention, there is provided a signal separating device that is inputted with a signal formed by mixing plural signals and separates the signal into individual signals, the signal separating device including:

first signal converting means for converting an input signal into the time-frequency domain and generating observation spectrograms;

second signal converting means for executing data conversion for the observation spectrograms generated by the first signal converting means and generating modulation spectrograms; and

signal separating means for generating separated results from the modulation spectrograms generated by the second signal converting means, wherein
the signal separating means interprets the modulation spectrograms as instantaneous mixtures and generates separated results.

It is preferable that the first signal converting means executes processing for executing short-time Fourier transform (STFT) on the input signal to convert the input signals into the time-frequency domain and generating observation spectrograms.

It is preferable that the second signal converting means generates modulation spectrograms as results of executing short-time Fourier transform (STFT) in the temporal direction on the observation spectrograms and the signal separating means generates separated results according to processing for improving independence of respective signal components Y1′ to Yn′ corresponding to separated signals included in the modulation spectrograms.

It is preferable that the signal separating means generates separated results by performing, as the processing for improving independence of the respective signal components Y1′ to Yn′ corresponding to the separated signals, update processing for a separation matrix for applying Kullback-Leiblar information as an independence measure and minimizing the Kullback-Leiblar information.

It is preferable that the signal separating device further includes inverse Fourier transform means for executing inverse Fourier transform on the respective signal components Y1′ to Yn′ corresponding to the separated signals obtained by the signal separating means and generating spectrograms Y1 to Yn corresponding to the separated signals.

It is preferable that the signal separating device further includes unnecessary-channel removing means for generating a first separated results according to processing for applying an instantaneous mixing ICA (Independent Component Analysis) to the observation spectrograms generated by the first signal converting means and executing processing for removing zero or more unnecessary channels judged as corresponding to none of sound sources from the first separated results, wherein the second signal converting means and the signal separating means execute only processing for signals after unnecessary channel removal and generate separated results.

It is preferable that the processing for applying an instantaneous mixing ICA to the observation spectrograms is processing for generating separated signals in the time-frequency domain from an observation signal in the time-frequency domain and a separation matrix, correcting the separation matrix until the generated separated signals in the time-frequency domain and a separation matrix calculated with a multidimensional score function derived from a multidimensional probability density function nearly converge, and applying the corrected separation matrix to generate separated signals in the time-frequency domain.

According to still another embodiment of the present invention, there is provided a signal separating device that is inputted with signals formed by mixing plural signals and separates the signal into individual signals, the signal separating device including:

signal converting means for converting input signals into the time-frequency domain and generating observation spectrograms; and

signal separating means for generating separated results from the observation spectrograms generated by the signal converting means, wherein
the signal separating means shifts the observation spectrograms in the frame direction, generates a set of shifted observation spectrograms (observation spectrogram shift set) formed by superimposing data having different shift length, respectively, and generates separated results according to processing for applying an instantaneous mixing ICA (Independent Component Analysis) to the generated observation spectrogram shift set.

It is preferable that the processing for applying an instantaneous mixing ICA to the observation spectrogram shift set is processing for generating separated signals in the time-frequency domain from observation signals in the time-frequency domain and a separation matrix, correcting the separation matrix until the generated separated signals in the time-frequency domain and a separation matrix calculated with a multidimensional score function derived from a multidimensional probability density function nearly converge, and applying the corrected separation matrix to generate separated signals in the time-frequency domain.

It is preferable that the signal separating means applies the instantaneous mixing ICA to the observation spectrogram shift set corresponding to plural channels formed by superimposing plural observation spectrograms generated in association with respective observation signals of plural signal input sources and generates separated results.

It is preferable that the signal separating means sets zero or a value close to zero in a gap generated in the shift or copies values at both ends of the observation spectrograms and sets the values in the gap and generates the observation spectrogram shift set.

It is preferable that the signal separating means executes cyclic shift processing for copying data at one end pushed out from the observation spectrograms to the other end.

It is preferable that the signal separating means generates plural shift data with a minimum shift amount set as 0 and a maximum shift amount set as the number of frame taps [L′] in generating separated results from observation signals and generates the observation spectrogram shift set formed by superimposing the generated data having different shift amounts.

It is preferable that the signal separating means changes the number of frame taps [L′] according to a frequency bin and generates the observation spectrograms shift set.

It is preferable that the signal separating means generates a first separated results according to processing for applying an instantaneous mixing ICA (Independent Component Analysis) to the observation spectrograms, executes processing for removing zero or more unnecessary channels judged as corresponding to none of sound sources from the first separated results, shifts observation spectrograms remaining after the removal processing in the frame direction to generate the observation spectrograms shift set, and applies the instantaneous mixing ICA to the generated observation spectrograms shift set to generate separated results.

According to still another embodiment of the present invention, there is provided a signal separating device that is inputted with signals formed by mixing plural signals and separates the signals into individual signals, the signal separating device including:

signal converting means for converting input signals into the time-frequency domain and generating observation spectrograms; and

signal separating means for generating separated results from the observation spectrograms generated by the signal converting means, wherein
the signal separating means generates separated results Y1 to Yn according to processing for applying an instantaneous mixing ICA (Independent Component Analysis) to the observation spectrograms, shifts signal spectrograms corresponding to the respective separated results Y1 to Yn in the frame direction, generates observation spectrograms shift set formed by superimposing data having different shift amounts, respectively, executes reverberation removal processing according to processing for applying an instantaneous mixing ICA (Independent Component Analysis) to the generated observation spectrogram shift set, and generates separated results, from which reverberation is removed, according to processing for reverberation-removed integrating spectrograms.

It is preferable that the processing for applying an instantaneous mixing ICA to the observation spectrograms is processing for generating separated signals in the time-frequency domain from observation signals in the time-frequency domain and a separation matrix, correcting the separation matrix until the generated separated signals in the time-frequency domain and a separation matrix calculated by a multidimensional score function derived from a multidimensional probability density function nearly converge, and applying the corrected separation matrix to generate separated signals in the time-frequency domain.

According to still another embodiment of the present invention, there is provided a signal separating method of inputting signals formed by mixing plural signals and separating the signals into individual signals in a signal separating device, the signal separating method including:

a signal converting step in which signal converting means converts an input signal into the time-frequency domain and generates observation spectrograms; and

a signal separating step in which signal separating means generates separated results from the observation spectrograms generated in the signal converting step, wherein

the signal separating step is a step of interpreting the observation spectrograms as observation signals subjected to convolutive mixtures in the time-frequency domain and generating separated results by executing processing for solving convolutive mixtures in the time-frequency domain.

It is preferable that the signal converting step is a step of executing processing for executing short-time Fourier transform (STFT) on the input signal to convert the input signal into the time-frequency domain and generating observation spectrograms.

It is preferable that the signal separating step is a step of setting separated signals Y(t) in frame (t) as convolutive mixtures of observation signals X(t−L′) to X(t) and generating separated results according to processing for improving independence of respective individual signal components Y1(t) to Yn(t) included in the separated signals Y(t).

It is preferable that, in the signal separating step, separated results are generated by performing, as the processing for improving independence of the respective individual signal components Y1(t) to Yn(t) included in the separated signals Y(t), update processing for a separation matrix for applying the Kullback-Leiblar information I(Y) as an independence measure and minimizing the Kullback-Leiblar information I(Y).

It is preferable that the signal separating step is a step of generating a first separated results according to processing for applying an instantaneous mixing ICA (Independent Component Analysis) to the observation spectrograms, executing processing for removing zero or more unnecessary channels judged as corresponding to none of sound sources from the first separated results, and executing processing for solving convolutive mixtures in the time-frequency domain on the observation spectrograms remaining after the removal processing to generate separated results.

It is preferable that the processing for applying an instantaneous mixing ICA to the observation spectrograms is processing for generating separated signals in the time-frequency domain from observation signals in the time-frequency domain and a separation matrix, correcting the separation matrix until the generated separated signals in the time-frequency domain and a separation matrix calculated by a multidimensional score function derived from a multidimensional probability density function nearly converge, and applying the corrected separation matrix to generate separated signals in the time-frequency domain.

According to still another embodiment of the present invention, there is provided a signal separating method of inputting a signal formed by mixing plural signals and separating the signal into individual signals in a signal separating device, the signal separating method including:

a first signal converting step in which first signal converting means converts input signals into the time-frequency domain and generates observation spectrograms;

a second signal converting step in which second signal converting means executes data conversion for the observation spectrograms generated in the first signal converting step and generates modulation spectrograms; and

a signal separating step in which signal separating means generates separated results from the modulation spectrograms generated in the second signal converting step, wherein

the signal separating step is a step of interpreting the modulation spectrogram as instantaneous mixtures and generating separated results.

It is preferable that the first signal converting step is a step of executing processing for executing short-time Fourier transform (STFT) on the input signal to convert the input signal into the time-frequency domain and generating observation spectrograms.

It is preferable that the second signal converting step is a step of generating modulation spectrograms as results of executing short-time Fourier transform (STFT) in the temporal direction on the observation spectrograms and, in the signal separating step, separated results are generated according to processing for improving independence of respective signal components Y1′ to Yn′ corresponding to separated signals included in the modulation spectrograms.

It is preferable that, in the signal separating step, separated results are generated by performing, as the processing for improving independence of the respective signal components Y1′ to Yn′ corresponding to the separated signals, update processing for a separation matrix for applying the Kullback-Leiblar information as an independence measure and minimizing the Kullback-Leiblar information.

It is preferable that the signal separating method further includes an inverse Fourier transform step in which inverse Fourier transform means executes inverse Fourier transform on the respective signal components Y1′ to Yn′ corresponding to the separated signals obtained in the signal separating step and generates spectrograms Y1 to Yn corresponding to the separated signals.

It is preferable that the signal separating method further includes an unnecessary-channel removing step in which unnecessary-channel removing means generates a first separated results according to processing for applying an instantaneous mixing ICA (Independent Component Analysis) to the observation spectrograms generated by the first signal converting means and executing processing for removing zero or more unnecessary channels judged as corresponding to none of sound sources from the first separated results, wherein the second signal converting means and the signal separating means execute only processing for signals after unnecessary channel removal and generate separated results.

It is preferable that the processing for applying an instantaneous mixing ICA to the observation spectrograms is processing for generating separated signals in the time-frequency domain from observation signals in the time-frequency domain and a separation matrix, correcting the separation matrix until the generated separated signals in the time-frequency domain and a separation matrix calculated by a multidimensional score function derived from a multidimensional probability density function nearly converge, and applying the corrected separation matrix to generate separated signals in the time-frequency domain.

According to still another embodiment of the present invention, there is provided a signal separating method of inputting a signal formed by mixing plural signals and separating the signal into individual signals, the signal separating method including:

a signal converting step in which signal converting means converts input signals into the time-frequency domain and generates observation spectrograms; and

a signal separating step in which signal separating means generates separated results from the observation spectrograms generated in the signal converting step, wherein

the signal separating step is a step of shifting the observation spectrograms in the frame direction, generating the observation spectrograms shift set formed by superimposing data having different shift amounts, respectively, and generating separated results according to processing for applying an instantaneous mixing ICA (Independent Component Analysis) to the generated observation spectrogram shift set.

It is preferable that the processing for applying an instantaneous mixing ICA to the observation spectrogram shift set is processing for generating separated signals in the time-frequency domain from observation signals in the time-frequency domain and a separation matrix, correcting the separation matrix until the generated separated signals in the time-frequency domain and a separation matrix calculated by a multidimensional score function derived from a multidimensional probability density function nearly converge, and applying the corrected separation matrix to generate separated signals in the time-frequency domain.

It is preferable that, in the signal separating step, the instantaneous mixing ICA is applied to the observation spectrogram shift set corresponding to plural channels formed by superimposing plural observation spectrogram shift sets generated in association with respective observation signals of plural signal input sources and generates separated results.

It is preferable that, in the signal separating step, zero or a value close to zero is set in a gap generated in the shift or values at both ends of the observation spectrograms are copied and set in the gap and the observation spectrogram shift set is generated.

It is preferable that, in the signal separating step, cyclic shift processing for copying data at one end pushed out from the observation spectrograms to the other end is executed.

It is preferable that, in the signal separating step, plural shift data with a minimum shift amount set as 0 and a maximum shift amount set as the number of frame taps [L′] in generating separated results from observation signals are generated and the observation spectrogram shift set formed by superimposing the generated data having different shift amounts is generated.

It is preferable that, in the signal separating step, the number of frame taps [L′] is changed according to a frequency to generate the observation spectrogram shift set.

It is preferable that the signal separating step is a step of generating first separated results according to processing for applying an instantaneous mixing ICA (Independent Component Analysis) to the observation spectrograms, executing processing for removing zero or more unnecessary channels judged as corresponding to none of sound sources from the first separated results, shifting observation spectrograms remaining after the removal processing in the frame direction to generate the observation spectrogram shift set, and applying the instantaneous mixing ICA to the generated observation spectrogram shift set to generate separated results.

According to still another embodiment of the present invention, there is provided a signal separating method of inputting a signal formed by mixing plural signals and separating the signal into individual signals, the signal separating method including:

a signal converting step in which signal converting means converts input signals into the time-frequency domain and generates observation spectrograms; and

a signal separating step in which signal separating means generates separated results from the observation spectrograms generated in the signal converting step, wherein

in the signal separating step, separated results Y1 to Yn are generated according to processing for applying an instantaneous mixing ICA (Independent Component Analysis) to the observation spectrograms, signal spectrograms corresponding to the respective separated results Y1 to Yn are shifted in the frame direction, the observation spectrogram shift set formed by superimposing data having different shift amounts, respectively, is generated, reverberation removal processing is executed according to processing for applying an instantaneous mixing ICA (Independent Component Analysis) to the generated observation spectrograms shift set, and generates separated results, from which reverberation is removed, according to processing for reverberation-removed integrating spectrograms.

It is preferable that the processing for applying an instantaneous mixing ICA to the observation spectrograms is processing for generating separated signals in the time-frequency domain from observation signals in the time-frequency domain and a separation matrix, correcting the separation matrix until the generated separated signals in the time-frequency domain and a separation matrix calculated by a multidimensional score function derived from a multidimensional probability density function nearly converge, and applying the corrected separation matrix to generate separated signals in the time-frequency domain.

According to still another embodiment of the present invention, there is provided a computer program for causing a signal separating device to execute signal separation processing for inputting signals formed by mixing plural signals and separating the signals into individual signals, the computer program causing the signal separating device to execute:

a signal converting step of causing signal converting means to convert input signals into the time-frequency domain and generate observation spectrograms; and

a signal separating step of causing signal separating means to generate separated results from the observation spectrograms generated in the signal converting step, wherein

the signal separating step is a step of interpreting the observation spectrograms as observation signals subjected to convolutive mixtures in the time-frequency domain and generating separated results by executing processing for solving convolutive mixtures in the time-frequency domain.

According to still another embodiment of the present invention, there is provided a computer program for causing a signal separating device to execute signal separation processing for inputting signals formed by mixing plural signals and separating the signals into individual signals, the computer program causing the signal separating device to execute:

a first signal converting step of causing first signal converting means to convert input signals into the time-frequency domain and generate observation spectrograms;

a second signal converting step of causing second signal converting means to execute data conversion for the observation spectrograms generated in the first signal converting step and generate modulation spectrograms; and

a signal separating step of causing signal separating means to generate separated results from the modulation spectrograms generated in the second signal converting step, wherein

the signal separating step is a step of interpreting the modulation spectrograms as instantaneous mixtures and generating separated results.

According to still another embodiment of the present invention, there is provided a computer program for causing a signal separating device to execute signal separation processing for inputting signals formed by mixing plural signals and separating the signal into individual signals, the computer program causing the signal separating device to execute:

a signal converting step of causing signal converting means to convert an input signal into the time-frequency domain and generate observation spectrograms; and

a signal separating step of causing signal separating means to generate separated results from the observation spectrograms generated in the signals converting step, wherein

the signal separating step is a step of shifting the observation spectrograms in the frame direction, generating the observation spectrogram shift set formed by superimposing data having different shift amounts, respectively, and generating separated results according to processing for applying an instantaneous mixing ICA (Independent Component Analysis) to the generated observation spectrogram shift set.

The computer programs according to the embodiments of the present invention are, for example, computer programs that can be provided to a computer system, which can execute various program codes, by storage media provided in a computer readable format, communication media, recording media such as a CD, an FD, and an MO, and communication media such as a network. Processing corresponding to the computer programs is executed on the computer system by providing such computer programs in a computer readable format.

Other objects, characteristics, and advantages of the present invention will be made apparent by detailed explanation based on embodiments of the present invention described later and the accompanying drawings. A system in this specification is a logical set of plural apparatuses and is not limited to a system in which apparatuses having respective configurations are provided in an identical housing.

According to an embodiment of the present invention, input signals formed by mixing plural signals are converted into the time-frequency domain to generate observation spectrograms. In signal separation processing for generating separated results from the observation spectrograms, separated results are generated by processing for interpreting the observation spectrograms as observation signals subjected to convolutive mixtures in the time-frequency domain and solving convolutive mixtures in the time-frequency domain. Alternatively, modulation spectrograms are generated by short-time Fourier transform (STFT) in the temporal direction for the observation spectrograms and the modulation spectrograms are interpreted as instantaneous mixtures to generate separated results. Therefore, highly accurate separation processing performed by taking into account a delay amount is realized for mixed sound signals having various delay amounts such as direct waves and reflected waves.

### BRIEF DESCRIPTION OF THE DRAWINGS

FIG. 1 is a diagram for explaining an example of the structure for acquiring sound information applied to separation processing for sound signals formed by mixing plural signals;

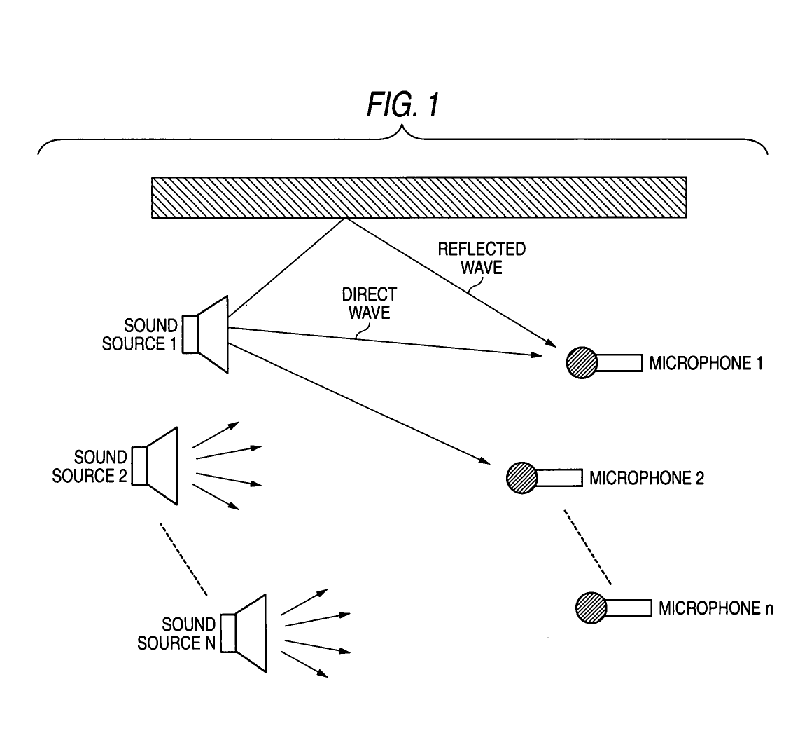

FIG. 2 is a diagram showing a relation between entropy H(Yₖ) for one spectrogram concerning each of channels and joint entropy H(Y) for the whole spectrograms concerning all the channels;

FIG. 3 is a graph showing a graph in which a relation between a window length of STFT and separation accuracy of the time-frequency domain ICA is plotted;

FIG. 4 a graph showing a graph representing separation accuracy of the time-frequency domain ICA with a window length on the abscissa set as an actual second;

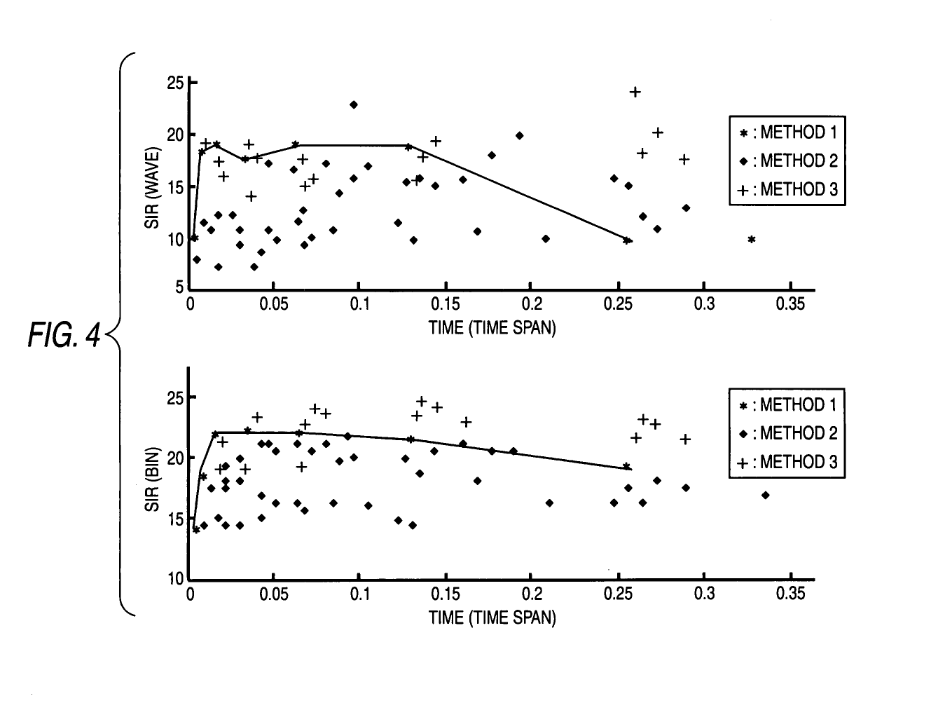

FIG. 5 is a diagram for explaining an example of the structure for acquiring sound information applied to separation processing for sound signals formed by mixing plural signals;

FIGS. 6A to 6C are diagrams for explaining a concept of understanding that convolutive mixtures in the time domain are not instantaneous mixtures but are convolutive mixtures in the time-frequency domain;

FIGS. 7A and 7B are diagrams for explaining short-time Fourier transform (STFT);

FIGS. 8A and 8B are diagrams for explaining conversion into X (spectrograms) subjected to short-time Fourier transform (STFT) from wave forms x;

FIGS. 9A and 9B are diagrams for explaining conversion to X′ (modulation spectrograms) subjected to short-time Fourier transform (STFT) in the temporal direction again from the spectrograms X;

FIG. 10 is a diagram for explaining a method of calculating entropy H(Y′k);

FIGS. 11A and 11B are diagrams for explaining processing for generating vectors vertically superimposed while a frame number is shifted with respect to observation spectrograms;

FIGS. 12A and 12B are diagrams for explaining operation for generating separated results by convoluting (t−l)th to (t−l+L′)th frames concerning observation spectrograms X;

FIG. 13 is a diagram for explaining processing as a combination of shift superimposition and an instantaneous mixing ICA;

FIG. 14 is a flowchart for explaining a sequence of the processing as a combination of shift superimposition and the instantaneous mixing ICA;

FIG. 15 is a diagram for explaining an example of the structure of a signal separating device according to an embodiment of the present invention;

FIG. 16 is a diagram for explaining an example of the structure of the signal separating device according to the embodiment;

FIG. 17 is a flowchart for explaining a processing sequence of the signal separating device according to the embodiment;

FIG. 18 is a flowchart for explaining a detailed sequence of separation processing executed by the signal separating device according to the embodiment;

FIG. 19 is a flowchart for explaining a detailed sequence of separation processing executed by the signal separating device according to the embodiment;

FIGS. 20A and 20B are diagrams for explaining processing for setting a value of the number of frame taps [L′] different for each of frequencies;

FIG. 21 is a flowchart for processing for performing channel number deletion and performing signal separation according to two-stage separation;

FIG. 22 is a flowchart for explaining reverberation processing;

FIG. 23 is a diagram for explaining the structure of an experimental device for checking an effect of the signal separating device according to the embodiment;

FIGS. 24A and 24B are graphs showing evaluation data of an experimental result for checking an effect of the signal separating device according to the embodiment;

FIGS. 25A and 25B are graphs showing evaluation data of an experimental result for checking an effect of the signal separating device according to the embodiment;

FIGS. 26A and 26B are graphs showing evaluation data of an experimental result for checking an effect of the signal separating device according to the embodiment;

FIGS. 27A and 27B are graphs showing evaluation data of an experimental result for checking an effect of the signal separating device according to the embodiment;

FIG. 28 is a diagram for explaining an environment in which an evaluation experiment for signal separation processing is performed;

FIG. 29 is a diagram for explaining sound sources applied to the evaluation experiment for the signal separation processing;

FIG. 30 is a diagram for explaining input and output patterns of the sound sources applied to the evaluation experiment for the signal separation processing;

FIGS. 31A and 31B are diagrams for explaining an example of observation signals in the evaluation experiment for the signal separation processing;

FIG. 32 is a diagram for explaining a result of shift and superimposition (see FIGS. 11A and 11B) obtained in the evaluation experiment for the signal separation processing;

FIGS. 33A and 33B are diagrams for explaining separated results and an SIR obtained in the evaluation experiment for the signal separation processing;

FIG. 34 is a diagram for explaining an evaluation result obtained in the evaluation experiment for the signal separation processing; and

FIG. 35 is a diagram for explaining an evaluation result obtained in the evaluation experiment for the signal separation processing.

### DESCRIPTION OF THE PREFERRED EMBODIMENTS

Details of a signal separating device, a signal separating method, and a computer program according to embodiments of the present invention will be hereinafter explained with reference to the accompanying drawings.

In the embodiments of the present invention, signal separation processing for executing processing for separating and restoring an original signal according to signal analysis of mixed signals acquired by mixing plural original signals as described above is performed. Signal separation processing by an independent component analysis (ICA) is performed.

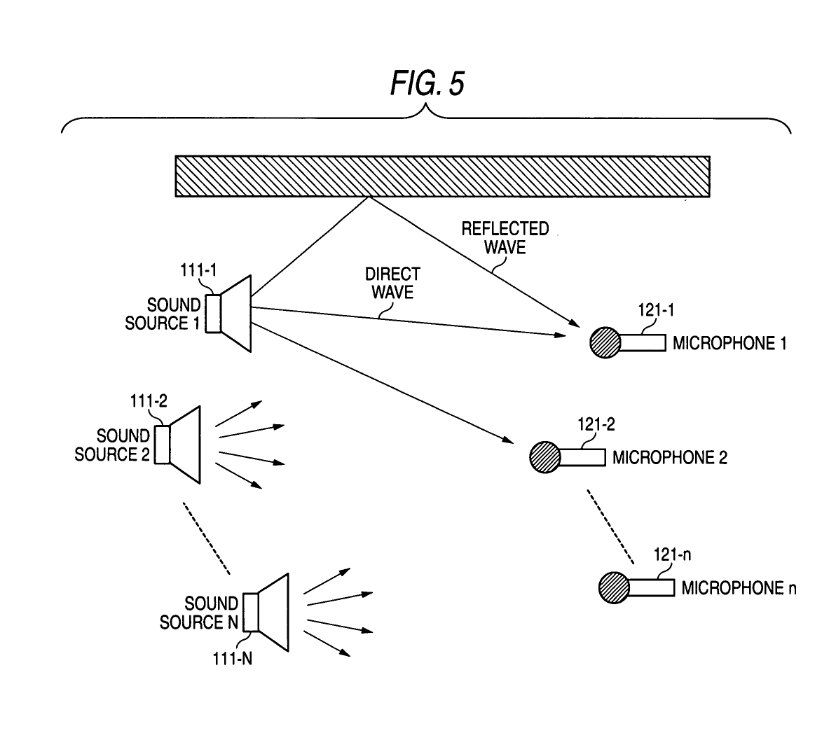

Specifically, as shown in FIG. 5, different sounds are emitted from N sound sources 111-1 to 111-N and the sounds are observed with n microphones 121-1 to 121-n. In such a situation, the signal separation processing by the independent component analysis (ICA) is performed on the basis of mixed signals acquired with the microphones 121-1 to 121-n.

As explained above, signals observed by one microphone j (1≦j≦n) (observation signals) can be represented as an equation obtained by summing up convolution between original signals and transfer functions for all sound sources as indicated by Equation [1.1] (“convolutive mixtures”). When observation signals for all the microphones 1 to n are represented by one equation, the equation can be represented like Equation [1.2]. As a method of solving these convolutive mixtures, there are two methods:

(1) a method of directly solving convolutive mixtures in the time domain (time domain deconvolution); and
(2) a method of converting observation signals into the time-frequency domain and solving convolutive mixtures as an instantaneous mixing problem.

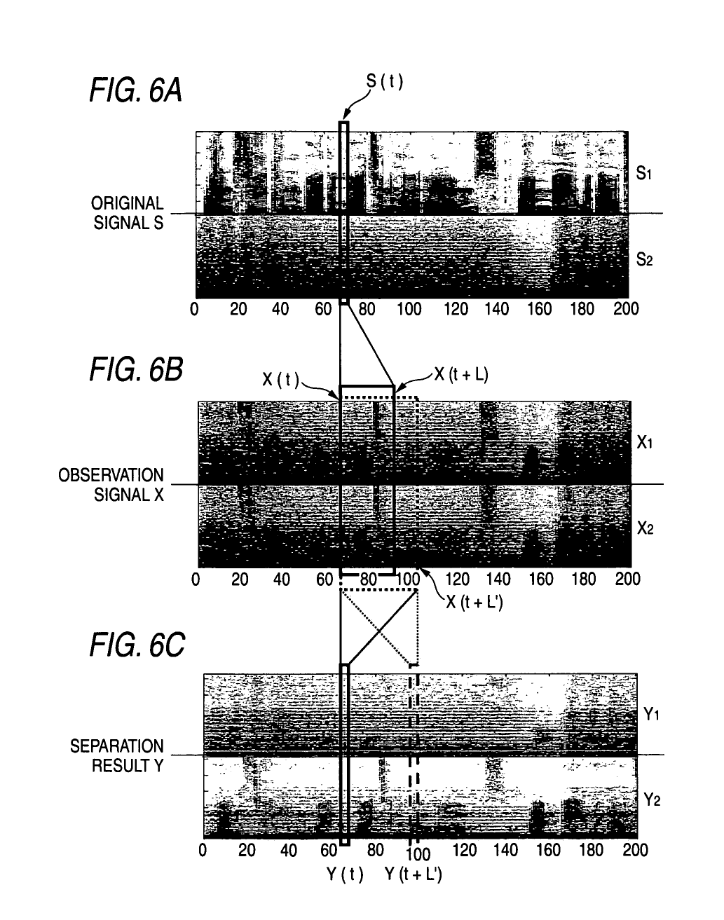

As a premise for performing the method of converting observation signals into the time-frequency domain and solving convolutive mixtures as an instantaneous mixing problem, in a framework of the time-frequency domain ICA in the past, it is understood that convolutive mixtures in the time-domain are represented by instantaneous mixtures in the time-frequency domain. On the other hand, in the embodiments of the present invention, it is understood that convolutive mixtures in the time domain are still convolutive mixtures in the time-frequency domain. This concept is explained with reference to FIGS. 6A to 6C.

In FIG. 6A, spectrograms of original signals, i.e., original signals outputted by respective sound sources 111-1 to 111-N shown in FIG. 5 are vertically superimposed. A set of spectrograms obtained by vertically superimposing both spectrograms S1 and S2 is S. As described above, spectrograms are a diagram representing |Xk(ω,t)|, which is the absolute value of Xk(ω,t), as shading of a color with t (frame number) set on the abscissa and ω (frequency bin number) set on the ordinate.

In the spectrograms of the original signals shown in FIG. 6A, signals in the t-th frame represented by a vector are set as S(t). One frame in a spectrogram is called spectrum.

In the past, it is understood that S(t) reaches each microphone without delay. However, in the embodiments of the present invention, it is understood that there is a frame delay. Referring to FIG. 5, vectors called spectra are independently generated in the respective sound sources 111-1 to 111-N and reaches microphones 121-1 to 121-n, which serve as sensors, with a delay equal to or larger than 0. The vectors include direct waves and reflected waves.

Various signals such as direct waves from different sound sources, direct waves and reflected waves, simple reflection and complex reflection, and the like are acquired with the microphones. It is surmised that various delay amounts are present in the signals. Assuming that a maximum value of delay is L+1, the influence of the spectrum S(t), which is the vector representation of the t-th frame signal in the spectrograms of the original signals shown in FIG. 6A, extends to t-th to (t+L)th frames of observation signals.

FIG. 6B shows spectrograms of observation signals. The spectrograms are spectrograms X of observation signals generated by executing short-time Fourier transform (STFT) on observation signals acquired with the respective microphones 121-1 to 121-n.

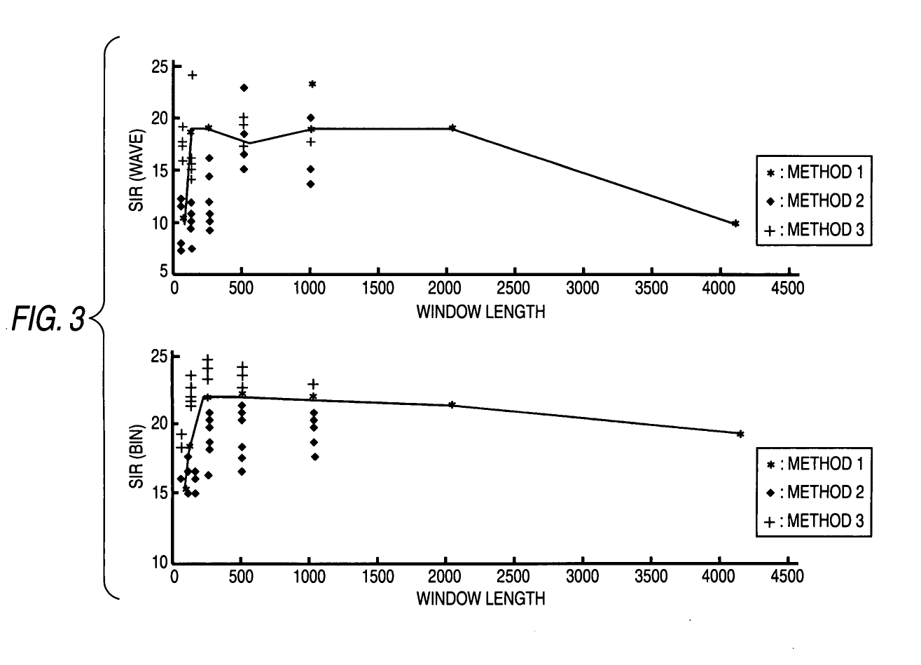

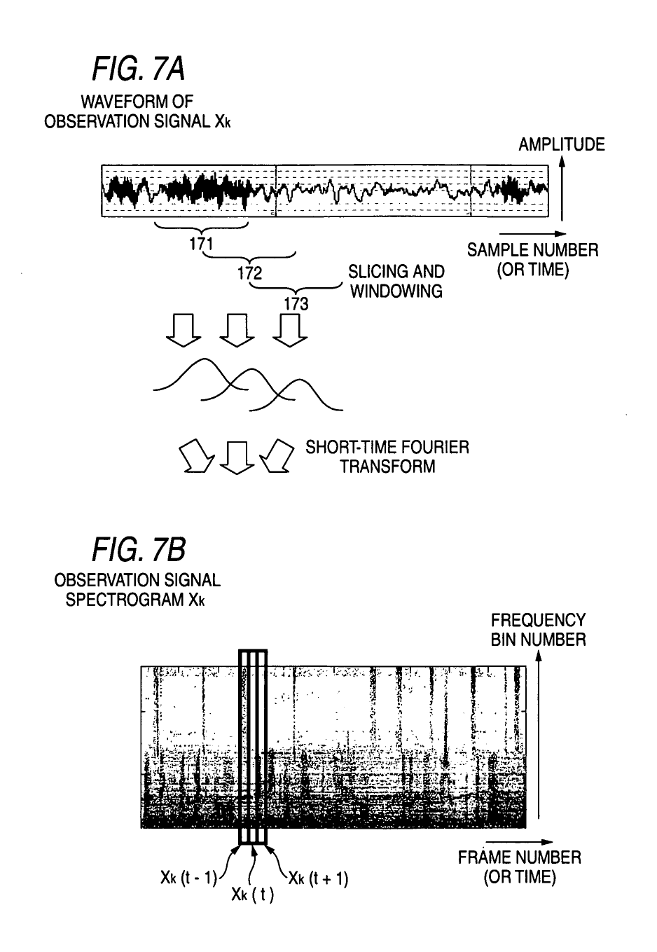

Short-time Fourier transform (STFT) is explained with reference to FIGS. 7A and 7B. Observation signals xₖ recorded with the kth microphone in, for example, the environment shown in FIG. 5 is shown in FIG. 7A. A window functions such as a hanning window and a sine window are applied to the frames 171 to 173, which are sliced data obtained by slicing a fixed length from the observation signals xₖ. A slicing unit is referred to as frame. Slicing length (the number of sampling points) may be a value same as length (in FIG. 3, near a 512 point or a 1024 point) with which most highly accurate separated results is obtained in the time-frequency domain ICA in the method in the past. A spectrum Xk(t), which is data of the frequency domain, is obtained by applying discrete Fourier transform (Fourier transform in a finite section; abbreviated as DFT) or fast Fourier Transform (FFT) to data for one frame (t is a frame number).

Overlap of frames like the frames 171 to 173 shown in the figure may be present among frames to be sliced. In this way, it is possible change spectra Xk(t−1) to Xk(t+1) of consecutive frames smoothly. Spectra arranged according to frame numbers are referred to as a spectrogram. FIG. 7B is an example of the spectrogram.

When there is overlap among frames to be sliced in short-time Fourier transform (STFT), inverse transform results (waveforms) for the respective frames are superimposed with overlap in inverse Fourier Transform (FT) as well. This is referred to as overlap add. A window function such as the sine window may be applied to the inverse transform results before overlap add. This is referred to as weighted overlap add (WOLA). Noise deriving from discontinuity among the frames can be reduced by WOLA.

FIG. 6B is spectrograms of observation signals obtained by processing with reference to FIGS. 7A and 7B and obtained by vertically superimposing spectrograms. Spectrograms of respective sensors (microphones) are represented as X1 and X2 and a set of spectrograms obtained by vertically superimposing both the spectrograms are represented as X. When spectrograms of observation signals are X, L+1 frames from X(t) to X(t+L) are affected by the source spectra S(t). Conversely, observation signals X(t) in the t-th frame in the observation signals shown in FIG. 6B are affected by original signals for L+1 frames before the t-th frame.

Taking into account the fact that the observation signals X(t) in the t-th frame in the observation signals is affected by the original signals for L+1 frames before the t-th frame in this way, the observation signals X(t) can be represented as convolutive mixtures as indicated by Equation [6.1] shown below.

$$\begin{matrix}X ( t ) = {A}^{[ 0 ]} S ( t ) + … + {A}^{[ L ]} S ( t - L ) & [ 6.1 ] \\ Y ( t ) = {W}^{[ 0 ]} X ( t ) + … + {W}^{[ L ]} X ( t - {L}^{′} ) & [ 6.2 ] \\ Y ( t ) = {W}^{[ 0 ]} X ( t ) + … + {W}^{[ L ]} X ( t + {L}^{′} ) & [ 6.3 ] \\ X ( ω , t ) = {A}^{[ 0 ]} ( ω ) S ( ω , t ) + … + {A}^{[ L ]} ( ω ) S ( ω , t - L ) & [ 6.4 ] \\ {W}^{[ l ]} = [ \begin{matrix}{w}_{11}^{[ l ]} ( 1 ) & & 0 & & {w}_{1 n}^{[ l ]} ( 1 ) & & 0 \\ & ⋰ & & ⋯ & & ⋰ & \\ 0 & & {w}_{11}^{[ l ]} ( M ) & & 0 & & {w}_{1 n}^{[ l ]} ( M ) \\ & ⋮ & & ⋰ & & ⋮ & \\ {w}_{n 1}^{[ l ]} ( 1 ) & & 0 & & {w}_{nn}^{[ l ]} ( 1 ) & & 0 \\ & ⋰ & & ⋯ & & ⋰ & \\ 0 & & {w}_{n 1}^{[ l ]} ( M ) & & 0 & & {w}_{nn}^{[ l ]} ( M )\end{matrix} ] & [ 6.5 ] \\ {W}^{[ l ]} ( ω ) = [ \begin{matrix}{w}_{11}^{[ l ]} & ⋯ & {w}_{1 n}^{[ l ]} ( ω ) \\ ⋮ & ⋰ & ⋮ \\ {w}_{n 1}^{[ l ]} ( ω ) & ⋯ & {w}_{nn}^{[ l ]} ( ω )\end{matrix} ] & [ 6.6 ]\end{matrix}$$

Equation [6.1] is similar to Equation [1.2] explained above. However, it should be noted that Equation [6.1] is an equation in the time-frequency domain. In the case of L=0, Equation [6.1] is equivalent to instantaneous mixtures in the previous methods. When the observation signals X(t) are affected by only the original signal spectra S(t), L=0 and Equation [6.1] is equivalent to instantaneous mixtures in the previous methods.

In order to distinguish both kinds of convolution, L in Equation [1.2] is defied as [the number of time taps] and L in Equation [6.1] is defined as [the number of frame taps].

Equation [6.1] strictly holds when a shift width of frames is set to 1 in STFT. Even when the shift width of frames is set to 2 or more, Equation [6.1] approximately holds. Concerning details of this point, please refer to the inventor's thesis “Hiroe, A. “Blind Vector Deconvolution: Convolutive Mixture Models in Short-Time Fourier Transform Domain”, In M. E., Davies et al. (Eds.): ICA 2007, LNCS 4666, pp. 471 to 479, 2007”.

When time of reverberation is longer than a window length of short-time Fourier transform (STFT), the influence of reverberation does not conclude in one frame and extends over plural frames. The reverberation extending over the plural frames can be represented as convolution in the time-frequency domain. Therefore, according to the idea that “convolutive mixtures in the time-frequency domain” introduced in the embodiments of the present invention, it is possible to remove reverberation exceeding the window length of STFT.

The graph shown in FIG. 3 in which the relation between the window length of STFT and separation accuracy of the time-frequency domain ICA is plotted is referred to as an example. Instead of a long window (2048, 4096, etc.), a combination of a shorter window (512 or 1024) and plural frame taps (16 and 32) is possible. It is possible to secure a time span (time calculated from the number of time taps, a shift width in the frame direction, and the number of frame taps) equivalent to the long window while preventing tradeoff of the long window.

Compared with the time domain deconvolution, only convolution with a far smaller number of taps has to be performed (in the order of several tens taps). Therefore, it is possible to prevent the problem of the time domain deconvolution. In the following explanation, the number of frame taps in generating observations signal from original signals are represented by a character L. On the other hand, the number of frame taps in generating separated results from the observation signals are represented as L′. L is a value determined from reverberation time of the environment, the window length of STFT, and the shift width. On the other hand, L′ can be set to a value different from L. (When L′=0, this is equivalent to the previous methods.)

The number of frame taps L of the observation signals can be calculated by the following equation:

L=Tr×Fs/S

where, Tr is reverberation time of the environment, Fs is a sampling frequency, and S is the shift width of STFT.

For example, when the reverberation time Tr is set to 0.3 second, the sampling frequency Fs is set to 16000 Hz, and the shift width S is set to 256, the number of frame taps L in generating the observation signals from the original signals is 18.75. It is seen that the influence of reverberation extends over nineteen frames (fractions are rounded up).

The number of frame taps L′ for generating separated results Y from observation signals X, i.e., separated results Y in FIG. 6C from observation signals X in FIG. 6B only has to be set as L′=αL when L is known (i.e., reverberation time is known) (α is an appropriate positive real number). When L is unknown, for example, L′ can be determined by any one of methods described below.

A first method is a method of setting L′ to a fixed value such as 64 or 100. Basically, since computational cost increases as L′ is larger, L′ may be determined according to a balance between computational cost and separation performance.

A second method is a method of measuring reverberation time with some method and setting L′ to a value a fixed time as large as a value of L calculated from the reverberation time by the equation described above, i.e., L′=αL. As a method of measuring reverberation time, for example, impulsive sound is emitted from a speaker mounted on the device itself and time until the sound is sufficiently attenuated is measured.

A third method is a method of separating, under various values of L′, an observation signal generated from a known original signal and adopting a value of L′ that produces the best separated results. For this method, for example, plural speakers are set around the device, known sounds are emitted from the respective speakers, and the sounds are observed by plural microphones. Separated results are generated with respect to results of the measurement using different values of L′ (e.g., values from 0 to 100). A separation performance scale called SIR (signal-interference ratio) is calculated from the separated results and the original signals and L′ that produces the highest SIR is adopted. If an environment is the same, even when original signals are unknown, it is highly likely that L′ of the original signals produces the best separated signals.

For example, L′, i.e., the number of frame taps L′ for generating the separated results Y from the observation signals X, specifically, the number of frame taps L′ for generating the separated results Y shown in FIG. 6C from the observation signals X shown in FIG. 6B is determined by anyone of the methods. Separated results are generated from multiple consecutive frames of observation signals by using the number L′ of frame taps.

As a processing method for separating observation signals subjected to convolutive mixtures in the time-frequency domain, it is possible to apply, for example, any one of the following methods:

(1) a method of directly solving convolutive mixtures in the time-frequency domain;
(2) a method of subjecting spectrograms to short-time Fourier transform (STFT) in the temporal direction again and solving convolutive mixtures as instantaneous mixtures; and
(3) a method of solving convolutive mixtures according to processing as a combination of shift superimposition and an instantaneous mixing ICA.

“(3) The processing as a combination of shift superimposition and an instantaneous mixing ICA” is a method of realizing separation processing equivalent to “(1) the method of directly solving convolutive mixtures in the time-frequency domain”. This is a method of applying, after superimposing observation spectrograms while shifting the same, the instantaneous mixing ICA in the time-frequency domain in the past to results of superimposing the observation spectrograms. Details of the method are explained later.

(1) The Method of Directly Solving Convolutive Mixtures in the Time-Frequency Domain

First, processing for directly solving convolutive mixtures to separate observation signals subjected to convolutive mixtures in the time-frequency domain is explained.

Referring back to FIGS. 6A to 6C, as described above, the tth frame S(t) of the original signal spectrograms affects the tth to t+Lth frames of the observation signals. Therefore, in order to estimate one frame of the original signals, the observation signals for L frames or more are necessary. This value is denoted as L′.

When the tth frame in the separated signals is set as a reference, for example, when Y(t) in the separated signals shown in FIG. 6C is considered as a reference, data for at least L+1 frames after the tth frame is necessary in order to estimate S(t). Therefore, Y(t) as estimates (separated results) of the original signals is represented as convolutive mixtures of the observation signals X(t) to X(t+L′) as indicated by Equation [6.3].

On the other hand, when the t+L′ th frame in the separated signal is set as a reference, for example, when Y(t+L′) in the separated signals shown in FIG. 6C is considered as a reference, data for immediately preceding L+1 frames is necessary to estimate S(t). Therefore, the separated signals Y(t) are represented as convolutive mixtures of the observation signals (t−L′) to X(t) as indicated by Equation [6.2].

Both the equations are different in shift of the frames from S(t). However, since the equations are primarily equivalent, a method of estimating Y(t) from Equation [6.2] is explained below.

When it is assumed that mixing occurs only in the same frequency bin (i.e., it is assumed that modulation of a frequency does not occur in the process of propagation), Equation [6.1], which is the equation of mixing in all the frequency bins, can be rewritten as Equation [6.4], which is the equation of mixing in individual frequency bins. Under the assumption, a separation matrix W^{[l]} of Equation [6.2] can be represented as a matrix formed by diagonal matrixes as indicated by Equation [6.5]. Therefore, in order to estimate W^{[l]}, only non-zero components of Equation [6.5] have to be estimated.

Processing for calculating a learning rule (an equation of ΔW) from Equation [6.2] is performed as described below. As a scale representing independence of all spectrograms, the Kullback-Leiblar information I(Y) calculated by Equation [4.5] is considered. This method is processing same as the method described in JP-A-2006-238409.

In order to make Y1(t) to Yn(t), which are components of Y(t), independent from one another, separation matrixes W^{[0]} to W^{[L′]} that minimize the Kullback-Leiblar information I(Y) in Equation [4.5] only have to be calculated. Since the method described in JP-A-2006-238409 is instantaneous mixtures, only one separation matrix has to be estimated. However, in the embodiments of the present invention, since convolutive mixtures of L′+1 frames is performed, it is necessary to estimate L′+1 separation matrices.

If an assumption that “Yk(t−L′) to Yk(t) are also independent from one another” (independence among frames) is provided besides the assumption that “Y1(t) to Yn(t) are independent from one another” (independence among channels), finally, a learning rule of Equation [7.1] shown below is derived.

$$\begin{matrix}Δ {W}^{[ τ ]} ( ω ) = {W}^{[ τ ]} ( ω ) + {R}_{ω}^{[ 0 ]} {W}^{[ τ ]} ( ω ) + … + {R}_{ω}^{[ τ ]} {W}^{[ 0 ]} ( ω ) & [ 7.1 ] \\ {R}_{ω}^{[ l ]} = {E}_{t} [ {ϕ}_{ω} ( Y ( t ) ) {T ( ω , t - l )}^{H} ] & [ 7.2 ] \\ {R}_{ω}^{[ l ]} = {E}_{t} [ {ϕ}_{ω} ( Y ( t ) ) {T ( ω , t + l )}^{H} ] & [ 7.3 ] \\ {ϕ}_{ω} ( Y ( t ) ) = [ \begin{matrix}{ϕ}_{1 ω} ( {Y}_{1} ( t ) ) \\ ⋮ \\ {ϕ}_{n ω} ( {Y}_{n} ( t ) )\end{matrix} ] & [ 7.4 ] \\ {ϕ}_{k ω} ( {Y}_{k} ( t ) ) = \frac{\partial }{\partial {Y}_{k} ( ω , t )} log P ( {Y}_{k} ( t ) ) \\ Yk ( t ) \text{:} Probability density function of P ( Yk ( t ) ) & [ 7.5 ] \\ {ϕ}_{k ω} ( {Y}_{k} ( t ) ) = - \frac{{γ}_{k} ( ω ) {Y}_{k} ( ω , t )}{{\{ {\sum }_{ω} {\vert {α}_{k} ( ω ) {Y}_{k} ( ω , t ) \vert}^{m} \}}^{\frac{1}{m}} + {β}_{k} ( ω )} & [ 7.6 ] \\ {ϕ}_{k ω} ( {Y}_{k} ( t ) ) = - γ \frac{{Y}_{k} ( ω , t )}{{\{ {\sum }_{ω} {\vert {Y}_{k} ( ω , t ) \vert}^{2} \}}^{\frac{1}{2}}} & [ 7.7 ] \\ {W}^{[ τ ]} ( ω ) ← {W}^{[ τ ]} ( ω ) + ηΔ {W}^{[ τ ]} ( ω ) & [ 7.8 ] \\ η = \frac{{η}_{0}}{\frac{‖ Δ W ( ω ) ‖}{‖ W ( ω ) ‖} + 1} & [ 7.9 ] \\ ‖ W ( ω ) ‖ = {\sum }_{l = 0}^{L} {\sum }_{k , f} {\vert {w}_{kj}^{[ l ]} ( ω ) \vert}^{2} & [ 7.10 ] \\ {}_{k} ( ω ) = arg min {E}_{t} [ {\vert {X}_{k} ( ω , t ) - {}_{k} ( ω ) {Y}_{k} ( ω , t ) \vert}^{2} ] & [ 7.11 ] \\ {Y}_{k} ( ω , t ) ← {}_{k} ( ω ) {Y}_{k} ( ω , t ) & [ 7.12 ] \\ {W}^{[ τ ]} ( ω ) ← [ \begin{matrix}{}_{1} ( ω ) & & 0 \\ & ⋰ & \\ 0 & & {}_{n} ( ω )\end{matrix} ] {W}^{[ τ ]} ( ω ) & [ 7.13 ] \\ {\hat{X}}_{k} ( ω , t ) = {}_{k 1} ( ω ) {Y}_{1} ( ω , t ) + … + {}_{kn} ( ω ) {Y}_{n} ( ω , t ) + {β}_{k} ( ω ) & [ 7.14 ] \\ [ {}_{k 1} ( ω ) , … , {}_{kn} ( ω ) , {β}_{k} ( ω ) ] = arg min {E}_{t} [ {\vert {X}_{k} ( ω , t ) - {\hat{X}}_{k} ( ω , t ) \vert}^{2} ] & [ 7.15 ] \\ {Y}_{k} ( ω , t ) ← {}_{kk} ( ω ) {Y}_{k} ( ω , t ) & [ 7.16 ]\end{matrix}$$

In other words, in order to calculate the separation matrices W^{[0]} to W^{[L′}], Equations [6.2], [7.1], and [7.8] are repeated until W^{[0]} to W^{[L′]} converge (or a fixed number of iterations). Note that ΔW^{[l]}(ω) and W^{[l]} (ω) in Equation [7.1] are submatirces (Equation [6.6]) formed by extracting elements corresponding to a frequency bin ω from ΔW^{[l]} and W^{[l]}, respectively. Rω^{[l]} is a cross term calculated by Equation [7.2]. φω(Y(t)) in Equation [7.2] is a vector formed by score functions (Equation [7.4]). This is identical with a vector formed by score functions described in a prior application of the applicant (JP-A-2006-238409). The score function is defined as logarithmic derivative of a probability density function (Equation [7.5]). As disclosed in JP-A-2006-238409, it is possible to prevent occurrence of permutation by using the multivariate score functions.

A specific example of the score functions may be identical with that explained in JP-A-2006-238409. For example, Equation [7.6] is used. In this equation, αk(ω), m, and γk(ω) are positive real numbers and βk(ω) is a non-negative real number. As a simple example, Equation [7.7] may be applied.

In Equation [7.8], η is a positive real number called a learning ratio. η may be a constant such as 0.1 or may be adaptively calculated as indicated by Equation [7.9]. Note that, in this equation, ∥W(ω)∥ is a square sum (Equation [7.10]) of all elements of W^{[0]}(ω) to W^{[L]}(ω), ∥ΔW(ω)∥ is also a square sum of all elements of ΔW^{[0]}(ω) to ΔW^{[L′]}(ω), and η₀ is a positive real number representing an upper limit value of η. When Equation [7.8] is used, since η is a relatively small value in the beginning of learning (because ∥ΔW(ω)∥ is large), it is possible to prevent W(ω) from overflowing. On the other hand, since η is a relatively large value in the end of learning (because ∥ΔW(ω)∥ is close to a zero matrix), W(ω) converges to a target value early.

When Equation [6.3] is used instead of Equation [6.2], Equations [6.3], [7.1], and [7.8] are repeated in learning. Note that, as Rω^{[l]} in Equation [7.1], Equation [7.3] is used instead of Equation [7.2].

In deriving Equation [7.1], the assumption that “Yk(t−L′) to Yk(t) are also independent from one another” is set. However, if an assumption that “Yk(t−L′) to Yk(t) are dependent on one another” is set, Equation [8.1] described below, which is another learning rule, is obtained (Equation [7.1] is common).

$$\begin{matrix} {R}_{ω}^{[ l ]} = {E}_{t} ⌊ {ϕ}_{ω} ( Y ( t ) , … , Y ( t - {L}^{′} ) ) {Y ( ω , t - l )}^{H} ⌋ & [ 8.1 ] \\ {R}_{ω}^{[ l ]} = {E}_{t} [ {ϕ}_{ω} ( Y ( t ) , … , Y ( t + {L}^{′} ) ) {Y ( ω , t + l )}^{H} ] & [ 8.2 ] \\ {ϕ}_{ω} ( Y ( t ) , … , Y ( t + {L}^{′} ) ) = [ \begin{matrix}{ϕ}_{1 ω} ( {Y}_{n} ( t ) , … , {Y}_{1} ( t - {L}^{′} ) ) \\ ⋮ \\ {ϕ}_{n ω} ( {Y}_{n} ( t ) , … , {Y}_{n} ( t - {L}^{′} ) )\end{matrix} ] & [ 8.3 ] \\ {ϕ}_{k ω} ( {Y}_{k} ( t ) , … , {Y}_{k} ( t - {L}^{′} ) ) = \frac{\partial }{\partial {Y}_{k} ( ω , t )} log P ( {Y}_{k} ( t ) , … , {Y}_{k} ( t - {L}^{′} ) ) & [ 8.4 ] \\ {ϕ}_{k ω} ( {Y}_{k} ( t ) , … , {Y}_{k} ( t - {L}^{′} ) ) = - \frac{{γ}_{k} ( ω ) {Y}_{k} ( ω , t )}{{\{ {\sum }_{l = 0}^{L} {\sum }_{ω} {\vert {α}_{k}^{[ l ]} ( ω ) {Y}_{k} ( ω , t - l ) \vert}^{m} \}}^{\frac{1}{m}} + {β}_{k} ( ω )} & [ 8.5 ] \\ {ϕ}_{k ω} ( {Y}_{k} ( t ) , … , {Y}_{k} ( t - {L}^{′} ) ) = - γ \frac{{Y}_{k} ( ω , t )}{{\{ {\sum }_{l = 0}^{L} {\sum }_{ω} {\vert {Y}_{k} ( ω , t - l ) \vert}^{2} \}}^{\frac{1}{2}}} & [ 8.6 ]\end{matrix}$$

A difference between Equation [7.2] and Equation [8.1] is present in arguments of score functions. Whereas only Y(t) is an argument in Equation [7.2], all of Y(t−L′) to Y(t) are arguments in Equation [8.1]. This score function is defined by Equation [8.4]. P(Yk(t), . . . , Yk(t−L′)) appearing in this equation represents a probability of simultaneous generation of data of adjacent L′+1 frames. Therefore, when Equation [8.1] is used, a dependency relation among adjacent frames can be further reflected on a separation matrix. Examples of the score function include Equation [8.5] (Equation [8.6] is a specific example thereof).

Equation [8.1] is an equation corresponding to Equation [6.2]. When Equation [6.3] is used instead of Equation [6.2], Equation [8.2] corresponds to Equation [6.3].

In the above explanation, the Kullback-Leiblar information is adopted as a scale of independence. However, other scales may be used. As scales representing independence other than the Kullback-Leiblar information, there are non-Gaussianity and kurtosis. A separation matrix may be updated to maximize or minimize the scales.

(2) The Method of Subjecting Spectrograms to Short-Time Fourier Transform (STFT) in the Temporal Direction Again and Solving Convolutive Mixtures as Instantaneous Mixtures

Processing for subjecting spectrograms to short-time Fourier transform (STFT) in the temporal direction again and solving convolutive mixtures as an instantaneous mixing problem to separate observation signals subjected to convolutive mixtures in the time-frequency domain is explained.

When convolutions are subjected to short-time Fourier transform (STFT) with a window length longer than the number of taps, convolutions are converted into a mere product. This also applies to convolutive mixtures in the time-frequency domain. In other words, when Equation [6.4], which is convolutive mixtures in the time-frequency domain, is subjected to short-time Fourier transform (STFT) in the temporal direction again, Equation [9.1] shown below is obtained. Note that X′, A′, and S' are results obtained by subjecting respective elements of X, A, and S in Equation [6.4] to short-time Fourier transform (STFT).

$$\begin{matrix}{X}^{′} ( ω , {ω}_{2} , t ) = {A}^{′} ( ω , {ω}_{2} ) {S}^{′} ( ω , {ω}_{2} , t ) & [ 9.1 ] \\ {Y}^{′} ( ω , {ω}_{2} , t ) = {W}^{′} ( ω , {ω}_{2} ) {X}^{′} ( ω , {ω}_{2} , t ) & [ 9.2 ] \\ {Y}^{′} ( {ω}^{′} , t ) = {W}^{′} ( {ω}^{′} ) {X}^{′} ( {ω}^{′} , t ) & [ 9.3 ] \\ \begin{matrix}I ( {Y}^{′} ) = {\sum }_{k = 1}^{n} H ( {Y}_{k}^{′} ) - H ( {Y}^{′} ) \\ = {\sum }_{k = 1}^{n} {E}_{t} [ - log P ( {Y}_{k}^{′} ( t ) ) ] - log \vert det ( {W}^{′} ) \vert - H ( {X}^{′} )\end{matrix} & [ 9.4 ] \\ Δ {W}^{′} ( {ω}^{′} ) = \{ I + {E}_{t} [ {ϕ}_{ω} \cdot ( {Y}^{′} ( t ) ) {{Y}^{′} ( {ω}^{′} , t )}^{H} ] \} {W}^{′} ( {ω}^{′} ) & [ 9.5 ] \\ {W}^{′} ( {ω}^{′} ) ← {W}^{′} ( {ω}^{′} ) + ηΔ {W}^{′} ( {ω}^{′} ) & [ 9.6 ]\end{matrix}$$

Equation [9.1] is an equation of instantaneous mixtures. In order to separate observation signals into independent components, Equation [9.2] only has to be considered.

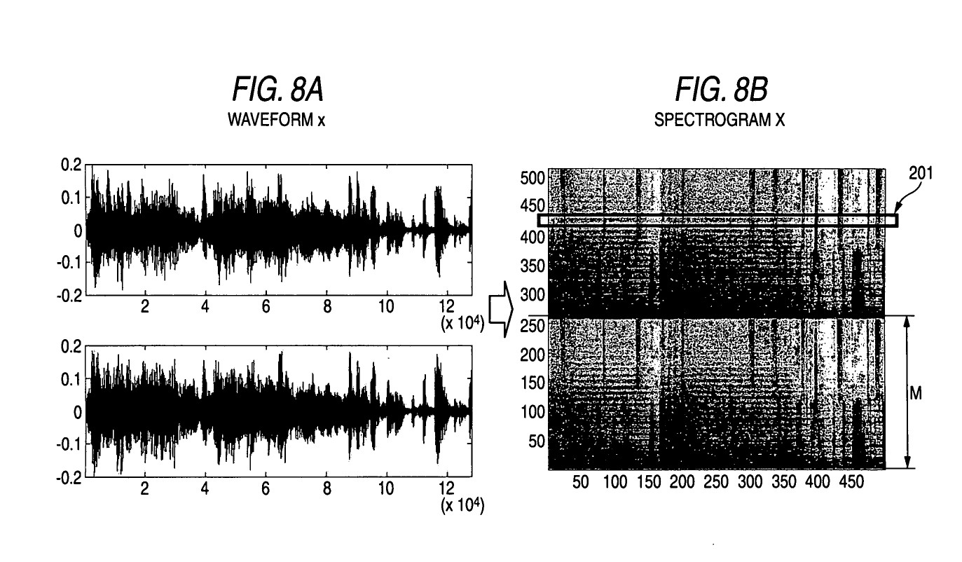

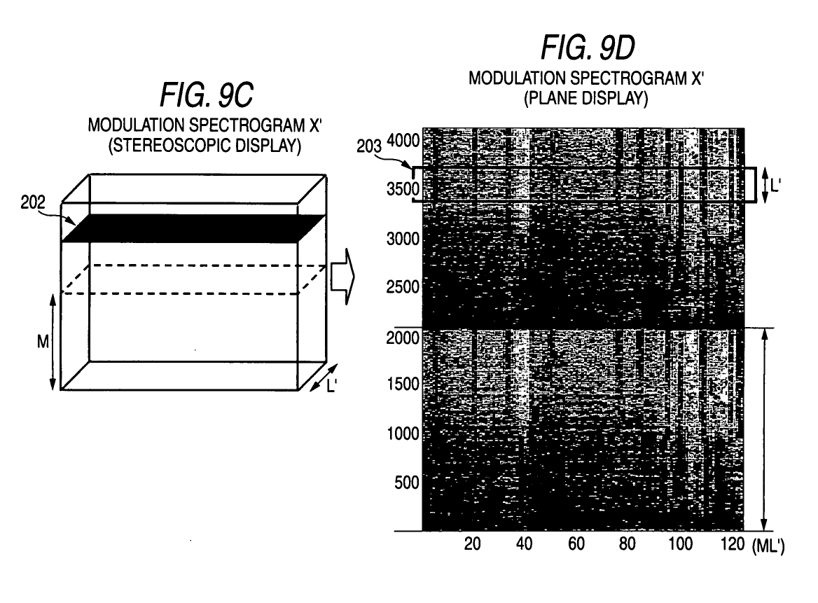

Conversion of spectrograms X into X′ (modulation spectrograms) obtained by subjecting the spectrograms X to short-time Fourier transform (STFT) in the temporal direction again is explained with reference to FIGS. 8A and 8B and FIGS. 9A and 9B. For comparison, conversion of waveforms x into the spectrograms X is also explained.

FIG. 8A is waveforms of observation signals (although the number of channels is set to 2 in the figure, the number of channels is arbitrary).

FIG. 8B is spectrograms generated by subjecting the waveforms of the observation signals (FIG. 8A) to short-time Fourier transform (STFT) (STFT is performed for each of the channels and results of STFT are vertically arranged and displayed). When Fourier transform is performed with a window length of N, N frequency components are obtained. However, since a negative frequency component and a positive frequency component are in a relation of complex conjugate in conversion of real number data (referred to as conjugate symmetry), only N/2+1=M frequency bins of DC components and positive frequency components have to be taken into account. A frequency bin 201 shown in FIG. 8B indicates one of the frequency bins. Usually, a spectrogram indicates a plotted absolute value of x. However, here, X itself is also referred to as spectrogram. The same applies to the original signals S and the separated results Y.

Short-time Fourier transform (STFT) is applied to the spectrograms X show in FIG. 8B again for each of the frequency bins. Data generated by subjecting spectrograms to STFT again is referred to as modulation spectrograms. When a window length of short-time Fourier transform (STFT) in the second time is L′, L′ bins are generated from one frequency bin, for example, the bin 201 shown in FIG. 8B. Therefore, the bins are represented in a depth direction. The bins represented in the depth direction are bins 202 shown in FIG. 9A. A result of integrating the bins 202 is data shown in FIG. 9A.

FIG. 9A is modulation spectrograms generated by applying short-time Fourier transform (STFT) to the spectrograms X shown in FIG. 8B for each of the frequency bins. The modulation spectrograms can be represented by modulation spectrograms X′ of the rectangular parallelepiped structure shown in FIG. 9A. There are frequency components in the depth direction as well. However, the frequency components are not frequency components of waveforms but are frequency components of an envelope. Since data before conversion are also in complex number in the second time short-time Fourier transform (STFT), conversion results don't have conjugate symmetry. Therefore, all the L′ bins have to be taken into account.

The bins generated anew are arranged in the vertical direction instead of the depth direction. When the bins 202 shown in FIG. 9A are arranged like bins 203 shown in FIG. 9B, the modulation spectrograms can be represented in plane as shown in FIG. 9B. Note that, although the modulation spectrograms X′ shown in FIG. 9B are similar to the spectrograms X shown in FIG. 8B at a glance, meanings of the frequency bins are different. (The number of bins per channel is L′ in the spectrograms X shown in FIG. 8B and is M×L′ in the modulation spectrograms X′ shown in FIG. 9B.

Referring back to Equations [9.n] described above, the cubic modulation spectrograms X′ shown in FIG. 9A is equivalent to X′ in Equations [9.1] and [9.2]. ω represents the frequency bins in the vertical direction and ω₂ represents the bins in the depth direction. In Equation [9.2], when a pair (ω, ω₂) is collectively represented by the index ω′, Equation [9.3] is obtained. Equation [9.3] corresponds to the flat modulation spectrogram X′ shown in FIG. 9B.

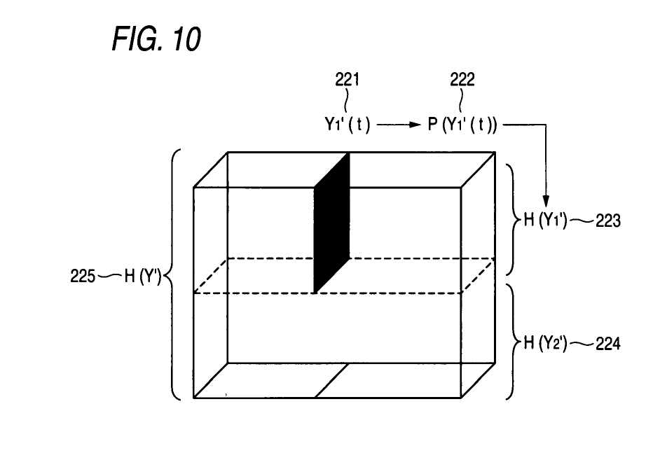

A learning rule (an equation of ΔW) from Equation [9.2] or Equation [9.3] is calculated as described below. As a scale representing independence in all modulation spectrograms, the Kullback-Leiblar information calculated by Equation [9.5] is considered. This equation is substantially identical with Equation [4.5]. However, H(Yk′) is entropy calculated from modulation spectrograms for one channel and H(Y′) is joint entropy calculated from the whole modulation spectrograms. A method of calculating H(Y′) is explained with reference to FIG. 10.

FIG. 10 is equivalent to the cubic modulation spectrograms X′ shown in FIG. 9A. In other words, FIG. 10 is equivalent to, for example, modulation spectrograms generated by further applying short-time Fourier transform (STFT) to the spectrograms X shown in FIG. 8B, which is generated by subjecting the waveforms of the observation signals (FIG. 8A) to short-time Fourier transform (STFT), for each of the frequency bins. In the cubic modulation spectrograms X shown in FIG. 10, for example, in an entropy calculation for the first channel, a modulation spectrogram Y1′(t) 221 of a first frame in FIG. 10 represents a plane. Entropy H(Y1′) 223 is calculated by substituting Y1′ (t) in a multivariate probability density function P(Y1′ (t)) 222, which takes the modulation spectrogram Y1′ (t) 221 as its arguments.

Equation [9.3] is identical with Equation [3.5] except a difference of variable's names. Therefore, in order to derive a learning rule, a variable's name in Equation [5.2] only has to be changed. As a result, Equation [9.5] is obtained. In other words, when Equations [9.3], [9.5], and [9.6] are repeated until W′ converges, Y1′ (t) to Yn′ (t) become independent from one another.

When inverse Fourier transform and overlap add are caused to act on the respective modulation spectrograms Y1′ to Yn′ independent from one another, spectrograms Y1 to Yn independent from one another are obtained.

In the above explanation, the Kullback-Leiblar information is adopted as a scale of independence. However, as in the method (1), other scales may be used. In the above explanation, an equation based on the natural gradient method is derived as an equation for separation matrix update. However, other algorithms may be used instead. Examples of the other algorithms include a gradient method with normal orthogonal constraint, a fixed point method, and a Newton method. This method is the same as the instantaneous mixing ICA in the past in this point.

(3) The Method of Solving Convolutive Mixtures According to Processing as a Combination of Shift Superimposition and an Instantaneous Mixing ICA

Next, processing for separating observation signals subjected to convolutive mixtures in the time-frequency domain according to the processing as a combination of shift superimposition and the instantaneous mixing ICA is explained.

This third processing method is a method of realizing separation processing substantially equivalent to “[(1) the method of directly solving convolutive mixtures in the time domain]. The third processing method is realized by using the instantaneous mixing ICA processing disclosed in JP-A-2006-238409, which is a prior patent application of the applicant.

This method is realized by, for example, after superimposing observation spectrograms while shifting the same, applying the instantaneous mixing ICA in the time-frequency domain, i.e., the instantaneous mixing ICA disclosed in JP-A-2006-238409, which is a prior patent application of the applicant, to a result of superimposing the observation spectrograms. The permutation (replacement) problem is solved by the application of the third method. In addition, highly accurate separation processing performed by taking into account a delay amount is realized for mixed sounds signal having various delay amounts such as direct waves and reflected waves.

Before explaining the third method, the permutation problem that occurs in the separation processing for observation signals and an overview of the instantaneous mixing ICA disclosed in JP-A-2006-238409, which is a prior patent application of the applicant, for solving this problem are briefly explained again.

When original signals independent from one another emitted by n sound sources are represented as s1 to sn and a vector having the original signals as elements is represented as s, observation signals x observed with multiple microphones are signals obtained by applying the convolutive mixture in Equation [1.2] to the original signals s. Next, short-time Fourier transform is applied to the observation signals x to obtain signals X in the time-frequency domain. When an element of X is Xk(ω,t), Xk(ω,t) takes a complex value. A diagram representing |Xk(ω, t)|, which is the absolute value of Xk(ω, t), as shading of a color is called spectrogram of the observation signals shown in FIG. 6B. These spectrograms are spectrograms X of observation signals generated by executing short-time Fourier transform (STFT) on, for example, observation signals acquired by the microphones 121-1 to 121-n shown in FIG. 5.

A spectrogram is a diagram representing |Xk(ω, t)|, which is the absolute value of Xk(ω,t), as shading of a color with t (frame index) set on the abscissa and c (frequency bin index) set on the ordinate. Subsequently, the separated signals Y is obtained by multiplying respective frequency bins of the signals X with the separation matrix W(ω). The separated signals y in the time domain can be obtained by subjecting the separated signals Y to inverse Fourier transform.

However, as described above, in the independent component analysis in the time-frequency domain in the past, the separation processing for a signal is performed for each of the frequency bins and relations among the frequency bins is not taken into account. Therefore, even if the separation itself is successful, it is likely that inconsistency of scaling and inconsistency of separation destinations occur among the frequency bins. The inconsistency of scaling can be solved by a method of estimating an observation signal for each of sound sources. However, it is difficult to solve the inconsistency of separation destinations, for example, the permutation problem in that, whereas signals deriving from S1 appear in Y1 at ω=1, signals deriving from S2 appear in Y1 at ω=2.

JP-A-2006-238409, which is a prior patent application of the applicant, discloses a method of solving the permutation problem. A method of calculating a separation matrix W that maximizes independence in all the spectrograms using Equation [4.4] explained above and shown below as an equation representing separation in all spectrogram is adopted.

$$\begin{matrix}X ( t ) = [ \begin{matrix}{X}_{1} ( 1 , t ) \\ ⋮ \\ {X}_{1} ( M , t ) \\ ⋮ \\ {X}_{n} ( 1 , t ) \\ ⋮ \\ {X}_{n} ( M , t )\end{matrix} ] = [ \begin{matrix}{X}_{1} ( t ) \\ ⋮ \\ {X}_{n} ( t )\end{matrix} ] & [ 4.1 ] \\ Y ( t ) = [ \begin{matrix}{Y}_{1} ( 1 , t ) \\ ⋮ \\ {Y}_{1} ( M , t ) \\ ⋮ \\ {Y}_{n} ( 1 , t ) \\ ⋮ \\ {Y}_{n} ( M , t )\end{matrix} ] = [ \begin{matrix}{Y}_{1} ( t ) \\ ⋮ \\ {Y}_{n} ( t )\end{matrix} ] & [ 4.2 ] \\ W = [ \begin{matrix}{w}_{11} ( 1 ) & & 0 & & {w}_{1 n} ( 1 ) & & 0 \\ & ⋰ & & ⋯ & & ⋰ & \\ 0 & & {w}_{11} ( M ) & & 0 & & {w}_{1 n} ( M ) \\ & ⋮ & & ⋰ & & ⋮ & \\ {w}_{n 1} ( 1 ) & & 0 & & {w}_{nn} ( 1 ) & & 0 \\ & ⋰ & & ⋯ & & ⋰ & \\ 0 & & {w}_{n 1} ( M ) & & 0 & & {w}_{nn} ( M )\end{matrix} ] & [ 4.3 ] \\ Y ( t ) = WX ( t ) & [ 4.4 ] \\ \begin{matrix}I ( Y ) = {\sum }_{k = 1}^{n} H ( {Y}_{k} ) - H ( Y ) \\ = {\sum }_{k = 1}^{n} {E}_{t} [ - log P ( {Y}_{k} ( t ) ) ] - log \vert det ( W ) \vert - H ( X )\end{matrix} & [ 4.5 ]\end{matrix}$$

Specifically, the KL (Kullback-Leiblar) information I(Y) represented by Equation [4.5] is introduced as independence in all the spectrograms to calculate a separation matrix W that minimizes I(Y). The KL information I(Y) is an amount obtained by subtracting joint entropy of all spectrograms from a sum of entropies for each of the spectrograms. When all the spectrograms are independent from one another, the KL information I(Y) is minimized (ideally, 0).

In Equation [4.5] defining the KL information I(Y), H(Yₖ) represents entropy for one spectrogram for each of channels and H(Y) represents joint entropy for the whole spectrograms.

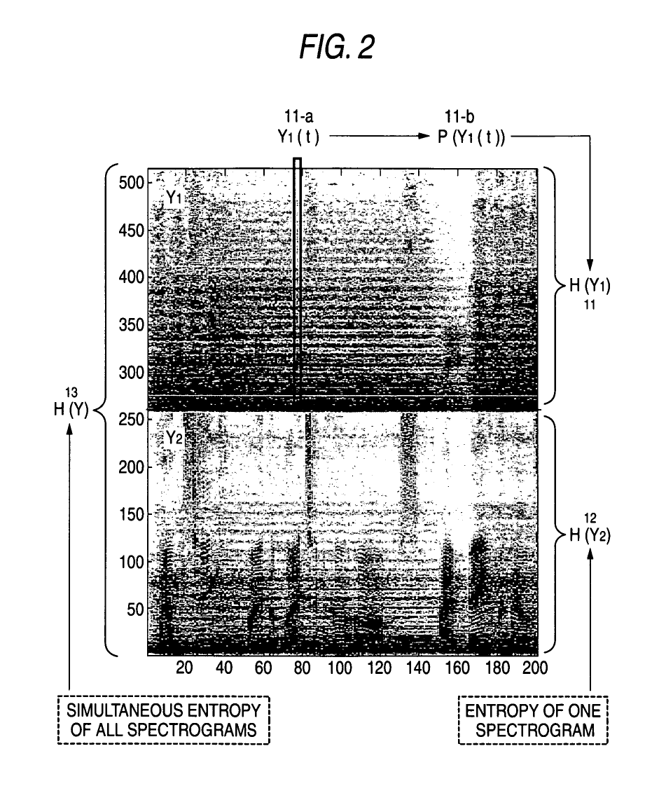

For example, relations between H(Yk) and H(Y) at the case n=2 is as explained above with reference to FIG. 2. In FIG. 2, P(Yₖ (t)) is a probability density function of Yk (t) and H(Yₖ) is entropy for one spectrogram for each of channels. The Kullback-Leiblar information I(Y) is amount obtained by subtracting joint entropy 13 of all spectrograms from a sum of entropies 11 and 12 for each of the spectrograms. When all the spectrograms are independent from one another, the KL information I(Y) is minimized (ideally, 0).

In order to minimize the KL information I(Y) in all the spectrograms, as explained above, Equations [5.1] to [5.3] shown below are repeated until W and Y converge.

$$\begin{matrix}Y ( t ) = WX ( t ) ( t = 1 , … , T ) & [ 5.1 ] \\ Δ W ( ω ) = \{ I + {E}_{t} [ {ϕ}_{ω} ( Y ( t ) ) {Y ( ω , t )}^{H} ] \} W ( ω ) & [ 5.2 ] \\ W ← W + ηΔ W & [ 5.3 ] \\ W ( ω ) = [ \begin{matrix}{w}_{11} ( ω ) & … & {w}_{1 n} ( ω ) \\ ⋮ & ⋰ & ⋮ \\ {w}_{n 1} ( ω ) & … & {w}_{nn} ( ω )\end{matrix} ] & [ 5.4 ] \\ Y ( ω , t ) = [ \begin{matrix}{Y}_{1} ( ω , t ) \\ ⋮ \\ {Y}_{n} ( ω , t )\end{matrix} ] & [ 5.5 ] \\ {ϕ}_{ω} ( Y ( t ) ) = [ \begin{matrix}{ϕ}_{1 ω} ( {Y}_{1} ( t ) ) \\ ⋮ \\ {ϕ}_{n ω} ( {Y}_{n} ( t ) )\end{matrix} ] & [ 5.6 ] \\ {ϕ}_{k ω} ( {Y}_{k} ( t ) ) = \frac{\partial }{\partial {Y}_{k} ( ω , t )} log P ( {Y}_{k} ( t ) ) & [ 5.7 ]\end{matrix}$$

ΔW(ω), W(ω), and Y(ω,t) in Equation [5.3] are submatrices obtained by extracting elements corresponding to a ωth frequency bin from ΔW, W, and Y(t), respectively. This makes it possible to obtain separated results without the permutation problem.

A third processing method is a method of applying the instantaneous mixing ICA in the time-frequency domain disclosed in JP-A-2006-238409. Processing performed by applying the instantaneous mixing ICA in the time-frequency domain disclosed in JP-A-2006-238409 is specifically executed as signal separation processing for generating separated signals in the time-frequency domain from observation signals in the time-frequency domain and a separation matrix in which an initial value is substituted, performing correction of the separation matrix until the generated separated signals in the time-frequency domain and a separation matrix calculated by a multidimensional score function derived from a multidimensional probability density function nearly converge, and applying the corrected separation matrix to generate separated signals in the time-frequency domain. Details of the processing method are as disclosed in JP-A-2006-238409.

In the third processing method explained below, i.e., [(3) processing for separating observation signals subjected to convolutive mixtures in the time-frequency domain according to processing as a combination of shift superimposition and an instantaneous mixing ICA), the instantaneous mixing ICA in the time-frequency domain disclosed in JP-A-2006-238409 is applied. Specifically, for example, this is a method of applying, after superimposing observation spectrograms while shifting the same, the instantaneous mixing ICA in the time-frequency domain to results of superimposing the observation spectrograms. The third method is explained below.

In this method, vectors vertically superimposed while a frame number is shifted with respect to respective observation spectrograms of plural microphones, which are sound input units, are generated. For example, vectors vertically superimposed while a frame number is shifted with respect to observation spectrograms of a kth channel corresponding to a kth microphone, i.e., the observation spectrograms Xₖ (t) in Equation [4.1] are considered. Moreover, a vector formed by superimposing the vectors for all the channels is considered. This is a vector X″(t) in Equation [11.1] shown below. The vector X″ (t) in Equation [11.1] includes vectors for n channels. A vector for each of the channels is indicated as Xₖ″ (t).

$$\begin{matrix}{X}^{″} ( t ) = [ \begin{matrix}{X}_{1} ( t ) \\ ⋮ \\ {X}_{1} ( t + {L}^{′} ) \\ ⋮ \\ {X}_{n} ( t ) \\ ⋮ \\ {X}_{n} ( t + {L}^{′} )\end{matrix} ] = [ \begin{matrix}{X}_{1}^{″} ( t ) \\ ⋮ \\ {X}_{n}^{″} ( t )\end{matrix} ] & [ 11.1 ] \\ {Y}^{[ l ]} ( t ) = {W}^{[ l , 0 ]} X ( t - l ) + … + {W}^{[ l , L ]} X ( t - l + {L}^{′} ) & [ 11.2 ] \\ {Y}^{[ l ]} ( t ) = [ \begin{matrix}{Y}_{1}^{[ l ]} ( t ) \\ ⋮ \\ {Y}_{n}^{[ l ]} ( t )\end{matrix} ] & [ 11.3 ] \\ {W}^{[ l , τ ]} = [ \begin{matrix}{W}_{11}^{[ l , τ ]} & ⋯ & {W}_{1 n}^{[ l , τ ]} \\ ⋮ & ⋰ & ⋮ \\ {W}_{n 1}^{[ l , τ ]} & ⋯ & {W}_{nn}^{[ l , τ ]}\end{matrix} ] & [ 11.4 ] \\ {W}_{ki}^{[ l , τ ]} = [ \begin{matrix}{w}_{ki}^{[ l , τ ]} ( 1 ) & & 0 \\ & ⋰ & \\ 0 & & {w}_{ki}^{[ l , τ ]} ( M )\end{matrix} ] & [ 11.5 ] \\ {Y}^{″} ( t ) = [ \begin{matrix}{Y}_{1}^{[ 0 ]} ( t ) \\ ⋮ \\ {Y}_{1}^{[ {L}^{′} ]} ( t + {L}^{′} ) \\ ⋮ \\ {Y}_{n}^{[ 0 ]} ( t ) \\ ⋮ \\ {Y}_{n}^{[ {L}^{′} ]} ( t + {L}^{′} )\end{matrix} ] = [ \begin{matrix}{Y}_{1}^{′} ( t ) \\ ⋮ \\ {Y}_{n}^{″} ( t )\end{matrix} ] & [ 11.6 ] \\ {W}^{″} = [ \begin{matrix}{W}_{11}^{[ 0 , 0 ]} & ⋯ & {W}_{11}^{[ 0 , {L}^{′} ]} & & {W}_{1 n}^{[ 0 , 0 ]} & ⋯ & {W}_{1 n}^{[ 0 , {L}^{′} ]} \\ ⋮ & ⋰ & ⋮ & ⋯ & ⋮ & ⋰ & ⋮ \\ {W}_{11}^{[ {L}^{′} , 0 ]} & ⋯ & {W}_{11}^{[ {L}^{′} , {L}^{′} ]} & & {W}_{1 n}^{[ {L}^{′} , 0 ]} & ⋯ & {W}_{1 n}^{[ {L}^{′} , {L}^{′} ]} \\ & ⋮ & & ⋰ & & ⋮ & \\ {W}_{n 1}^{[ 0 , 0 ]} & ⋯ & {W}_{n 1}^{[ 0 , {L}^{′} ]} & & {W}_{nn}^{[ 0 , 0 ]} & ⋯ & {W}_{nn}^{[ 0 , {L}^{′} ]} \\ ⋮ & ⋰ & ⋮ & ⋯ & ⋮ & ⋰ & ⋮ \\ {W}_{n 1}^{[ {L}^{′} , 0 ]} & ⋯ & {W}_{n 1}^{[ {L}^{′} , {L}^{′} ]} & & {W}_{nn}^{[ {L}^{′} , 0 ]} & ⋯ & {W}_{nn}^{[ {L}^{′} , {L}^{′} ]}\end{matrix} ] & [ 11.7 ] \\ {Y}^{″} ( t ) = {W}^{″} {X}^{″} ( t ) & [ 11.8 ]\end{matrix}$$

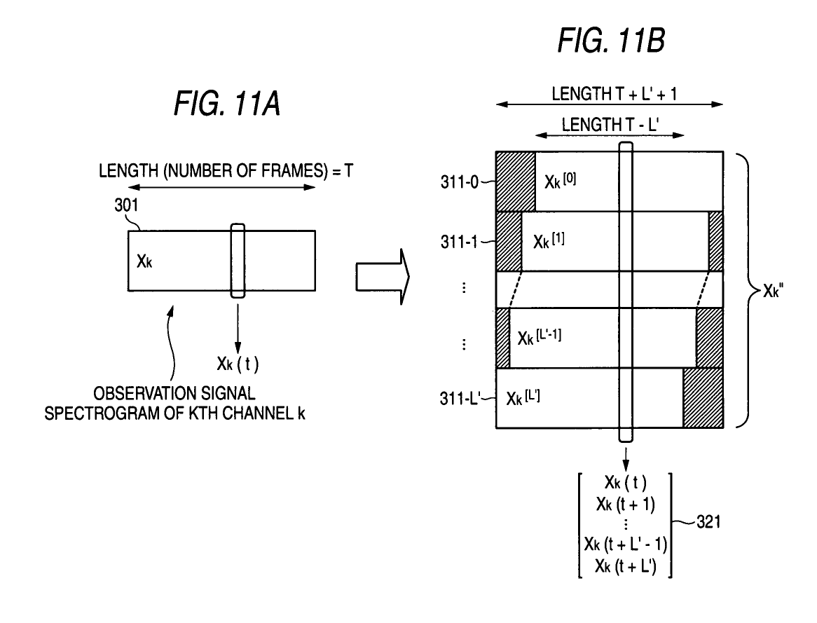

A procedure for generating the vector X″(t) in Equation [11.1] is explained with reference to FIGS. 11A and 11B and subsequent figures. FIGS. 11A and 11B are diagrams for explaining processing for generating the vector X′ (t) for each of the channels from the observation spectrograms Xₖ(t) for each of the channels generated on the basis of input signals of the respective microphones. Data 301 shown in FIG. 11A, i.e., Xₖ is a spectrogram for one channel of observation signals, i.e., an observation spectrograms Xₖ of the kth channel corresponding to a kth microphone. Xₖ is equivalent to X1 and X2 shown in FIG. 6B explained above.

A result obtained by shifting Xₖ to the left by 1 frames at a time is Xₖ[1]. FIG. 11B shows the structure in which plural observation spectrograms Xₖ are vertically superimposed while sequentially changing the shift amount l from 0 to L′. Data 311-0 indicates the shift amount 1=0, data 311-1 indicates the shift amount l=1 frames, . . . , and data 311-L′ indicates the shift amount l=L′ frames. As described above, L′ is the number of frame taps in generating separated results from observation signals.

The observation spectrogram shift set having a shift amount in the plural different frame directions is generated from one observation spectrograms and is represented as the observation spectrogram shift set [X″]. When observation spectrograms for one frame is sliced from the observation spectrograms shift set [X″], Equation 312 shown in FIG. 11B is obtained. This equation corresponds to a vector [Xₖ(t)] corresponding to one channel included in Equation [11.1] Equation [11.1] is, as explained above, a vector including observation spectrograms shift set corresponding to plural channels generated by superimposing, for all the channels, a vector including the observation spectrogram shift set generated by vertically superimposing the observation spectrograms Xₖ(t) corresponding to one channel while shifting a frame number.

As shown in FIG. 11B, a value close to zero is substituted in or values at both ends (X(1), X(T), etc.) are copied and set in gaps formed in the shift, i.e., hatching portions of the data 311-0 to 311-L′ shown in FIG. 11B. When a zero division measure described later is applied, zero may be substituted. Gaps at both the ends may be removed and data for T−L′ frames in the middle may be used. Moreover, instead of normal shift processing, circular shift with length T (for copying data at the left end pushed out by the shift to the right end) may be applied. An example of processing explained below is an example of processing to which the observation spectrogram shift set [X″] generated by the circular shift is applied.

The observation spectrogram shift set [X″] generated by shift processing and superimposing processing shown in FIG. 11B is compared with the original observation spectrograms [X]. The observation spectrograms [X] are spectrograms for n channels. On the other hand, the observation spectrogram shift set [X″] includes spectrograms for n×(L′+1) channels in appearance. Here, n is the number of channels corresponding to the number of microphones and (L′+1) is the number of shift data set in association with one channel.

Assuming that the observation spectrogram shift set [X″] is the observation spectrograms for n×(L′+1) channels, separation processing is performed according to the method to which the instantaneous mixing ICA disclosed in JP-A-2006-238409, which is a prior patent application of the applicant, is applied. Separation equivalent to “(1) the method of directly solving convolutive mixtures in the time-frequency domain” explained above can be performed by this processing. In the following explanation, a principle of the separation is explained.

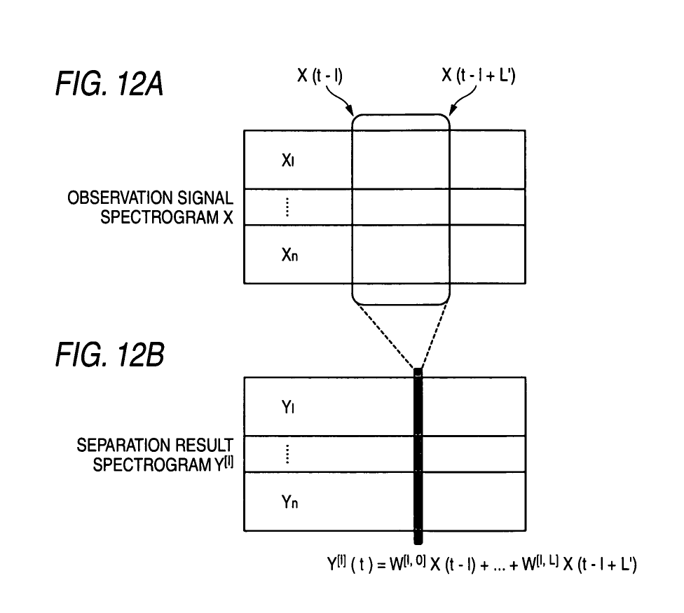

Operation for generating, concerning the observation spectrograms X, separated results by convoluting (t−l)th to (t−l+L′)th frames is examined. This is operation for generating separated results for one frame from L′+1 frames ranging from X(t−l) to X(t−l+L′) as shown in FIGS. 12A and 12B. An equation for obtaining separated signals Y^{[l]}(t) according to this processing is represented by Equation [11.2].

Separated results are represented as Y^{[l]} (t). Since the separated signals Y^{[l]}(t) are convolutions among L′+1 frames, L′+1 matrixes of coefficients are necessary. A separation matrix [W] takes different values depending on the number of shift frames [1], the separation matrix [W] is represented as W^{[1,0]}, to W^{[1,L′]} with two kinds of suffixes attached thereto. In other words, the separation matrix [W] is set according to the umber of shift frames [1] and respective shift spectrograms.

Equation [11.3] and Equation [11.4] are details of submatrices appearing in Equation [11.2]. Equation [11.5] indicates details of a submatrix appearing in Equation [11.4]

Separated signals [Y^{[l]} (t)] and a separation matrix [W^{[l,τ]}] respectively include vectors and matrixes corresponding to components of the respective channels. A suffix τ for W is 0 to L′.

A separated results vector Y″ (t) in Equation [11.6] includes all separated results Y^{[0]}(t) to Y^{[L′]}(t) and a matrix W″ in Equation [11.7] includes plural separation matrices W^{[0,0]} to W^{[L′+1,L′]}. When the vector [Y″(t)] and the matrix [W″] are used, an equation indicating the separation processing can be simply represented as Equation [11.8], i.e., Y″(t)=W″X″(t)

[11.8]

In JP-A-2006-238409 explained above as the method in the past, the processing performed by using Equation [4.4] explained above, i.e., Y(t)=WX(t) as the equation representing separation in all the spectrograms is performed. When Equation [11.8] and Equation [4.4] are compared, since the number of channels is simply increased from n to n×(L′+1) in Equation [11.8], Equation [4.4] can be regarded as applied.

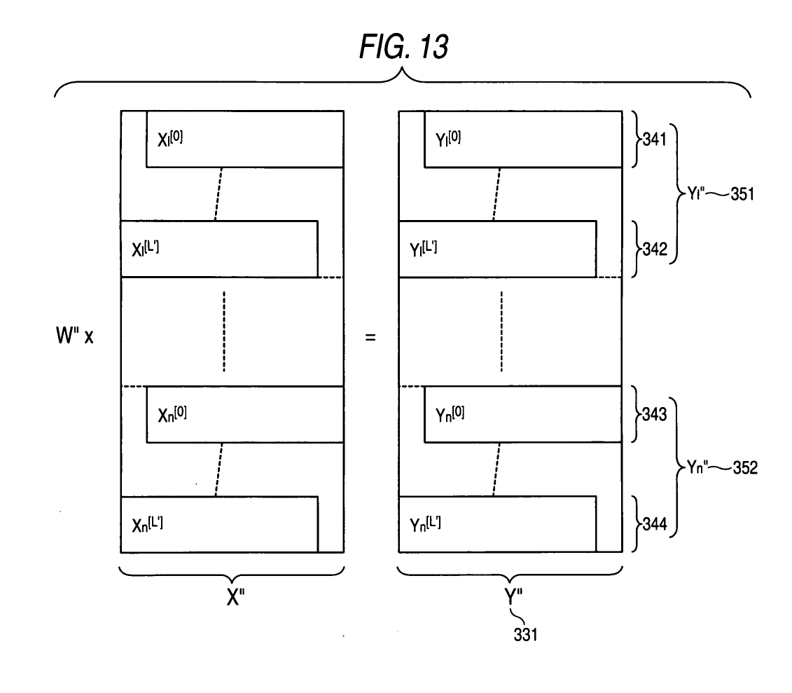

As shown in FIG. 13, the observation spectrogram shift set [X″] for the plural channels include X1″ to Xn″. If X1″ to Xn″ are considered as observation spectrograms corresponding to n×(L′+1) individual channels, since the number of channels is simply increased from n to n×(L′+1) in Equation [11.8], Equation [4.4] can be regarded as applied.

Therefore, the observation spectrograms X for n channels is expanded to n×(L′+1) channels according to the method explained with reference to FIGS. 11A and 11B and Equations [5.1] to [5.3], which are the learning rules disclosed in JP-A-2006-238409, are repeatedly applied to the observation spectrogram shift set [X″], which is a result of the expansion. Then, separated results Y″ and a separation matrix W″ are obtained.

Note that, in Equations [5.4] to [5.7] as details of variables of Equations [5.1] to [5.3], n is replaced with n×(L′+1) and k is an index representing 1≦k≦n×(L′+1) rather than 1≦k≦n.

The separated results Y″ include spectrograms for n×(L′+1) channels. However, spectrograms for n channels (or less than n channels) are desired. Therefore, spectrograms are selected according to necessity. As a method of selection, for example, a method of leaving only components corresponding to a specific shift amount [l] such as Y₁^{[0]}, Y₂^{[0]}, . . . , Yₙ^{[0]} in the separated results Y″ is applicable.

Alternatively, as the number of frame taps in generating separated results from observation signals, as in the method of determining a value of L′, an optimum shift amount [l] in the frame direction may be calculated using known signals. In other words, after the known signals are emitted from one or more speakers or the like and sound recording and separation are performed by the method according to the embodiments of the present invention, an SIR (signal-interference-ratio), which are a scale of separation accuracy, is calculated for each of separated results Yₖ^{[0]} to Yₖ^{[L′]}. Separated results [Yk^{[l]}] corresponding to the number of shifts l realizing the highest separation accuracy (SIR) is selected. Such processing is possible.

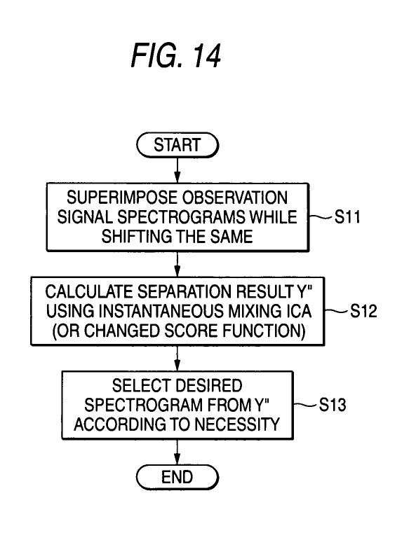

A flowchart for explaining a sequence of (3) the processing for separating observation signals subjected to convolutive mixtures in the time-frequency domain according to the processing as a combination of shift superimposition and the instantaneous mixing ICA is shown in FIG. 14. Processing in respective steps in a flow shown in FIG. 14 is explained.

First, in step S11, the signal separating device superimposes observation spectrograms while shifting the same. This processing is the processing explained with reference to FIGS. 11A and 11B. The signal separating device sequentially shifts observation spectrograms, which are generated from observation signals acquired by respective microphones, in shift frame (l) units. The signal separating device generates shift data and superimposes the shift data until the number of frame taps reaches a shift amount equivalent to L′ to generate the observation spectrogram shift set [X″].

Subsequently, in step S12, the signal separating device calculates separated results Y″ using the instantaneous mixing ICA (or a changed score function). In other words, the signal separating device repeatedly applies Equations [5.1] to [5.3], which are the learning rules disclosed in JP-A-2006-238409, to the observation spectrogram shift set [X″] to calculate separated results Y″ and a separation matrix W″. Note that, in Equations [5.4] to [5.7] as details of variables of Equations [5.1] to [5.3], n is replaced with n×(L′+1) and k is an index representing 1≦k≦n×(L′+1) rather than 1≦k≦n.

The score function is defined as logarithmic derivative of a probability density function and defined in Equation [5.7]. As explained concerning Equation [7.5] in [(1) the method of directly solving convolutive mixtures in the time-frequency domain], as disclosed in JP-A-2006-238409, permutation can be prevented from occurring by using a multivariate score function. Processing performed by using this score function is described later.

In step S13, the signal separating device selects a desired spectrogram from the separated results Y″ according to necessity. As described above, the separated results Y″ includes spectrograms for n×(L′+1) channels. However, since spectrograms for n channels (or less than n channels) are desired, spectrograms are selected according to necessity.

As a selection method, a method of leaving only components corresponding to a specific shift amount [l] such as Y₁^{[0]}, Y₂^{[0]}, . . . , Yₙ^{[0]} in the separated results Y″ is applicable. In this case, such a processing that the separated results [Yk^{[1]}] corresponding to the number of shifts l realizing the highest separation accuracy (SIR) is selected is possible.

The method explained above is equivalent to execution of processing substantially equivalent to the method of using Equations [7.2] to [7.5] explained in [(1) the method of directly solving convolutive mixtures in the time-frequency domain]. This example of processing is processing for separating signals of n×(L′+1) channels to be independent from one another. For example, referring to FIG. 13, signals Y₁^{[0]} 341 for one spectrogram in signals Y″ 331, which are separated results obtained as results of applying the observation spectrogram shift set [X″] for the plural channels, is not only independent from signals Yₙ^{[0]} 343 and Yₙ^{[L′]} 344 deriving from other sound sources but also independent from Y₁^{[L′]} 342 that should derive from an identical sound source.

On the other hand, by changing the score function (Equation [5.7], etc.) used in the method, it is possible to perform processing equivalent to the method of using Equations [8.1] to [8.4] explained in [(1) the method of directly solving convolutive mixtures in the time-frequency domain].

The method of using Equations [8.1] to [8.4] explained in [(1) the method of directly solving convolutive mixtures in the time-frequency domain] is processing based on the assumption that “Yk(t−L′) to Yk(t) are dependent on one another”. In this example of processing [(3) the processing as a combination of shift superimposition and an instantaneous mixing ICA], processing that takes into account dependency of separated results is also possible. Referring to FIG. 13, separation for making Y₁^{[0]} 341 independent from Yₙ^{[0]} 343 and Yₙ^{[L′]} 344 and dependent on Y₁^{[L′]} 342 can be performed. A method of the separation is explained below.

To make the separate results Yₖ^{[0]} to Yₖ^{[L′]} deriving from the identical sound source dependent on one another, Equation [12.1] shown below is used instead of Equation [5.2] for calculating ΔW(ω) explained above.

$$\begin{matrix}Δ {W}^{″} ( ω ) = \{ I + {E}_{t} [ {ϕ}_{ω} ( {Y}^{″} ( t ) ) {{Y}^{″} ( ω , t )}^{H} ] \} {W}^{″} ( ω ) & [ 12.1 ] \\ Δ {W}^{″} ( ω ) = \{ I + {E}_{t} [ {ϕ}_{ω} ( {Y}^{″} ( t ) ) {{Y}^{″} ( ω , t )}^{H} - {Y}^{″} ( ω , t ) {{ϕ}_{ω} ( {Y}^{″} ( t ) )}^{H} - {Y}^{″} ( ω , t ) {{Y}^{″} ( ω , t )}^{H} ] \} {W}^{″} ( ω ) & [ 12.2 ] \\ {Y}^{″} ( ω , t ) = [ \begin{matrix}{Y}_{1}^{[ 0 ]} ( ω , t ) \\ ⋮ \\ {Y}_{1}^{[ {L}^{′} ]} ( ω , t + {L}^{′} ) \\ ⋮ \\ {Y}_{n}^{[ 0 ]} ( ω , t ) \\ ⋮ \\ {Y}_{n}^{[ {L}^{′} ]} ( ω , t + {L}^{′} )\end{matrix} ] & [ 12.3 ] \\ {W}^{″} ( ω ) = [ \begin{matrix}{w}_{11}^{[ 0 , 0 ]} ( ω ) & ⋯ & {w}_{11}^{[ 0 , {L}^{′} ]} ( ω ) & & {w}_{1 n}^{[ 0 , 0 ]} ( ω ) & ⋯ & {w}_{1 n}^{[ 0 , {L}^{′} ]} ( ω ) \\ ⋮ & ⋰ & ⋮ & ⋯ & ⋮ & ⋰ & ⋮ \\ {w}_{11}^{[ {L}^{′} , 0 ]} ( ω ) & ⋯ & {w}_{11}^{[ {L}^{′} , {L}^{′} ]} ( ω ) & & {w}_{1 n}^{[ {L}^{′} , 0 ]} ( ω ) & ⋯ & {w}_{1 n}^{[ {L}^{′} , {L}^{′} ]} ( ω ) \\ & ⋮ & & ⋰ & & ⋮ & \\ {w}_{n 1}^{[ 0 , 0 ]} ( ω ) & ⋯ & {w}_{n 1}^{[ 0 , {L}^{′} ]} ( ω ) & & {w}_{nn}^{[ 0 , 0 ]} ( ω ) & ⋯ & {w}_{nn}^{[ 0 , {L}^{′} ]} ( ω ) \\ ⋮ & ⋰ & ⋮ & ⋯ & ⋮ & ⋰ & ⋮ \\ {w}_{n 1}^{[ {L}^{′} , 0 ]} ( ω ) & ⋯ & {w}_{n 1}^{[ {L}^{′} , {L}^{′} ]} ( ω ) & & {w}_{nn}^{[ {L}^{′} , 0 ]} ( ω ) & ⋯ & {w}_{nn}^{[ {L}^{′} , {L}^{′} ]} ( ω )\end{matrix} ] & [ 12.4 ] \\ {ϕ}_{ω} ( {Y}^{″} ( t ) ) = [ \begin{matrix}{ϕ}_{1 ω}^{[ 0 ]} ( {Y}_{1}^{″} ( t ) ) \\ ⋮ \\ {ϕ}_{1 ω}^{[ {L}^{′} ]} ( {Y}_{1}^{″} ( t ) ) \\ ⋮ \\ {ϕ}_{n ω}^{[ 0 ]} ( {Y}_{n}^{″} ( t ) ) \\ ⋮ \\ {ϕ}_{n ω}^{[ {L}^{′} ]} ( {Y}_{n}^{″} ( t ) )\end{matrix} ] & [ 12.5 ] \\ {ϕ}_{k ω}^{[ l ]} ( {Y}_{k}^{″} ( t ) ) = \frac{\partial }{\partial {Y}_{k}^{[ l ]} ( ω , t )} log P ( {Y}_{k}^{″} ( t ) ) & [ 12.6 ]\end{matrix}$$

$$\begin{matrix}{ϕ}_{ω} ( {Y}^{″} ( t ) ) {{Y}^{″} ( ω , t )}^{H} = [ \begin{matrix}{ϕ}_{1 ω}^{[ 0 ]} ( {Y}_{1}^{″} ( t ) ) \overline{{Y}_{1}^{[ 0 ]} ( ω , t )} & ⋯ & {ϕ}_{1 ω}^{[ 0 ]} ( {Y}_{1}^{″} ( t ) ) \overline{{Y}_{1}^{[ {L}^{′} ]} ( ω , t + {L}^{′} )} & & {ϕ}_{1 ω}^{[ 0 ]} ( {Y}_{1}^{″} ( t ) ) \overline{{Y}_{n}^{[ 0 ]} ( ω , t )} & ⋯ & {ϕ}_{1 ω}^{[ 0 ]} ( {Y}_{1}^{″} ( t ) ) \overline{{Y}_{n}^{[ {L}^{′} ]} ( ω , t + {L}^{′} )} \\ ⋮ & ⋰ & ⋮ & ⋯ & ⋮ & ⋰ & ⋮ \\ {ϕ}_{1 ω}^{[ {L}^{′} ]} ( {Y}_{1}^{″} ( t ) ) \overline{{Y}_{1}^{[ 0 ]} ( ω , t )} & ⋯ & {ϕ}_{1 ω}^{[ {L}^{′} ]} ( {Y}_{1}^{″} ( t ) ) \overline{{Y}_{1}^{[ {L}^{′} ]} ( ω , t + {L}^{′} )} & & {ϕ}_{1 ω}^{[ {L}^{′} ]} ( {Y}_{1}^{″} ( t ) ) \overline{{Y}_{n}^{[ 0 ]} ( ω , t )} & ⋯ & {ϕ}_{1 ω}^{[ {L}^{′} ]} ( {Y}_{1}^{″} ( t ) ) \overline{{Y}_{n}^{[ {L}^{′} ]} ( ω , t + {L}^{′} )} \\ & ⋮ & & ⋰ & & ⋮ & \\ {ϕ}_{n ω}^{[ 0 ]} ( {Y}_{n}^{″} ( t ) ) \overline{{Y}_{1}^{[ 0 ]} ( ω , t )} & ⋯ & {ϕ}_{n ω}^{[ 0 ]} ( {Y}_{n}^{″} ( t ) ) \overline{{Y}_{1}^{[ {L}^{′} ]} ( ω , t + {L}^{′} )} & & {ϕ}_{1 ω}^{[ 0 ]} ( {Y}_{n}^{″} ( t ) ) \overline{{Y}_{n}^{[ 0 ]} ( ω , t )} & ⋯ & {ϕ}_{n ω}^{[ 0 ]} ( {Y}_{n}^{″} ( t ) ) \overline{{Y}_{n}^{[ {L}^{′} ]} ( ω , t + {L}^{′} )} \\ ⋮ & ⋰ & ⋮ & ⋯ & ⋮ & ⋰ & ⋮ \\ {ϕ}_{n ω}^{[ {L}^{′} ]} ( {Y}_{n}^{″} ( t ) ) \overline{{Y}_{1}^{[ 0 ]} ( ω , t )} & ⋯ & {ϕ}_{n ω}^{[ {L}^{′} ]} ( {Y}_{n}^{″} ( t ) ) \overline{{Y}_{1}^{[ {L}^{′} ]} ( ω , t + {L}^{′} )} & & {ϕ}_{n ω}^{[ {L}^{′} ]} ( {Y}_{n}^{″} ( t ) ) \overline{{Y}_{n}^{[ 0 ]} ( ω , t )} & ⋯ & {ϕ}_{n ω}^{[ {L}^{′} ]} ( {Y}_{n}^{″} ( t ) ) \overline{{Y}_{n}^{[ {L}^{′} ]} ( ω , t + {L}^{′} )}\end{matrix} ] & [ 12.7 ] \\ {E}_{t} [ {ϕ}_{k ω}^{[ α ]} ( {Y}_{k}^{″} ( t ) ) \overline{{Y}_{i}^{[ β ]} ( ω , t + β )} ] ≅ {E}_{t} [ {ϕ}_{k ω}^{[ 0 ]} ( {Y}_{k}^{″} ( t ) ) \overline{{Y}_{i}^{[ β - α ]} ( ω , t + β - α )} ] & [ 12.8 ] \\ {E}_{t} [ {Y}^{″} ( ω , t ) {{ϕ}_{ω} ( {Y}^{″} ( t ) )}^{H} ] = {{E}_{t} [ {ϕ}_{ω} ( {Y}^{″} ( t ) ) {{Y}^{″} ( ω , t )}^{H} ]}^{H} & [ 12.9 ] \\ {E}_{t} [ {Y}^{″} ( ω , t ) {{Y}^{″} ( ω , t )}^{H} ] = {W}^{″} {E}_{t} [ {X}^{″} ( ω , t ) {{X}^{″} ( ω , t )}^{H} ] {W}^{″ H} & [ 12.10 ] \\ {X}^{″} ( ω , t ) = [ \begin{matrix}{X}_{1} ( ω , t ) \\ ⋮ \\ {X}_{1} ( ω , t + {L}^{′} ) \\ ⋮ \\ {X}_{n} ( ω , t ) \\ ⋮ \\ {X}_{n} ( ω , t + {L}^{′} )\end{matrix} ] & [ 12.11 ] \\ {E}_{t} [ {X}_{k} ( ω , t + α ) \overline{{X}_{i} ( ω , t + β )} ] ≅ {E}_{t} [ {X}_{k} ( ω , t ) \overline{{X}_{i} ( ω , t + β - α )} ] & [ 12.12 ] \\ {E}_{t} [ {X}_{i} ( ω , t + β ) {X}_{k} ( ω , t + α ) ] = \overline{{E}_{t} [ {X}_{k} ( ω , t + α ) \overline{{X}_{i} ( ω , t + β )} ]} & [ 12.13 ]\end{matrix}$$

Note that Y″(ω, t) and W″(ω) in Equation [12.1] are a vector and a matrix formed by extracting components of a ωth frequency bin from Y″ and W″, respectively, and are represented as Equation [12.3] and Equation [12.4]. φω(Y″ (t)) is a vector having n×(L″+1) score functions as elements as represented by Equation [12.5]. (A specific example of the score functions is described later.)

A difference between Equation [12.5] and Equation [5.6] is present in arguments of the score functions. When Equation [5.6] is expanded to n×(L′+1) channels, all of the n×(L′+1) score functions take different arguments. On the other hand, in Equation [12.5], φ_{kω}^{[0]}(Yₖ″(t)) to φ_{kω}^{[L′]}(Yₖ″(t)) take the identical argument Yₖ″ (t). Therefore, there are n kinds of arguments.

The score function φ_{kω}^{[l]}(Yₖ″(t)) is defined as logarithmic derivative of a multidimensional (multivariate) probability density function having Yₖ″(t) (i.e., Yₖ^{[0]} to Yₖ^{[L′]}) as arguments (Equation [12.5]). It is theoretically demonstrated that, when plural arguments are included in one probability density function in this way and learning of an ICA is performed using a score function derived from the arguments, elements forming the arguments have dependency on one another (not independent from one another). In other words, referring back to FIG. 13, in signals Y₁″ 351 as a set of Y₁^{[0]} to Y₁^{[L′]}, elements in the set have dependency on one another. However, the signals Y₁″ 351 are independent from signals of other sets, for example, Yₙ″ 352.

Specific examples of the multidimensional probability density function and the score function are explained. As a type of the multidimensional probability density function, there is a so-called spherical distribution. This is generated by substituting an L2 norm of a vector in a function having a scalar as an argument as indicated by Equation [13.1] shown below (“∝” represents proportion).

$$\begin{matrix}P ( {Y}_{k}^{″} ( t ) ) ∝ f ( {‖ {Y}_{k}^{″} ( t ) ‖}_{2} ) & [ 13.1 ] \\ {‖ {Y}_{k}^{″} ( t ) ‖}_{m} = {\{ {\sum }_{τ = 0}^{{L}^{′}} {\sum }_{ω = 1}^{M} {\vert {Y}_{k}^{[ τ ]} ( ω , t + τ ) \vert}^{m} \}}^{1 / m} & [ 13.2 ] \\ P ( {Y}_{k}^{″} ( t ) ) ∝ exp ( - γ {‖ {Y}_{k}^{″} ( t ) ‖}_{2} ) & [ 13.3 ] \\ {ϕ}_{k ω}^{[ l ]} ( {Y}_{k}^{″} ( t ) ) = - γ \frac{{Y}_{k}^{[ l ]} ( ω , t + τ )}{{‖ {Y}_{k}^{″} ( t ) ‖}_{2}} & [ 13.4 ] \\ {ϕ}_{k ω}^{[ l ]} ( {Y}_{k}^{″} ( t ) ) = - {γ}_{k}^{[ l ]} ( ω ) \frac{{Y}_{k}^{[ l ]} ( ω , t + τ )}{{‖ {Y}_{k}^{″} ( t ) ‖}_{m} + {β}_{k}^{[ l ]} ( ω )} & [ 13.5 ]\end{matrix}$$

The L2 norm is a square root of a square sum of (absolute values) of respective elements and is obtained by substituting 2 in m of Equation [13.2]. When a distribution based on an exponential distribution indicated by Equation [13.3] (γ is a positive real number) is used as an example of the spherical distribution, Equation [13.4] is derived as a score function corresponding thereto. This equation only has to be substituted in Equation [12.5].

Like Equation [7.6] explained in [(1) the method of directly solving convolutive mixtures in the time-frequency domain], Equation [13.4] may be changed. An example of the change is indicated as Equation [13.5]. Examples of the change are as described below.

1) A positive value βₖ^{[l]} (ω) is added to a denominator to prevent zero division. As the value, a different value is used for each of k, 1, and ω.
2) An L-m norm (Equation [13.2]) is used instead of the L2 norm.
3) A different positive value γₖ^{[l]}(ω) is used for each of k, l, and ω instead of a coefficient K of the score function.

Equation [12.1] is an update rule based on the natural gradient method. However, algorithm other than the update rule based on the natural gradient method can also be used. For example, an update rule based on an algorithm for simultaneously performing decorrelation and separation of signals, which is called “Equivariant Adaptive Separation via Independence: EASI), is as indicated by Equation [12.2]. When this algorithm is used, it is possible to cause learning to converge in a smaller number of times compared with the natural gradient method.

When attention is paid to symmetry of elements of matrixes in Equation [12.1] and Equation [12.2], it is possible to reduce computational cost. This point is explained below.

Terms in parentheses of ET[ ] in Equation [12.1] are expanded to a matrix of (L′+1)n×(L′+1)n indicated by Equation [12.7] (an upper line represents a complex conjugate). In calculating averages of elements of this equation, if relative shift amounts are the same in φkω^{[α]}(Yₖ″(t)) as a first term and Yᵢ^{[β]}(ω,t) as a second element of the respective elements (α and β are integers satisfying a condition 0≦x, β≦L′), values after averaging are substantially the same values. In other words, a relation of Equation [12.8] holds. In particular, when the circular shift described above is used as shift, completely identical values are obtained.

When this characteristic is used, values have to be actually calculated for only 2(L′+1)n² elements among {(L′+1)n}² elements in Equation [12.7]. Values of the remaining elements only have to be reused according to Equation [12.8].

Similarly, reduction of computational cost is also possible for Equation [12.2]. Among the three terms in the parentheses of ET[ ], calculation same as Equation [12.1] can be performed for a first term. For a second term, after calculating the first term, Hermite transposition has to be simply calculated (Equation [12.9]). For a third term, reduction of computational cost is possible by performing modification of Equation [12.10]. Note that X″(ω,t) of Equation [12.10] is a vector formed by extracting an element corresponding to a ωth frequency bin from Equation [11.1] and can be represented as Equation [12.11].

Seventeen pieces of Et[X″(ω,t)X″(ω,t)^{H}] are typically fixed during learning. Therefore, Et[X″(ω,t)X″(ω,t)^{H}] only has to be calculated once before learning and it is unnecessary to perform averaging operation every time during the learning. In other words, computational cost can be reduced more in the right side than in the left side of Equation [12.10].

In the calculation of Et[X″(ω,t)X″ (ω,t)^{H}], Equation [12.12] having symmetry same as that of Equation [12.8] and Equation [12.13] symmetrical to a diagonal linehold. Therefore, only (L′+1)² elements among the {(L′+1)n}² elements have to be actually calculated.

Specific Examples of the Structure and Examples of Processing

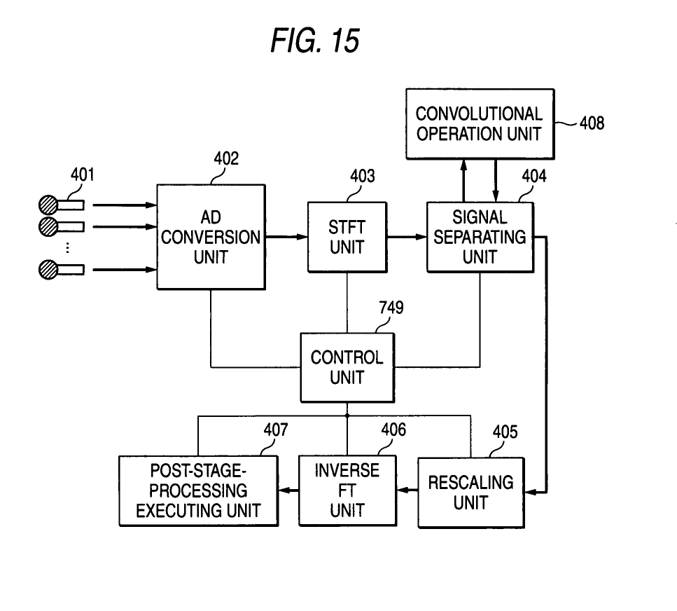

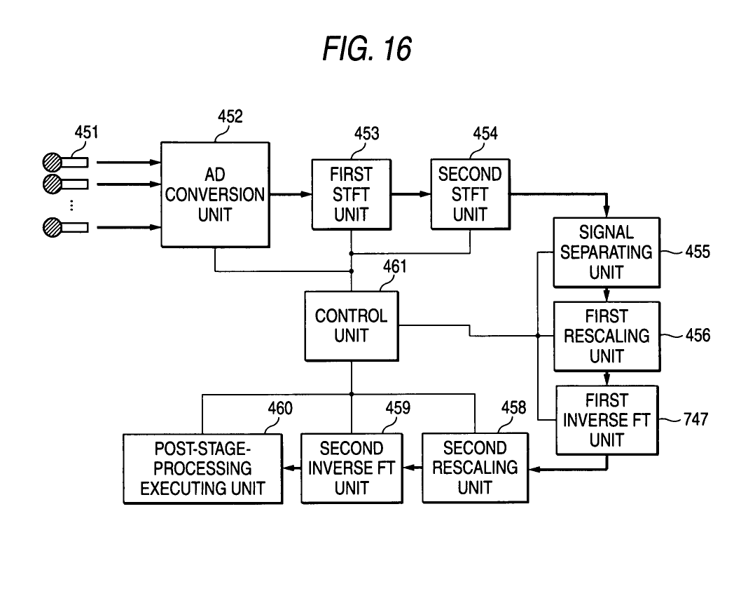

Examples of the structure of the signal separating device according to an embodiment of the present invention are shown in FIGS. 15 and 16. FIG. 15 is a diagram of an example of the structure of a signal separating device that executes a method of solving convolutive mixtures in the time-frequency domain.

FIG. 16 is a diagram of an example of the structure of a signal separating device that executes a method of converting an observation spectrograms into a modulation spectrogram and, then, solving instantaneous mixtures.

(1) The Structure for Executing the Method of Solving Convolutive Mixtures in the Time-Frequency Domain

First, the structure and processing of the signal separating device that executes the method of solving convolutive mixtures in the time-frequency domain shown in FIG. 15 are explained. Comprehensive control of the processing explained below is executed in a control unit 409. The control unit 409 controls the processing in accordance with, for example, a program, which is stored in a storing unit (not shown) of the device in advance, for executing the processing explained below. Processing of respective components is explained below. Plural microphones 401 observe independent sounds emitted by plural sound sources. An AD conversion unit 402 converts input analog signals into digital signals to obtain digital observation signals.

The digital observation signals are inputted to a short-time Fourier transform (STFT) unit 403 and short-time Fourier transform processing is performed to obtain spectrograms of the observation signals. Processing up to this point is equivalent to, for example, the processing for obtaining spectrograms X of observation signals shown in FIG. 6B.

A signal separating unit 404 separates the spectrograms X of the observation signals generated by the short-time Fourier transform (STFT) unit 403 into independent components. The signal separating device shown in FIG. 15 adopts the method of directly solving convolutive mixtures in the time-frequency domain as processing for separating an observation signals subjected to convolutive mixtures in the time-frequency domain. The signal separating device executes the separation processing for the observation signals by repeatedly performing the calculations of Equations [6.2], [7.2], [7.1], and [7.8] until a separation matrix and separated results sufficiently converge (or a fixed number of times). The separated results Y shown in FIG. 6C are obtained by this separation processing.

Processing performed by a convolution unit 408 is processing according to the processing explained with reference to FIGS. 6A to 6C. This is processing performing by taking into the fact that observation signals X(t) of a tth frame in observation signals are affected by original signals for preceding L+1 frames when a maximum value of a delay is set as L+1. This is convolution performed by representing the observation signals X(t) with convolutive mixtures of Equation [6.1] to which the number of frame taps L is applied, setting Y(t+L′) in separated signals in FIG. 6C as a reference, representing separated signals Y(t) as convolutive mixtures from X(t−L′) to X(t) as indicated by Equation [6.2] taking into account data for immediately preceding L+1 frames in order to estimate S(t), and applying Equation [6.2] and Equation [7.2].

The number of frame taps L′ for generating the separated results Y from the observation signals X, i.e., the separated results Y shown in FIG. 6C from the observation signals X shown in FIG. 6B only has to be set as L′=αL (α is an appropriate positive real number) if L is known (i.e., reverberation time is known) as described above. When L is unknown, L′ is determined by, for example, any one of methods described below.

(a) A method of setting L′ to a fixed value such as 64 or 100
(b) A method of measuring reverberation time and setting a value of L calculated from the reverberation time as L′
(c) A method of performing separation under various values of L′ and adopting a value of L′ that produces the best separated results. For example, a separation performance scale called SIR (signal-interference ratio) is calculated and L′ that produces the highest SIR is adopted.

L′, i.e., the number of frame taps L′ for generating the separated results Y from the observation signals x, specifically, for example, the number of frame taps L′ for generating the separated results Y shown in FIG. 6C from the observation signals X shown in FIG. 6B is determined according to any one of the methods. Separated results are generated from plural consecutive frames of observation signals by using the number of frame taps L′.

A resealing unit 405 applies resealing processing for adjusting a scale to respective frequency bins of separated signals. Rescaling is processing for adjusting a scale for each of the frequency bins. When normalization (adjustment of their mean and variance) is applied to the observation signals before separation processing, the effect of the normalization is recovered.

An inverse Fourier transform unit 406 converts spectrograms of the separated signals into signals in the time domain using inverse Fourier transform. The converted signals are sent to a post-stage-processing executing unit 407 according to necessity. Post-stage processing is playback from as peaker, speech recognition, and the like. Depending on the post-stage processing, it is also possible to remove the inverse Fourier transform unit.

As described above, the signal separating device shown in FIG. 15 is the signal separating device that is inputted with signals formed by mixing plural sound signals and separates the signals into individual sound signals. The signal separating device includes signal converting means (the STFT unit 403) for converting an input signal into the time-frequency domain and generating observation spectrograms and signal separating means (the signal separating unit 404) for generating separated results from the observation spectrograms generated by the signal converting means (the STFT unit 403). The signal separating means (the signal separating unit 404) interprets the observation spectrograms as observation signals subjected to convolutive mixtures in the time-frequency domain and generates separated results according to execution of convolution in the convolution unit 408.

The signal converting means (the STFT unit 403) executes processing for executing short-time Fourier transform (STFT) on the input signals and converts the input signals into the time-frequency domain to generate observation spectrograms.

The signal separating means (the signal separating unit 404) sets separated signals Y(t) of a frame number (t) as convolutive mixtures of observation signals X(t−L′) to X(t) and generates separated results according to processing for improving independence of respective individual sound signal components Y1(t) to Yn(t) included in the separated signals Y(t). Specifically, the signal separating means (the signal separating unit 404) generates separated results by performing, as the processing for improving independence of the respective individual signal components Y1(t) to Yn(t) included in the separated signals Y(t), update processing for a separation matrix for applying Kullback-Leiblar information I(Y) as an independence measure and minimizing the Kullback-Leiblar information I(Y).

As the structure of the device that executes (3) the processing for separating observation signals subjected to convolutive mixtures in the time-frequency domain according to processing as a combination of shift superimposition and the instantaneous mixing ICA, for example, the structure in which the convolutive operation unit 408 is removed from the structure shown in FIG. 15 can be applied. Processing executed in the signal separating unit is different.

In the device that performs the processing as a combination of shift superimposition and the instantaneous mixing ICA, the STFT unit 403 functions as signal converting means for converting input signals into the time-frequency domain and generating observation spectrograms. The signal separating unit 404 is configured to perform processing for generating separated results from the observation spectrograms generated by the signal converting means. As explained with reference to FIGS. 11A and 11B to FIG. 14, the signal separating unit 404 shifts the observation spectrograms in the frame direction, generates the observation spectrogram shift set formed by superimposing data having different shift amounts, and generates separated results according to processing for applying an instantaneous mixing ICA (Independent Component Analysis) to the generated the observation spectrogram shift set. The processing performed by applying the instantaneous mixing ICA is executed as the method disclosed in JP-A-2006-238409, i.e., processing for generating separated signals in the time-frequency domain from observation signals and a separation matrix, correcting the separation matrix until the generated separated signals in the time-frequency domain and a separation matrix calculated by a multidimensional score function derived from a multidimensional probability density function nearly converge, and generating separated signals in the time-frequency domain by applying the corrected separation matrix.

(2) The Structure for Executing a Method of Converting Observation Spectrograms into Modulation Spectrograms and, then, Solving Instantaneous Mixtures

The structure and the processing of the signal separating device shown in FIG. 16 that executes the method of converting observation spectrograms into modulation spectrograms and, then, solving instantaneous mixtures are explained. Comprehensive control of processing explained below is executed in a control unit 461. The control unit 461 controls the processing in accordance with a program, which is stored in a storing unit (not shown) of the device in advance, for executing the processing explained below. Processing of respective components is explained below. Plural microphones 451 observe independent sounds emitted by plural sound sources. An AD conversion unit 452 converts input analog signals into digital signals to obtain digital observation signals.

The digital observation signals are inputted to a first short-time Fourier transform (STFT) unit 453 and short-time Fourier transform processing is performed to obtain spectrograms of the observation signals. Signals obtained at this stage is, for example, the spectrograms X shown in FIG. 8B. The spectrograms of the observation signals obtained by the short-time Fourier transform (STFT) processing at the first stage is inputted to a second short-time Fourier transform (STFT) unit 454. Short-time Fourier transform (STFT) is executed for each of frequency bins to obtain modulation spectrograms.

The modulation spectrograms obtained by short-time Fourier transform (STFT) in the second short-time Fourier transform (STFT) unit 454 is, for example, the modulation spectrograms X′ shown in FIGS. 9A and 9B.

A signal separating unit 455 is inputted with the modulation spectrograms X′ and separates the modulation spectrograms X′ into independent components. This separation processing is the processing explained with reference to FIG. 10 above. FIG. 10 is equivalent to the cubic modulation spectrograms X′ shown in FIG. 9A. In the cubic modulation spectrograms X′ shown in FIG. 10, for example, in an entropy calculation for the first channel, the modulation spectrogram Y1′ (t) 221 of the first frame in FIG. 10 represents a plane. The entropy H(Y1′) 223 is calculated by substituting Y1′ (t) in the multivariate probability density function P(Y1′ (t)) 222, which takes the modulation spectrogram Y1′ (t) 221 as an argument. Equation [9.3] is identical with Equation [3.5] except a difference of variable names. Therefore, in order to derive a learning rule, a variable name of Equation [5.2] only has to be changed. As a result, Equation [9.5] is obtained. In other words, when Equations [9.3], [9.5], and [9.6] are repeated until W′ converges, Y1′ (t) to Yn′ (t) become independent from one another.

A first rescaling unit 456 applies rescaling to modulation spectrograms. Rescaling is processing for adjusting a scale for each of the frequency bins. A first inverse Fourier transform (FT) unit 457 executes inverse Fourier transform (FT) processing on the rescaled modulation spectrograms and converts the modulation spectrograms into spectrograms. Thereafter, a second rescaling unit 458 performs rescaling again. A second inverse Fourier transform (FT) unit 459 executes inverse Fourier transform (FT) processing on the rescaled spectrograms and converts the spectrograms into waveforms. The signals converted into the waveforms are sent to a post-stage-processing executing unit 461 according to necessity. The post-stage-processing executing unit 461 executes post-stage processing corresponding to necessity. The post-stage processing is playback from one or more loud speakers, speech recognition, and the like.

As described above, the signal separating device shown in FIG. 16 is the signal separating device that is inputted with signals formed by mixing plural signals and separates the signals into individual signals. The signal separating device includes first signal converting means (the first STFT unit 453) for converting input signals into the time-frequency domain and generating observation spectrograms, second signal converting means (the second STFT unit 454) for executing data conversion on the observation spectrograms generated by the first signal converting means (the first STFT unit 453) and generates modulation spectrograms, and signal separating means (the signal separating unit 455) for generating separated results from the modulation spectrograms generated by the second signal converting means (the second STFT unit 454). The signal separating means (the signal separating unit 455) interprets the modulation spectrograms as instantaneous mixtures and generates separated results.

The first signal converting means (the first STFT unit 453) executes short-time Fourier transform (STFT) on the input signals and converts the input signals into the time-frequency domain to generate observation spectrograms. The second signal converting means (the second STFT unit 454) further executes short-time Fourier transform (STFT) in the temporal direction on the observation spectrograms and generates modulation spectrograms.

The signal separating means (the signal separating unit 455) generates separated results according to processing for improving independence of respective individual signal components Y1′ to Yn′ corresponding to separated signals included in the modulation spectrograms. Specifically, the signal separating means (the signal separating unit 455) generates separated results by performing, as the processing for improving independence of the respective individual signals components Y1′ to Yn′ corresponding to the separated signals, update processing for a separation matrix for applying Kullback-Leiblar information I(Y) as an independence measure and minimizing the Kullback-Leiblar information I(Y).

The inverse Fourier transform means (the first inverse FT unit 457) executes inverse Fourier transform on the respective signal components Y1′ to Yn′ corresponding to the separated signal obtained by the signal separating means (the signal separating unit 455) and generates spectrograms Y1 to Yn corresponding to the separated signals.

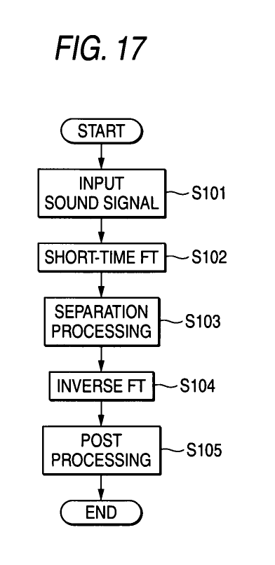

An example of a sequence of processing executed by the signal separating device according to the embodiment of the present invention is explained with reference to a flowchart shown in FIG. 17. In step S101, the signal separating device observes sounds using the microphones. For example, as explained with reference to FIG. 5 above, the signal separating device acquires mixed signals of sounds outputted from plural sound sources using the microphones. Next, in step S102, the signal separating device executes short-time Fourier transform (STFT) for observation signals to obtain spectrograms. Short-time Fourier transform is the processing explained with reference to FIGS. 7A and 7B. The signal separating device obtains spectrograms according to this processing. These spectrograms are, for example, the spectrograms shown in FIG. 6B.

In step S103, the signal separating device applies separation processing by an ICA to the spectrograms of the observation signals. Details of a processing sequence of the separation processing are described later. In step S104, the signal separating device executes inverse Fourier transform (IFT) on separated results according to necessity and, thereafter, executes post-stage processing in step S105 according to necessity.

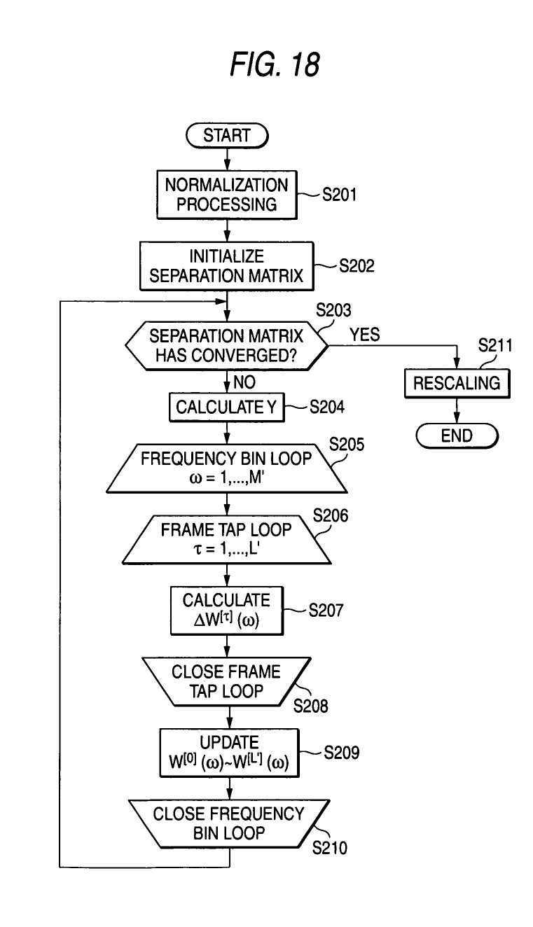

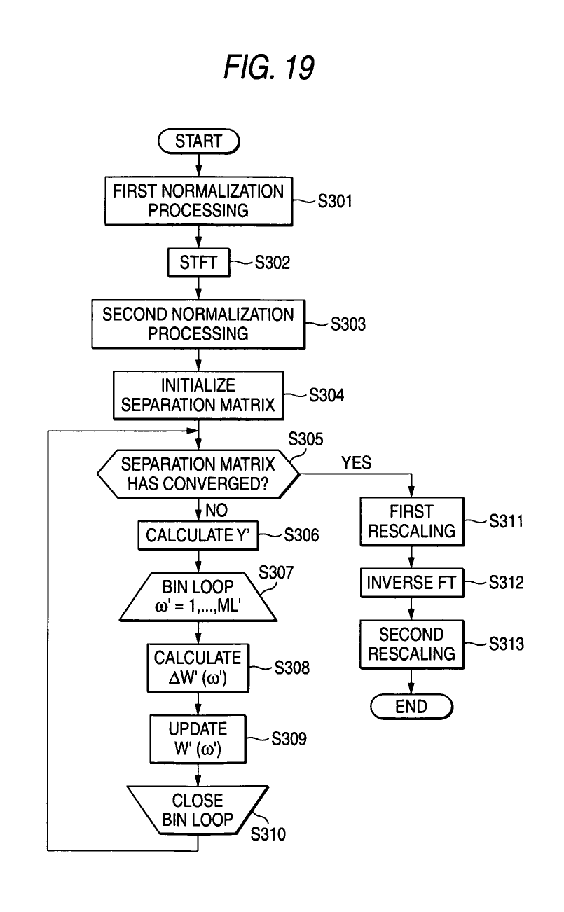

Detailed sequences of the separation processing executed in step S103 are explained with reference to flowcharts shown in FIGS. 18 and 19.

The separation processing sequences shown in FIGS. 18 and 19 are respectively the specific sequences of the separation processing executed in the signal separating device explained with reference to FIGS. 15 and 16.

FIG. 18 is a flowchart of the detailed sequence of separation processing in the method of solving convolutive mixtures in the time-frequency domain executed by the signal separating device shown in FIG. 15. FIG. 19 is a flowchart of the detailed sequence of separation processing in the method of converting observation spectrograms into modulation spectrograms and, then, solving instantaneous mixtures executed by the signal separating device shown in FIG. 16.

First, the separation processing in the method of solving convolutive mixtures in the time-frequency domain executed by the signal separating device shown in FIG. 15, i.e., a separation processing sequence for performing deconvolution in the time-frequency domain is explained with reference to FIG. 18.

First, in Step S201, the signal separating device applies normalization to observation spectrograms. Normalization processing in this processing is processing for setting, with respect to respective frequency bins of spectrograms, their mean to 0 and setting their variance to 1 or adjusting their mean and variance to values convenient to processing after that. Subsequently, in step S202, the signal separating device performs initialization processing for a separation matrix, i.e., substitutes initial values in a separation matrix W^{[τ]}. As the initial values, the identity matrix only has to be substituted in W^{[0]} and a zero matrix only has to be substituted in the separation matrix W^{[τ]} (τ>0). When a separation matrix calculated in the last learning is present, the separation matrix may be used as the initial value.

Steps S203 to S210 form a loop of learning. The signal separating device repeats this loop until a separation matrix and separated results converge. In other words, the signal separating device repeatedly executes a loop including step S203 for judging whether the separation matrix converges, step S204 for calculating a separated signal Y, step S205 for starting a frequency bin loop (ω=1, . . . , M), step S206 for starting a frame tap loop (τ=0, . . . L), step S207 for calculating an increment ΔW^{[τ]} corresponding to a τth frame tap, step S208 for finishing the frame tap loop, step S209 for updating ΔW^{[0]} (ω) to W^{[L′]} (ω), and step S210 for finishing the frequency bin loop.

For the calculation of the separated results Y in step S204, Equation [6.2] or Equation [6.3] explained above is used. (Y=[Y(1), . . . , Y(T)].) Steps S205 to S210 form a loop for frequency bins. With M set as the number of frequency bins, the signal separating device repeats steps S206 to S209 for respective frequencies (ω) that satisfy a condition 1≦ω≦M. Instead of the loop, parallel processing for each of the frequency bins may be performed. In the method disclosed in JP-A-2006-238409, which is a prior patent application of the applicant, only one separation matrix is estimated (or one separation matrix is estimated for each of the frequency bins). However, in this embodiment, it is necessary to estimate separation matrixes equivalent to the number of frame taps. Therefore, the signal separating device turns the loop the number of times equivalent to the number of frame taps (steps S206 to S208).

In step S207, the signal separating device calculates an increment ΔW^{[τ]} (ω) corresponding to the τth frame tap. For the calculation of ΔW^{[τ]}(ω), Equation [7.1] is used. As described above, Rω^{[l]} in Equation [7.1] is difference according to which of Equation [6.2] and Equation [6.3] is used for the calculation of the separated results Y.

When Equation [6.2] is used for the calculation of the separated results Y, Equation [7.2] or Equation [8.1] is used for the calculation of Rω^{[l]}. When Equation [6.3] is used for the calculation of the separated results Y, Equation [7.3] or Equation [8.2] is used for the calculation of Rω^{[l]}.

After leaving the loop for the frame taps in steps S206 to S208, in step S209, the signal separating device updates separation matrixes ΔW^{[0]}(ω) to ΔW^{[L′]}(ω) using Equation [7.8]. This processing may be performed collectively for all the frequency bins after step S210. (Note that, on the other hand, it is difficult to put the processing in the frame taps).

After leaving the loop for the frequency bins in steps S205 to S210, the signal separating device returns to the convergence check in step S203. When it is judged in step S204 that the separation matrix converges (or the steps are looped a predetermined number of times), the signal separating device proceeds to the right in a branch and shifts to step S211.

The judgment in step S203 on whether the separation matrix converges may be performed according to, for example, whether the norm ∥ΔW∥ of ΔW (norm of a matrix is calculated by, for example, Equation [7.10]) is below a certain value (or whether ∥ΔW∥/∥W∥ is below a certain value). Alternatively, a fixed number of times of loop may be simply set and executed.

When it is judged in step S203 that the separation matrix does not converge yet, the signal separating device repeatedly executes the processing at steps S204 to S210. When it is judged in step S204 that the separation matrix converges (or the steps are looped the predetermined number of times), the signal separating device proceeds to the right in a branch and shifts to step S211. In step S211, the signal separating device performs rescaling. The rescaling is processing for adjusting a scale for each of the frequency bins. When the mean and variance of the frequency bins are changed in the normalization processing step (S201), the signal separating device recovers the mean and variance according to necessity.

A coefficient of the resealing executed in step S211 is calculated as described below. The signal separating device calculates a scale with which a squared error between the observation signals and the separated results is minimized in a certain frequency bin (specifically, the method of least squares or the like is used). The signal separating device updates the separated results to a value obtained by multiplying the separated results with the scale (Equation [7.12]). The signal separating device also updates the separation matrix itself according to necessity (Equation [7.13]).

The coefficient may be calculated as described below. The signal separating device represents observation signals as a linear sum of separated results and a constant using Equation [7.14]. The signal separating device calculates scales αₖ₁(ω) to αₖₙ(ω) and a constant term βk(ω) using Equation [7.15] (specifically, the method of least squares or the like is used). When the scales are calculated, the signal separating device updates the separated results using Equation [7.16]. (The signal separating device also updates the separation matrix according to necessity.)

When all terms αₖⱼ(ω)Yⱼ(ω, t) appearing in Equation [7.14] are outputted, outputs in single-input-multiple-output (SIMO) format is obtained. The SIMO outputs from ICA means that “observation signals are resolved into components deriving from respective sound sources”. For example, Yⱼ is assumed to be estimated results of the ith sound source, αₖⱼ(ω)Yⱼ(ω,t) represents “components deriving from the ith sound source among signals observed by the kth microphone”. The flowchart in solving convolutive mixtures in the time-frequency domain has been explained.

Next, processing in solving instantaneous mixtures in the modulation spectrogram domain is explained with reference to the flowchart shown in FIG. 19. FIG. 19 is the flowchart of the detailed sequence of the separation processing in the method of converting observation spectrograms into modulation spectrograms and, then, solving instantaneous mixtures executed by the signal separating device shown in FIG. 16.

In step S301, the signal separating device applies normalization to observation spectrograms. This processing is processing same as the normalization processing in step S201 in the flow shown in FIG. 18. The processing is processing for setting, with respect to respective frequency bins of spectrograms, their mean to 0 and setting their variance to 1 or adjusting their mean and variance to values convenient to processing after that. In step S302, the signal separating device performs short-time Fourier transform (STFT) for each of the frequency bins and generates modulation spectrograms, i.e., the modulation spectrograms X′ shown in FIGS. 9A and 9B.

For the generation of the modulation spectrograms, as explained with reference to FIG. 16 above, it is necessary to apply short-time Fourier transform (STFT) processing in the first short-time Fourier transform (STFT) unit 453 to digital observation signals to obtain spectrograms of the observation signals (e.g., the spectrograms X shown in FIG. 8B), input the spectrograms of the observation signals obtained by short-time Fourier transform (STFT) at the first stage to a second short-time Fourier transform (STFT) unit 454, and execute short-time Fourier transform (STFT) again for each of the frequency bins. Modulation spectrograms obtained by short-time Fourier transform (STFT) in the second short-time Fourier transform (STFT) unit 454 are, for example, the modulation spectrograms X′ shown in FIGS. 9A and 9B.

As the modulation spectrograms, as shown in FIGS. 9A and 9B, there are cubic modulation spectrograms (equivalent to Equation [9.2]) and flat modulation spectrograms (equivalent to Equation [9.3]). In the following explanation, the flat modulation spectrograms are used. In other words, both the bins in the vertical direction and the depth direction shown in FIG. 9A are collectively represented as an index ω′.

In step S303, the signal separating device applies normalization to the respective bins ω′ of the modulation spectrograms again. Before a loop of learning, in step S304, the signal separating device substitutes an initial value in the separation matrix W′. The initial value may be the identity matrix or may be a separation matrix calculated by the last learning.

Steps S305 to S310 form a loop of learning. The signal separating device repeats this loop until the separation matrix W′ converges (or a fixed number of times). A convergence judgment in step S305 is the same as the processing in step S203 explained with reference to FIG. 18. The judgment on whether the separation matrix converges may be performed according to, for example, whether a norm ∥ΔW′∥ of ΔW′ (a norm of a matrix is calculated by, for example, Equation [7.10]) is below a certain value (or ∥ΔW′∥/∥W′∥ is below a certain value). Alternatively, a fixed number of times of loop may be simply set and executed.

In step S306, the signal separating device calculates separated result modulation spectrograms Y′. As this calculation, Equation [9.3] only has to be applied to all elements ω′ and t.

Steps S307 to S310 form a loop for the respective bins ω′ of the modulation spectrograms shown in FIG. 9A, i.e., the bins ω′ in both the vertical direction and the depth direction. Instead of the loop for performing repetition processing for the respective bins, processing for the respective bins may be executed as parallel processing. In step S308, the signal separating device calculates an increment of the separation matrix (Equation [9.5]). In step S309, the signal separating device updates the separation matrix (Equation [9.6]).

In step S310, after leaving the loop, the signal separating device returns to the convergence judgment in step S305. When it is judged in step S305 that the separation matrix converges (or the steps are looped a predetermined number of times), the signal separating device proceeds to the right in a condition branch. In step S311, the signal separating device performs resealing. The resealing is processing for adjusting a scale of each of bins. The signal separating device applies the resealing to the separated result modulation spectrograms. A method of the resealing is substantially the same as the processing in step S211 explained with reference to FIG. 18 above. The resealing is performed on the basis of an equation formed by appropriately replacing Y, X, and W in Equations [7.11] to [7.16] with Y′, X′, and W′. Processing for resetting the normalization in step S301 is also performed according to necessity.

In step S312, the signal separating device executes inverse Fourier transform (FT) for converting the modulation spectrograms into spectrograms. In that case, the signal separating device performs weighted overlap add (WOLA) and the like according to necessity. In other words, in inverse Fourier transform (FT), the signal separating device superimposes inverse transform results (waveforms) for respective frames with overlap. This is referred to as overlap add. A window function such as a sine window may be caused to act on the inverse transform results again before overlap add. This is referred to as weighted overlap add (WOLA). Noise deriving from discontinuity among the frames can be reduced by WOLA.

In step S313, the signal separating device applies resealing to the spectrograms. This is processing same as the resealing in step S311.

In inverse Fourier transform (FT) executed in step S104 in the flow shown in FIG. 17 and in step S312 in the flow shown in FIG. 19, inverse Fourier transform (FT) is applied to the separation matrix itself as well besides the spectrograms and the modulation spectrograms of the separated results according to necessity.

Modification

An embodiment obtained by modulating the embodiment described above is explained. In the embodiment described above, as the frame tap L′ applied in generating separated results, i.e., the frame tap L′ in generating separated results from observation signals, a fixed value is used in all frequencies. However, a value of the frame tap L′ may be changed for each of the frequencies instead of uniformly setting the fixed value for all the frequencies.

For example, since a component of a high frequency is suddenly attenuated compared with a component of a low frequency, reverberation time of the component is short. Therefore, for a frequency bin corresponding to the high frequency, a value of the frame tap L′ may be set smaller than that of a low frequency bin. In this way, it is possible to reduce computation cost while keeping separation performance.

The separation processing in the method is explained with reference to the signal separating device shown in FIG. 16 and the flowchart shown in FIG. 19. This is the method of converting observation spectrograms into modulation spectrograms and, then, solving instantaneous mixtures. In the method, in short-time Fourier transform (STFT) in the second time, besides setting the number of frame taps L′ different for each of the frequency bins, it is also possible to set a shift width different. However, when the number of frame taps or the shift width is set different for each of the frequency bins, it is likely that time length per one frame is different in the modulation spectrograms.

For example, in short-time Fourier transform (STFT) in the second time, when the number of taps is 32 and the shift width is 16 for the low frequency and the number of taps is 16 and the shift width is 8 for the high frequency, time length per one frame in the modulation spectrograms after the transformation at the low frequency is twice as high as that at the high frequency. In other words, the number of frames per unit time is smaller at the low frequency than that at the high frequency (a half that at the high frequency).

When the time length per one frame is fixed, as shown in FIG. 10, it is possible to slice the Yk′(t) 221 from the modulation spectrograms and calculate their independence. However, when the time length per one frame is not fixed, this is difficult. In such a case, inconsistency of frames is dealt with by using any one of methods (methods 1 to 3) explained below.

Method 1: Curtailment of Frame Data

In the generated modulation spectrograms, the number of data of a bin with a larger number of frames per unit time is adjusted to the number of data of a bin with a smaller number of frames by curtailing data from the bin with the larger number of frames. In the examples of thirty-two taps and sixteen shifts and sixteen taps and eight shifts described above, when every other data is curtailed from the bin subjected to short-time Fourier transform (STFT) of sixteen taps and eight shifts, the numbers of frames per unit time of both the bins coincide with each other (i.e., times per one frame are the same).

Method 2: Interpolation of Frame Data

Conversely to the method 1, this is a method of adjusting the number of data of a bin with a smaller number of frames per unit time to the number of data of a bin with a larger number of frames. In the example of thirty-two taps and sixteen shifts and sixteen taps and eight shifts, interpolation of data is applied to a bin subjected to short-time Fourier transform (STFT) of thirty-two taps and sixteen shifts. For example, by calculating an average of frame data, new data is inserted between the frame data.

Method 3: Overlap of Frame Data

As in the method 2, this is a method of adjusting the number of data of a bin with a smaller number of frames per unit time to the number of data of a bin with a larger number of frames. In the example of thirty-two taps and sixteen shifts and sixteen taps and eight shifts, data is caused to overlap twice for a bin subjected to short-time Fourier transform (STFT) of thirty-two taps and sixteen shifts, respectively, to adjust the number of data of the bin to that of a bin subjected to short-time Fourier transform (STFT) of sixteen taps and eight shifts.

A modification for “setting a value of [L′], i.e., a value of the number of frame taps [L′] in generating separated results from observation signals different for each of frequencies” is explained. This modification is a modification of the processing for separating observation signals subjected to convolutive mixtures in the time-frequency domain according to (3) the method by processing as a combination of shift superimposition and an instantaneous mixing ICA explained with reference to FIGS. 11A and 11B to FIG. 14, i.e., the method of superimposing observation spectrograms while shifting the same and subjecting the observation spectrograms to the instantaneous mixing ICA (e.g., the method disclosed in JP-A-2006-238409).

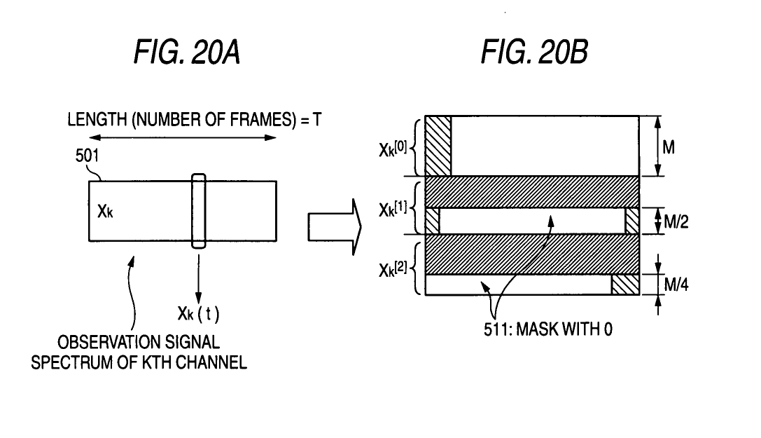

In order to realize this modification, i.e., the modification for “setting a value of the number of frame taps [L′] different for each of frequencies”, the following processing only has to be performed. L′ different for each of frequency bins is represented as L′(ω). In the shift processing explained with reference to FIGS. 11A and 11B, when a shift amount exceeds “L′(ω)”, data of the frequency bin is replaced with “0”. A method of replacing the data is explained with reference to FIGS. 20A and 20B.

It is assumed that a value of the number of frame taps [L′(ω)] different for each of the frequency bins is desired to be changed as described below according to a frequency bin number ω. (M is the number of frequency bins per one spectrogram)
L′(ω)=2 when 1≦ω<M/4
L′(ω)=1 when M/4≦ω<M/2
L′(ω)=0 when M/2≦ω<M

In order to realize the change, the following operation is applied to data Xₖ^{[0]}, Xₖ^{[1]}, and Xₖ^{[2]} generated by the shift processing explained with reference to FIGS. 11A and 11B.
Xₖ^{[0]} means that Xₖ is kept as it is. (Shift=0 is necessary in all the frequency bins)
Xₖ^{[1]} means that a frequency bin of M/2≦ω is masked by 0. (Shift equal to or larger than 1 is unnecessary when M/2≦ω)
Xₖ^{[2]} means that a frequency bin of M/4≦ω is masked by 0. (Shift equal to or larger than 2 is unnecessary when M/4≦ω)

Specifically, as shown in FIG. 20B, a data portion 511 painted black is a portion masked by 0. In actual processing, it is unnecessary to allocate memory for the masked portion. If a portion corresponding to the mask is skipped in accessing a spectrogram, it is possible to prevent an increase in processing time and a memory amount.

When the instantaneous mixing ICA in the time-frequency domain in the past (e.g., JP-A-2006-238409) is combined with the processing described above as pre-processing according to the embodiment of the present invention, it is possible to control an increase in processing time to some extent. In the following explanation, the combination of both the kinds of processing is explained. Examples of respective kinds of processing described below are explained in order.

(1) Basic two-stage separation

(2) Reduction of the number of channels

(3) Use as reverberation removal

(1) Basic Two-Stage Separation

In the instantaneous mixing ICA in the time-frequency domain in the past, when an analysis frame (or an analysis window) shorter than reverberation is used, it is difficult to entirely remove disturbing sound extending over plural frames. On the other hand, computational cost is smaller than that in the embodiment of the present invention (if an analysis frame length in STFT in the first time is the same). Therefore, if separation is performed in the time-frequency domain ICA in the past and spectrograms as results of the separation is further separated by the method according to the embodiment of the present invention, it is possible to attain equivalent separation accuracy in shorter time compared with the separation only by the method according to the embodiment.

In particular, when “(1) the method of directly solving convolutive mixtures in the time-frequency domain” according to the embodiment of the present invention is used, it is possible to cause the method in the past and the method according to the embodiment to operate seamlessly. In other word, it is possible to make use of the characteristic that, when L′ is set to 0 in Equation [7.2] and Equation [8.1] (or Equation [7.3] and Equation [8.2]), the method is equivalent to the method in the past. In the learning loop in steps S203 to S210 in the flow shown in FIG. 18, while the number of times of loop is small, L′ is set to 0 and, when the number of times of loop exceeds a certain value, L′ only has to be reset to an original value. L′ may be increases little by little according to an increase in the number of times of loop.

(2) Reduction of the Number of Channels

In general, computational cost of ICA is proportional to the square of the number of channels. Therefore, if it is possible to reduce the number of channels, it is possible to substantially reduce the computational cost. When two-stage separation is used, it is possible to reduce the number of channels of the steps according to the embodiment of the present invention. A method of reducing the number of channels is explained.

In an ICA in the time-frequency domain, when the number of microphones is larger than the number of sound sources, signals judged as corresponding to none of the sound sources are outputted from some of output channels. For example, when there are four microphones and three sound sources, three of the output channels correspond to the sound sources. However, signals like mixtures of background noise and reverberant sounds corresponding to none of the sound sources are outputted from the remaining one. Since such outputs have extremely small power compared with that of the other channels and have correlation with all the other channels, the outputs can be easily detected.

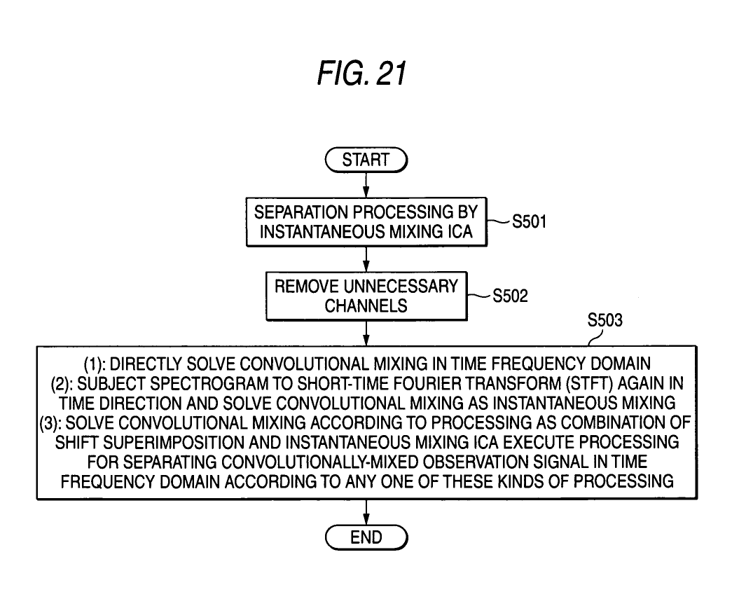

Therefore, in two-stage separation, first, separation processing by the instantaneous mixing ICA in the time-frequency domain is performed in step S501 in accordance with a flowchart shown in FIG. 21. This processing can be executed as the processing disclosed in JP-A-2006-238409. Thereafter, in step S502, for example, after removing “zero or more output channels judged as corresponding to none of the sound sources” (unnecessary channels), the processing for separating observation signals subjected to convolutive mixtures in the time-frequency domain are executed by the processing according to the embodiment of the present invention, i.e., processing of any one of the following method:

(1) the method of directly solving convolutive mixtures in the time-frequency domain;
(2) the method of subjecting spectrograms to short-time Fourier transform (STFT) in the temporal direction again and solving convolutive mixtures as instantaneous mixtures; and
(3) the method of solving convolutive mixtures according to processing as a combination of shift superimposition and an instantaneous mixing ICA.
Then, it is possible to reduce computational cost in separation processing. Since separation is possible when the number of input channels is equal to the number of sound sources, the reduction in the number of channels in step S502 does not affect separation accuracy.

For example, this two-stage processing is applied to (1) the method of directly solving convolutive mixtures in the time-frequency domain. In this case, the signal separating means generates the first separated results according to processing for applying an instantaneous mixing ICA (Independent Component Analysis) to observation spectrograms, executes processing for removing zero or more unnecessary channels judged as corresponding to none of sound sources from the first separated results, and executes processing for solving convolutive mixtures in the time-frequency domain on the observation spectrograms remaining after the removal processing to generate separated results.

This two-stage processing is applied to (2) the method of subjecting spectrograms to short-time Fourier transform (STFT) in the temporal direction again and solving convolutive mixtures as instantaneous mixtures. In this case, the first signal converting means converts input signals into the time-frequency domain and generates observation spectrograms. The unnecessary-channel removing means generates the first separated results according to processing for applying an instantaneous mixing ICA to the observation spectrograms generated by the first signal converting means and executes processing for removing zero or more unnecessary channels judged as corresponding to none of sound sources from the separated results. The second signal converting means executes data conversion on the observation spectrograms from which the unnecessary channels are removed and generates modulation spectrograms. The signal separating means generates separated results from the modulation spectrograms.

This two-stage processing is applied to (3) the method of solving convolutive mixtures according to processing as a combination of shift superimposition and the instantaneous mixing ICA. In this case, the signal separating means generates the first separated results according to processing for applying an instantaneous mixing ICA to observation spectrograms, executes processing for removing zero or more unnecessary channels judged as corresponding to none of sound sources from the first separated results, shifts the observation spectrograms remaining after the removal processing in the frame direction to generate the observation spectrogram shift set, and applies the instantaneous mixing ICA to the generated the observation spectrogram shift set again to generate separated results.

(3) Use as Reverberation Removal

Among the following kinds of separation processing according to the embodiment of the present invention:

(1) the method of directly solving convolutive mixtures in the time-frequency domain;
(2) the method of subjecting a spectrogram to short-time Fourier transform (STFT) in the temporal direction again and solving convolutive mixtures as instantaneous mixtures; and
(3) the method of solving convolutive mixtures according to processing as a combination of shift superimposition and an instantaneous mixing ICA,
the third method “shift superimposition+ the conventional method” is used. In this case, it is possible to perform separation itself using the method in the past as the pre-processing and perform reverberation removal using the method according to the embodiment. Consequently, computational cost is reduced from O({n×(L′+1)}²) to O(n×n×(L′+1)). This method is explained below.

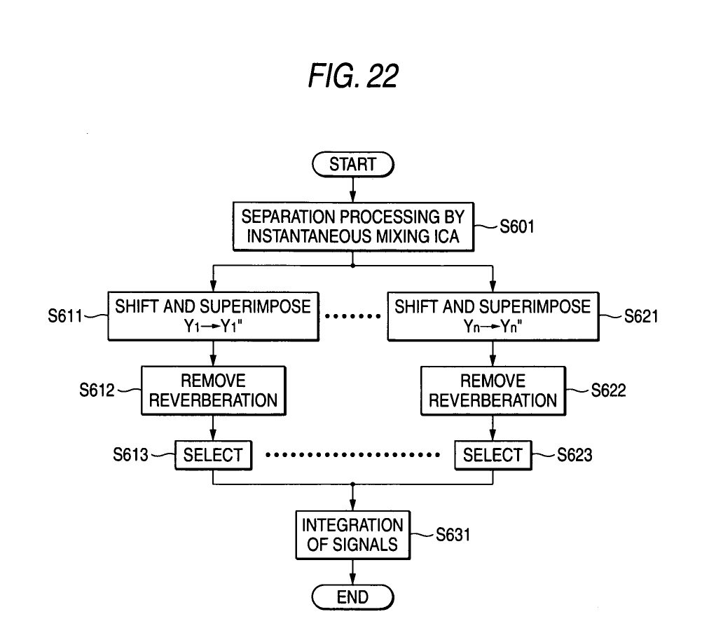

When the method “shift of spectrogram+superimposing” explained with reference to FIGS. 11A and 11B is performed, spectrograms for one channel are expanded to spectrograms for L′+1 channels in appearance. When results of the method are processed as inputs of L′+1 channel by using the instantaneous mixing ICA in the time-frequency domain in the past, as a result, spectrograms for L′+1 channel are generated. Even if such processing is performed, observation signals are not separated into components for each of sound sources. However, there is an effect of removing components extending over plural frames, i.e., an effect of reverberation removal. Therefore, it is conceivable to perform separation using the instantaneous mixing ICA in the time-frequency domain in the past and generate separated result spectrograms for n channels, and, then, applying “reverberation removal” to the respective channels. Such processing is explained with reference to a flowchart shown in FIG. 22.

First, in step S601, the signal separating device performs separation processing by the instantaneous mixing ICA in the time-frequency domain. This processing can be executed as the processing disclosed in JP-A-2006-238409. As a result, spectrograms Y₁ to Yₙ for n channels are generated. Processing after this is individually performed for the spectrograms Y₁ to Yₙ for the n channels. Processing for the spectrogram Y₁ corresponding to the first channel is steps S611 to S613. Processing for the spectrogram Yn corresponding to the nth channel is steps S621 to S623. At a point when the separation processing by the instantaneous mixing ICA in step S601 is finished, as explained with reference to FIGS. 20A and 20B, processing for removing zero or more unnecessary channels (outputs judged as corresponding to no sound sources) may be performed.

The processing in steps S611 to S613 is processing corresponding to steps S11 to S13 of the flow shown in FIG. 14, which is the processing sequence of the [(3) the method of solving convolutive mixtures according to processing as a combination of shift superimposition and an instantaneous mixing ICA] explained above. However, whereas the processing in step S11 of the flow shown in FIG. 14 is the processing for expanding spectrograms for n channels to spectrograms for n×(L′+1) channels, the processing in step S611 of the flow shown in FIG. 21 is processing for expanding a spectrogram for one channel to spectrograms for L′+1 channels. The reverberation removal processing in step S612 is processing identical with the processing in step S12 in the flow shown in FIG. 14. However, because of the reason described above, an effect of the processing in step S612 is not separation of sound sources but reverberation removal. The processing in step S613 is processing for selecting desired one of the spectrograms subjected to reverberation removal for L′+1 channels. The processing is the same as the processing in step S13 of the flow shown in FIG. 14.

The processing in steps S621 to S623 is the same as the processing in steps S611 to S613 except that a processing object is the signals Yₙ corresponding to a different channel.

When reverberation removal and selection are completed for all the output channels (the unnecessary channels may be removed), in step S631, the signal separating device integrates the remaining spectrograms. For example, the signal separating device executes processing for vertically superimposing the spectrograms. Processing for removing components extending over plural frames, i.e., reverberation removal processing is realized.

Verification of an Effect in Signal Separation Processing According to the Embodiment of the Present Invention

It was confirmed by an experiment that separation performance exceeding the time-frequency domain ICA in the past was realized by the method according to the embodiment of the present invention. An effect by the signal separation processing according to the embodiment of the present invention is explained on the basis of a result of the experiment.

First, conditions of the experiment are explained.

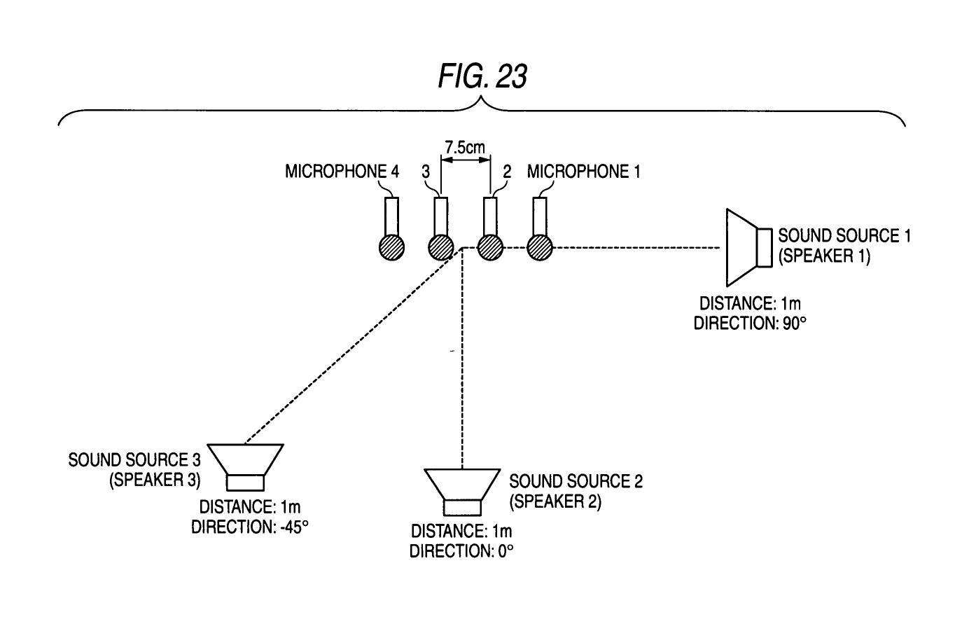

Recording of sound data was performed in an environment (an office room) shown in FIG. 23. The number of microphones was four (arranged at an interval of 7.5 cm), the number of sound sources was three, and sound sources shown on the following Web page were used as the sound sources.

Original Signal:

ICA′ 99 SYNTHETIC BENCHMARKS

http://sound.media.mit.edu/ica-bench/sources/

src1: beet.wav

src2: beet9.wav

src3: mike.wav

The sound recording was performed in a state in which the respective sound sources are independently played and recorded sounds were mixed on a computer later.

The experiment was performed under the following conditions:

Sampling frequency: 16 kHz

Window length of STFT: 64, 128, 256, 512, 1024, (2048, 4096)

Shift width of STFT: ½ of the window length

Windows: A sine window is used at the time of both short-time Fourier transform (STFT) and inverse Fourier transform (FT)

η0=0.5 (in Equation [7.9])

Number of times of loop: 200 or 400

Method:
Method 1: Equation [5.2] (equivalent to the method in the past)
Method 2: Equation [7.1] and Equation [7.2] (hereinafter referred to as “backward convolution)
Method 3: Equation [9.5] (hereinafter referred to as “re-STFT”)

Score function: Equation [7.7] is used

Value of γ of the Score Function:
Methods 1 & 2: γ=sqrt (M) M: number of frequency bins
Method 3: γ=sqrt(L′M)

Frame Tap:
Method 2: L′=4, 5, 8, 10, 15, 16, 20, 25, 30, 32
Method 3: L′=4, 8, 16, 32

As an evaluation scale, a signal-interference-ratio (SIR) on a waveform basis and an SIR on a frequency bin basis were used. A method of calculating an SIR is explained below.

Separated results (waveforms) corresponding to the kth channel is represented as yk(t), which is approximated by linear combination of original signals s₁(t) to s_{N}(t) (Equation [10.1] shown below).

$$\begin{matrix}{\hat{y}}_{k} ( t ) = {}_{1}^{}{s}{}_{1}^{} ( t ) + … + {}_{N}^{}{s}{}_{N}^{} ( t ) & [ 10.1 ] \\ [ {}_{1} , … {,}_{ N} ] = arg min {E}_{t} [ {\vert {y}_{k} ( t ) - {\hat{y}}_{k} ( t ) \vert}^{2} ] & [ 10.2 ] \\ {SIR}_{wave} ( k , i ) = 10 {log}_{10} \frac{{E}_{t} [ {\vert {}_{i}^{}{s}{}_{i}^{} ( t ) \vert}^{2} ]}{{E}_{t} [ {\vert {\hat{y}}_{k} ( t ) - {}_{i}^{}{s}{}_{i}^{} ( t ) \vert}^{2} ]} & [ 10.3 ] \\ {SIR}_{wave} ( i ) = {max}_{k} [ {SIR}_{wave} ( k , i ) ] & [ 10.4 ] \\ {\hat{Y}}_{k} ( ω , t ) = {}_{1}^{}{S}{}_{1}^{} ( ω , t ) + … + {}_{N}^{}{S}{}_{N}^{} ( ω , t ) & [ 10.5 ] \\ {SIR}_{bin} ( k , i ) = {mean}_{ω} [ 10 {log}_{10} \frac{{E}_{t} [ {\vert {}_{i}^{}{S}{}_{i}^{} ( ω , t ) \vert}^{2} ]}{{E}_{t} [ {\vert {\hat{Y}}_{k} ( ω , t ) - {}_{i}^{}{S}{}_{i}^{} ( ω , t ) \vert}^{2} ]} ] & [ 10.6 ] \\ {SIR}_{bin} ( i ) = {max}_{k} [ {SIR}_{bin} ( k , i ) ] & [ 10.7 ]\end{matrix}$$

Coefficients λ₁ to λ_{N} of s₁(t) to s_{N}(t) are calculated by minimizing a squared error of Equation [10.2].

When yk(t) is regarded as estimates of the ith sound source sᵢ(t), an SIR is defined as a power ratio between sᵢ(t) and the other sound sources (Equation [10.3]).

When the number of output channels (i.e., the number of microphones) is represented as n, n kinds of SIRs are calculated for one sound source. A maximum value of the SIRs is defined as an SIR of the sound source i (Equation [10.4]). In experimental results after that, SIRs calculated from the three sound sources are further averaged.

The SIR on a frequency bin basis is calculated by, after calculating an SIR for each of the frequency bins, averaging SIRs of all the frequency bins (Equation [10.6]).

In the following explanation, the experimental results are explained. The experimental results are shown as tables below.

In the respective tables, a window length is a window length of STFT, form-tap represents the number of frame taps, SIR(wave) represents an SIR on a waveform basis, and SIR(bin) represents an SIR on a frequency bin basis.

In the respective tables, experimental results obtained by the following methods are shown.

(1) Method 1 (the method in the past), 200 iterations

(2) Method 2 (Equations [6.1], [7.1], and [7.2]), 200 iterations

(3) Method 3 (Equations [9.2] and [9.5]), 200 iterations

(4) Method 1 (the method in the past), 400 iterations

(5) Method 2 (Equations [6.1], [7.1], ad [7.2]), 400 iterations

(6) Method 3 (Equations [9.2] and [9.5]), 400 iterations

TABLE 1
Method 1: 200 iterations

| Window Length | SIR (wave) | SIR (bin) |
|---|---|---|
| 64 | 10.085390 | 14.247462 |
| 128 | 18.448887 | 18.300289 |
| 256 | 18.930974 | 21.887905 |
| 512 | 17.692654 | 22.212446 |
| 1024 | 19.010121 | 21.831048 |
| 2048 | 18.818578 | 21.316580 |
| 4096 | 9.834248 | 19.257594 |

TABLE 2
Method 2: 200 iterations (1/2)

| Window | | | |
|---|---|---|---|
| Length | frm-tap | SIR (wave) | SIR (bin) |
| 64 | 2 | 7.723625 | 14.189539 |
| 64 | 3 | 11.366648 | 14.237571 |
| 64 | 4 | 11.577110 | 15.359920 |
| 64 | 5 | 10.084822 | 14.625560 |
| 64 | 8 | 19.091802 | 15.379239 |
| 64 | 10 | 15.335992 | 15.059319 |
| 64 | 15 | 9.594773 | 14.804861 |
| 64 | 16 | 7.253963 | 14.571525 |
| 64 | 20 | 9.909034 | 14.648844 |
| 64 | 25 | 9.699436 | 16.335202 |
| 64 | 30 | 16.652530 | 15.984961 |
| 64 | 32 | 12.331593 | 15.472048 |
| 128 | 2 | 17.437884 | 17.095271 |
| 128 | 3 | 11.902152 | 17.403008 |
| 128 | 4 | 7.531924 | 18.293102 |
| 128 | 5 | 11.649182 | 17.825224 |
| 128 | 8 | 17.917285 | 17.642283 |
| 128 | 10 | 17.510239 | 17.243153 |
| 128 | 15 | 11.795113 | 16.822791 |
| 128 | 16 | 9.502441 | 15.871420 |
| 128 | 20 | 10.426200 | 16.299691 |
| 128 | 25 | 16.942470 | 16.158811 |
| 128 | 30 | 11.656692 | 14.665683 |
| 128 | 32 | 9.703991 | 14.627081 |
| 256 | 2 | 15.476092 | 19.844828 |
| 256 | 3 | 10.806690 | 20.703241 |
| 256 | 4 | 9.049179 | 21.432315 |
| 256 | 5 | 9.925743 | 20.314377 |
| 256 | 8 | 10.308393 | 20.290103 |
| 256 | 10 | 14.376324 | 19.704720 |

TABLE 3
Method 2: 200 iterations (2/2)

| Window Length | frm-tap | SIR (wave) | SIR (bin) |
|---|---|---|---|
| 256 | 15 | 18.022393 | 19.463030 |
| 256 | 16 | 15.995910 | 19.119571 |
| 256 | 20 | 10.676328 | 18.206759 |
| 256 | 25 | 9.810350 | 16.363776 |
| 256 | 30 | 15.956797 | 16.322336 |
| 256 | 32 | 11.953494 | 16.489618 |
| 512 | 2 | 10.840694 | 20.703345 |
| 512 | 3 | 14.629299 | 21.116943 |
| 512 | 4 | 17.465950 | 21.027474 |
| 512 | 5 | 23.019001 | 21.341853 |
| 512 | 8 | 14.839779 | 20.623220 |
| 512 | 10 | 18.167215 | 20.386570 |
| 512 | 15 | 14.954496 | 17.668561 |
| 512 | 16 | 10.664045 | 18.196603 |
| 512 | 20 | 16.360184 | 16.575838 |
| 512 | 25 | 23.204726 | 15.199630 |
| 512 | 30 | 13.475126 | 14.657882 |
| 512 | 32 | 10.178490 | 14.050947 |
| 1024 | 2 | 15.615487 | 19.918627 |
| 1024 | 3 | 15.506131 | 20.717862 |
| 1024 | 4 | 15.683004 | 21.285990 |
| 1024 | 5 | 19.858295 | 20.271286 |
| 1024 | 8 | 12.673045 | 17.772065 |
| 1024 | 10 | 17.652114 | 16.736479 |
| 1024 | 15 | 18.138237 | 14.276585 |
| 1024 | 16 | 17.536441 | 14.003793 |
| 1024 | 20 | 9.038467 | 10.787367 |
| 1024 | 25 | 5.482779 | 7.743948 |
| 1024 | 30 | 10.944189 | 6.088159 |
| 1024 | 32 | 9.463023 | 5.576710 |

TABLE 4
Method 3: 200 iterations

| Window Length | frm-tap | SIR (wave) | SIR (bin) |
|---|---|---|---|
| 64 | 4 | 19.041199 | 18.292477 |
| 64 | 8 | 17.242261 | 19.040761 |
| 64 | 16 | 19.081600 | 19.206357 |
| 64 | 32 | 17.589866 | 19.251506 |
| 64 | 64 | 15.828559 | 19.316843 |
| 128 | 4 | 16.085427 | 21.317409 |
| 128 | 8 | 13.913609 | 21.872839 |
| 128 | 16 | 15.047359 | 22.652313 |
| 128 | 32 | 15.675254 | 23.379297 |
| 128 | 64 | 24.131190 | 21.664133 |
| 256 | 4 | 17.712214 | 23.237076 |
| 256 | 8 | 15.705569 | 24.051207 |
| 256 | 16 | 17.725996 | 24.683070 |
| 256 | 32 | 17.986593 | 23.043458 |
| 256 | 64 | 21.165182 | 18.693739 |
| 512 | 4 | 17.197261 | 23.484099 |
| 512 | 8 | 19.304703 | 24.025183 |
| 512 | 16 | 20.036843 | 22.572209 |
| 512 | 32 | 16.609152 | 18.383343 |
| 512 | 64 | 8.718236 | 11.361900 |
| 1024 | 4 | 15.512480 | 22.764524 |
| 1024 | 8 | 17.670261 | 21.470480 |
| 1024 | 16 | 16.237715 | 17.621698 |
| 1024 | 32 | 7.691592 | 11.012166 |
| 1024 | 64 | 10.699128 | 4.535049 |

TABLE 5
Method 1: 400 iterations

| Window Length | SIR (wave) | SIR (bin) |
|---|---|---|
| 64 | 10.526685 | 14.632956 |
| 128 | 18.814318 | 18.867612 |
| 256 | 18.354827 | 22.088436 |
| 512 | 15.595594 | 22.335028 |
| 1024 | 19.200497 | 21.979499 |
| 2048 | 19.416130 | 21.493876 |
| 4096 | 10.203228 | 19.378431 |

TABLE 6
Method 2: 400 iterations (1/2)

| Window Length | frm-tap | SIR (wave) | SIR (bin) |
|---|---|---|---|
| 64 | 2 | 10.168236 | 14.318466 |
| 64 | 3 | 14.166229 | 14.434097 |
| 64 | 4 | 8.520729 | 15.446840 |
| 64 | 5 | 5.918207 | 14.501643 |
| 64 | 8 | 15.516346 | 15.608022 |
| 64 | 10 | 11.366750 | 15.187244 |
| 64 | 15 | 8.382713 | 14.799052 |
| 64 | 16 | 15.684769 | 14.536716 |
| 64 | 20 | 9.580031 | 13.317032 |
| 64 | 25 | 7.618723 | 15.460673 |
| 64 | 32 | 10.957805 | 15.294873 |
| 128 | 2 | 17.633880 | 17.808423 |
| 128 | 3 | 11.903416 | 17.587348 |
| 128 | 4 | 7.971498 | 18.148690 |
| 128 | 5 | 16.725162 | 17.298061 |
| 128 | 8 | 12.650529 | 17.298647 |
| 128 | 10 | 7.265384 | 16.227632 |
| 128 | 15 | 9.892851 | 16.001325 |
| 128 | 16 | 7.968329 | 14.893214 |
| 128 | 20 | 12.677961 | 14.907597 |
| 128 | 25 | 11.017713 | 14.968466 |
| 128 | 32 | 7.766863 | 13.089973 |
| 256 | 2 | 18.055739 | 20.397809 |
| 256 | 3 | 13.097451 | 20.716522 |
| 256 | 4 | 14.145685 | 21.286219 |
| 256 | 5 | 10.286146 | 20.097042 |
| 256 | 8 | 11.521964 | 19.440812 |
| 256 | 10 | 14.264241 | 19.089509 |

TABLE 7
Method 2: 400 iterations (2/2)

| Window Length | frm-tap | SIR (wave) | SIR (bin) |
|---|---|---|---|
| 256 | 15 | 12.135029 | 18.373697 |
| 256 | 16 | 18.079076 | 17.599351 |
| 256 | 20 | 10.632775 | 16.375223 |
| 256 | 25 | 10.088245 | 14.541695 |
| 256 | 32 | 11.936404 | 15.199547 |
| 512 | 2 | 10.331808 | 20.855119 |
| 512 | 3 | 16.423993 | 21.151643 |
| 512 | 4 | 16.600142 | 20.780534 |
| 512 | 5 | 22.527277 | 20.951102 |
| 512 | 8 | 10.866635 | 19.744964 |
| 512 | 10 | 19.077785 | 19.662656 |
| 512 | 15 | 9.024312 | 16.609599 |
| 512 | 16 | 12.856733 | 16.833167 |
| 512 | 20 | 15.166960 | 15.050224 |
| 512 | 25 | 22.525527 | 13.796894 |
| 512 | 32 | 8.020437 | 11.726211 |
| 1024 | 2 | 19.534180 | 20.058328 |
| 1024 | 3 | 16.428720 | 20.799502 |
| 1024 | 4 | 18.667954 | 21.146034 |
| 1024 | 5 | 25.380972 | 20.041804 |
| 1024 | 8 | 12.933148 | 17.115028 |
| 1024 | 10 | 10.568863 | 15.916359 |
| 1024 | 15 | 12.759344 | 12.809804 |
| 1024 | 16 | 17.014241 | 12.203590 |
| 1024 | 20 | 16.073038 | 8.691911 |
| 1024 | 25 | 10.515738 | 6.424758 |
| 1024 | 32 | 6.163387 | 4.747775 |

TABLE 8
Method 3: 400 iterations

| Window Length | frm-tap | SIR (wave) | SIR (bin) |
|---|---|---|---|
| 64 | 4 | 18.763433 | 19.070321 |
| 64 | 8 | 16.620774 | 19.562279 |
| 64 | 16 | 16.750841 | 19.710744 |
| 64 | 32 | 16.219283 | 19.609934 |
| 64 | 64 | 17.463046 | 19.874975 |
| 128 | 4 | 15.592867 | 21.719596 |
| 128 | 8 | 14.121273 | 22.101275 |
| 128 | 16 | 14.832744 | 22.807193 |
| 128 | 32 | 15.003222 | 23.614894 |
| 128 | 64 | 20.091807 | 21.701593 |
| 256 | 4 | 16.149291 | 23.104884 |
| 256 | 8 | 16.284198 | 24.210666 |
| 256 | 16 | 16.052006 | 24.904951 |
| 256 | 32 | 20.103914 | 23.053002 |
| 256 | 64 | 21.063397 | 18.400974 |
| 512 | 4 | 18.873115 | 23.740183 |
| 512 | 8 | 16.353383 | 24.238644 |
| 512 | 16 | 22.026222 | 22.563068 |
| 512 | 32 | 18.984716 | 18.127569 |
| 512 | 64 | 9.437651 | 11.314213 |
| 1024 | 4 | 15.056290 | 22.924103 |
| 1024 | 8 | 19.711121 | 21.417292 |
| 1024 | 16 | 16.921069 | 17.257597 |
| 1024 | 32 | 7.501558 | 10.850579 |
| 1024 | 64 | 13.961828 | 4.698783 |

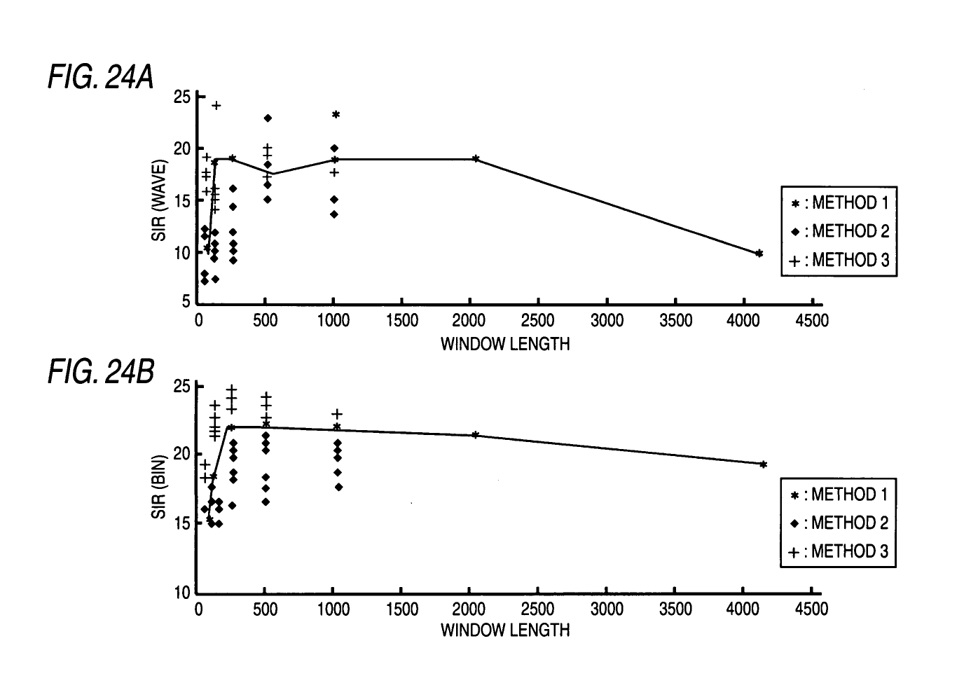

FIGS. 24A and 24B are graphs of evaluation data concerning separated results obtained by three methods described below.

(1) Method 1 (the method in the past), 200 iterations
(2) Method 2 (Equations [6.1], [7.1], and [7.2]), 200 iterations
(3) Method 3 (Equations [9.2] and [9.5]), 200 iterations

SIR data based on result data obtained when these three methods are executed is plotted in the graphs.

SIR data of (a) an SIR (signal-interference-ratio) on a waveform basis and (b) an SIR on a frequency bin basis are also plotted in the graphs. The abscissa indicates a window length of STFT and the ordinate indicates an SIR.

In the respective graphs, “*” (solid line) represents the method 1, black diamond represents the method 2, and “+” represents the method 3.

It can be confirmed that, in several settings, the SIRs of the method 2 and the method 3 exceed that of the method in the past.

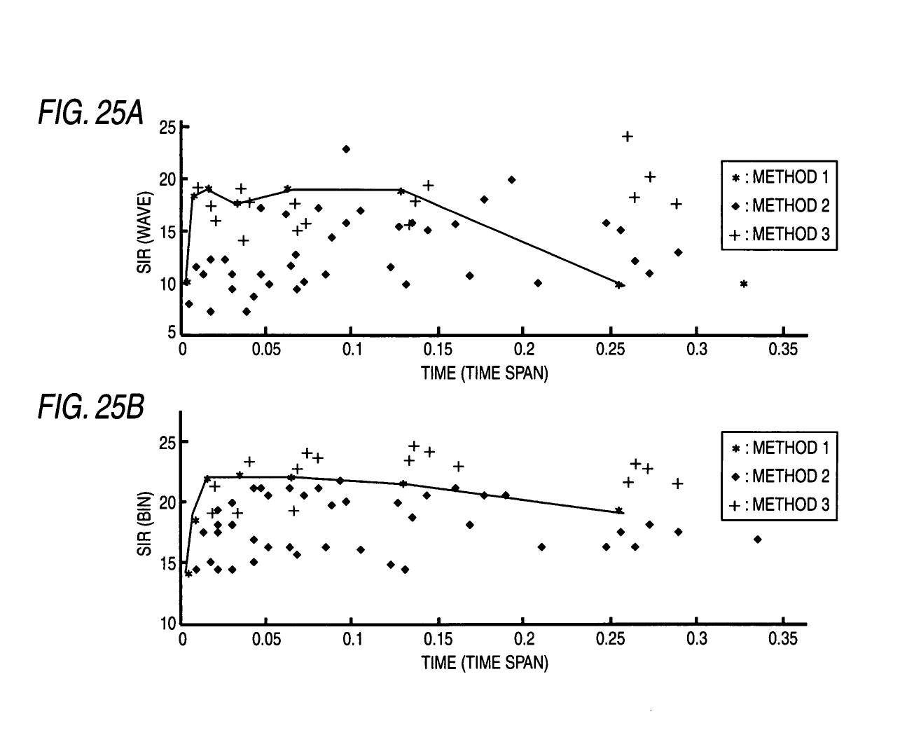

Evaluation data plotted as the abscissa by using a time span calculated by the following equation is shown in FIGS. 25A and 25B.

time_span={(frame_tap−1)×frame_shift+window_len}/srate

where, frame_tap is the number of frame taps (=L′), window_len is a window length (length of a sliced section in the first STFT), frame_shift is a window shift width (½ of the window length this experiment), and srate is sampling frequency (16 kHz).

FIGS. 25A and 25B are also graphs of evaluation data concerning separated results obtained by three methods described below.

(1) Method 1 (the method in the past), 200 iterations
(2) Method 2 (Equations [6.1], [7.1], and [7.2]), 200 iterations
(3) Method 3 (Equations [9.2] and [9.5]), 200 iterations

SIR data based on result data obtained when these three methods are executed is plotted in the graphs.

SIR data of (a) an SIR (signal-interference-ratio) on a waveform basis and (b) an SIR on a frequency bin basis are also plotted in the graphs. The abscissa indicates a window length of the time span (Time_span) described above and the ordinate indicates an SIR.

In the respective graphs, “*” (solid line) represents the method 1, black diamond represents the method 2, and “+” represents the method 3.

In the past, a window length of short-time Fourier transform (STFT) has to be extended in order to cover long time span. This causes the fall in an SIR. On the other hand, in the embodiment of the present invention, it is possible to cover equivalent time span without causing the fall in an SIR by using a combination of a shorter window and plural frame taps.

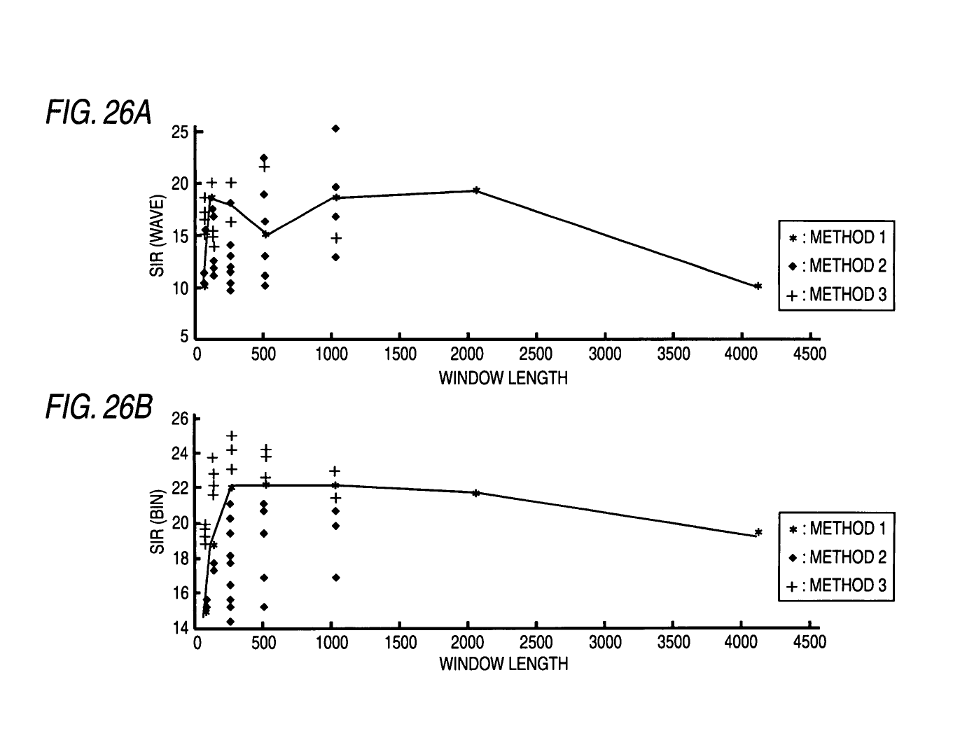

FIGS. 26A and 26B are graphs concerning separated results obtained by three methods described below.

(4) Method 1 (the method in the past), 400 iterations
(5) Method 2 (Equations [6.1], [7.1], and [7.2]), 400 iterations
(6) Method 3 (Equations [9.2] and [9.5]), 400 iterations

SIR data based on result data obtained when these three methods are executed is plotted in the graphs.

SIR data of (a) an SIR (signal-interference-ratio) on a waveform basis and (b) an SIR on a frequency bin basis are also plotted in the graphs. The abscissa indicates a window length of STFT and the ordinate indicates an SIR.

In the respective graphs, “*” (solid line) represents the method 1, black diamond represents the method 2, and “+” represents the method 3.

The same evaluation experiment was performed with the number of iterations in the separation processing increased to 400 times.

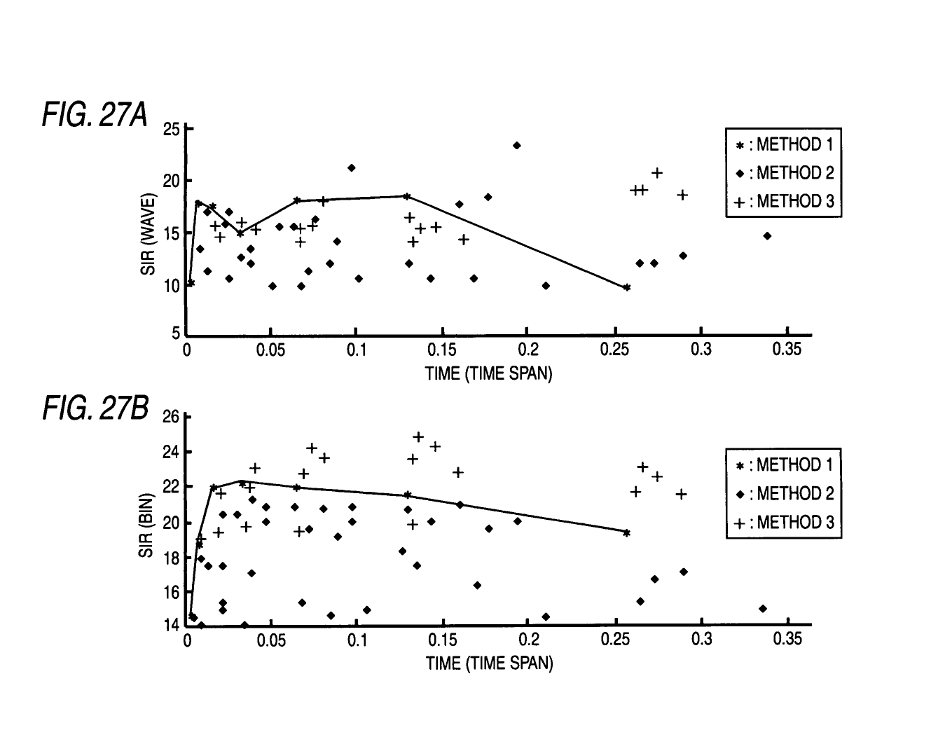

As data corresponding to the data shown in FIGS. 26A and 26B, evaluation data plotted by using time span as the abscissa is shown in FIGS. 27A and 27B. FIGS. 27A and 27B are graphs concerning separated results obtained by the three methods described below.

(4) Method 1 (the method in the past), 400 iterations
(5) Method 2 (Equations [6.1], [7.1], and [7.2]), 400 iterations
(6) Method 3 (Equations [9.2] and [9.5]), 400 iterations

SIR data based on result data obtained when these three methods are executed is plotted in the graphs.

SIR data of (a) an SIR (signal-interference-ratio) on a waveform basis and (b) an SIR on a frequency bin basis are also plotted in the graphs. The abscissa indicates a window length of the time span (Time_span) described above and the ordinate indicates an SIR.

In the respective graphs, “*” (solid line) represents the method 1, black diamond represents the method 2, and “+” represents the method 3.

In FIGS. 26A and 26B and FIGS. 27A and 27B, there are settings in which the SIRs of the method 2 and the method 3 exceed that of the method in the past. In this way, it is possible to prevent the problem of “tradeoff of a window length and separation performance” inherent in the time-frequency domain ICA in the past.

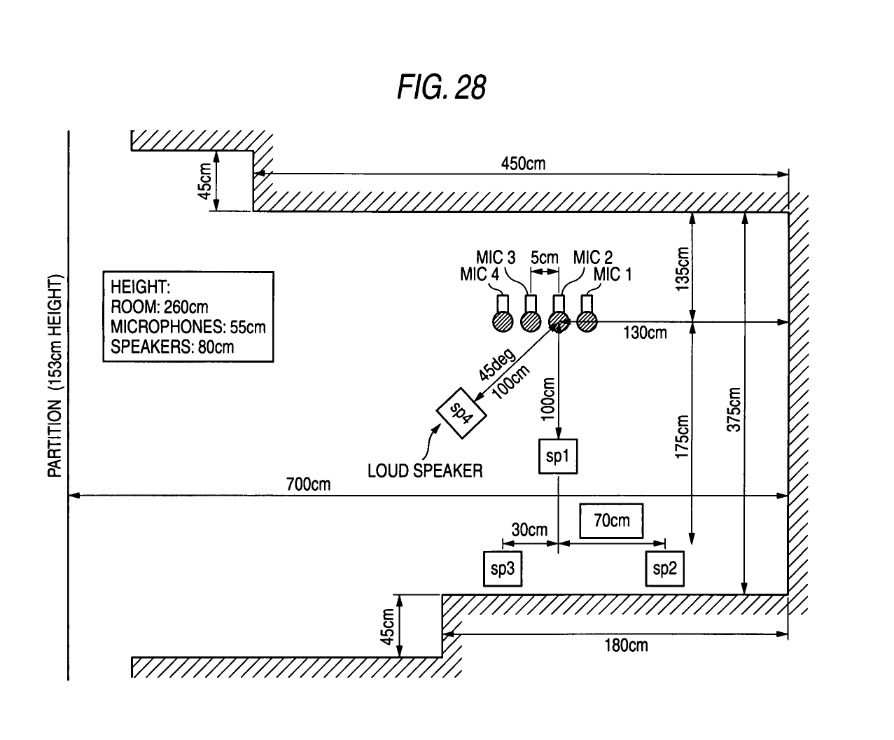

An evaluation experiment concerning another type of data is explained. FIG. 28 is a plan of an office environment, which is the recording environment. As shown in the figure, the experiment was performed in a rectangular room with a size of about 750 cm×375 cm. The room is not a complete rectangle as shown in the figure. One side of the room is a space divided by a partition with the height of 153 cm. Reverberation time of the room is a value slightly shorter than 0.3 second. (In the following explanation, the reverberation time is plotted as 0.275 second.)

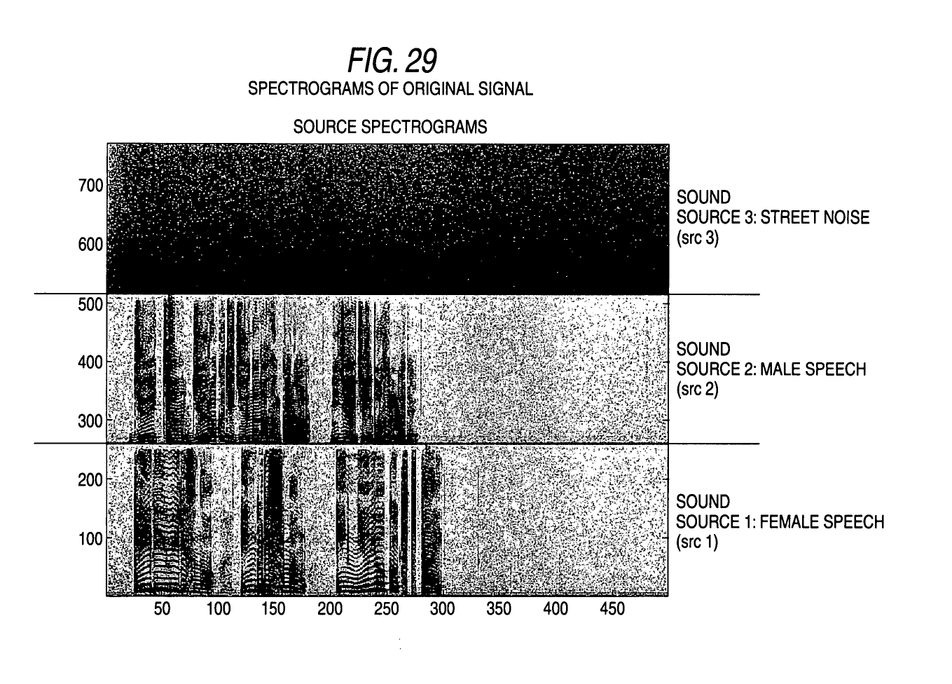

The following three kinds of sound were prepared as sound sources. (Spectrograms of respective signals are shown in FIG. 29.)

Sound source 1 (src1): speech of one female (hereinafter referred to as female speech or F)

Sound source 2 (src2): speech of one male (hereinafter referred to as male speech or M)

Sound source 3 (src3): Street noise made open to the public in the following URL (hereinafter referred to as street noise or S):

http://sound.media.mit.edu/ica-bench/sources/street.wav

The sounds were reproduced from respective loud speakers sp1 to sp4 in the figure and recorded with four microphones (mic1 to mic4) arranged at intervals of 5 cm. Sound output from the speakers sp1 to sp4 was performed in eight kinds of combinations shown in FIGS. 8A and 8B and analysis of data inputted by the four microphones (mic1 to mic4) was performed. Speech of one female is represented as F, speech of one male is represented as M, street noise is represented as S, and no sound output is represented as 0. There are the following eight patterns of sound output.

(1) sp1=S, sp2=0, sp3=F, sp4=M

(2) sp1=S, sp2=0, sp3=M, sp4=F

(3) sp1=F, sp2=S, sp3=0, sp4=M

(4) sp1=M, sp2=S, sp3=0, sp4=M

(5) sp1=0, sp2=0, sp3=F, sp4=M

(6) sp1=0, sp2=0, sp3=M, sp4=F

(7) sp1=F, sp2=0, sp3=0, sp4=M

(8) sp1=M, sp2=0, sp3=0, sp4=M

In the experiment, the length of observation signals was 4 seconds and 8 seconds for each of the patterns (1) to (8). Therefore, the number of variations of observation signals is 8×2=16 in total.

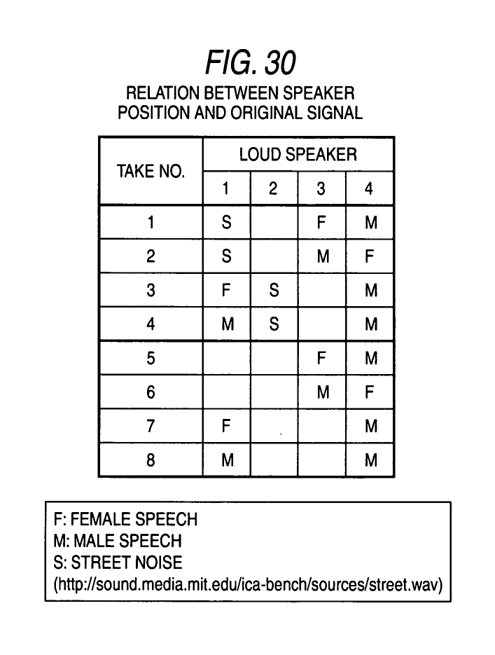

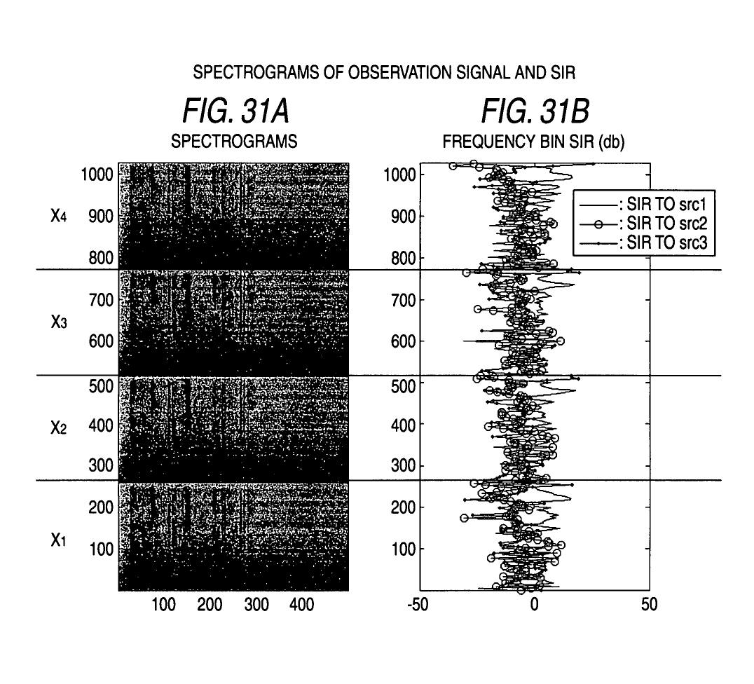

An example of observation signals is shown in FIGS. 31A and 31B. This corresponds to [Take No. 3] in the patterns shown in FIG. 30. In other words, this is the following output pattern:

(3) sp1=F, sp2=S, sp3=0, sp4=M

Four spectrograms X1 to X4 shown in FIG. 31A are observation signals observed by the four microphones (mic1 to mic4) shown in FIG. 28. FIG. 31B shows an SIR for each of frequency bins. It is seen that states of mixtures of the four sound sources are substantially the same among the four spectrograms.

A sound source separation experiment was performed for the following three methods. The method 2 is omitted from the experiment described above. Instead of the method 2, (the first method in) “(3) shift superimposition+instantaneous mixing ICA” was performed as the method 4.

Method 1: Equation [5.2] (equivalent to the conventional method)

Method 3: Equation [9.5] (hereinafter referred to as “re-STFT”)

Method 4: Equation [11.1] & Equation [5.2] (hereinafter referred to as “shift superimposition)

Conditions for the experiment are as described below.

Common Conditions:
Sampling frequency: 16 kHz
Number of sampling bits: 16
Length of observation signals: 4 seconds and 8 seconds

Method 1:
Window length of STFT: 256, 512, 1024, 2048, 4096, 8192
Shift width of STFT: ¼ of the window length
Window: hanning window at the time of short-time Fourier transform (STFT) and no window at the time of inverse Fourier transform (FT)
η0=0.3
Number of times of loop: 400
Value of γ of a score function: γ=sqrt(M) (M: number of frequency bins)

Only when the length of observation signals was 4 seconds and the window length of STFT was 8192, ⅛ of the window length, i.e., 1024 was used as the shift width. (This is because the number of frames is too small in ¼ shift.)

Method 3:
Window length of STFT (first time): 512
Shift width of STFT (first time): ¼ of the window length
Window (first time): hanning window at the time of short-time Fourier transform (STFT) and no window at the time of inverse Fourier transform (FT).
η0=0.3
Number of iterations: 400
Value of γ of a score function: γ=sqrt(M(L′+1)) (M: number of frequency bins)
Window length of STFT (second time): L′+1=4, 8, 16, 32
Shift width of STFT (second time): ⅛ of the window length (fractions are rounded up)
Window (second time): hamming window at the time of short-time Fourier transform (STFT) and no window at the time of inverse Fourier transform (FT)

The hamming window was used instead of the hanning window in STFT in the second time in order to effectively use samples at both ends even when the number of taps is small. (Since 0 is at both ends of the hanning window, two effective samples are reduced.)

Method 4:
Window length of STFT (first time): 512
Shift width of STFT (first time): ¼ of the window length
Window (first time): hanning window at the time of short-time Fourier transform (STFT) and no window at the time of inverse Fourier transform (FT)
η0=0.3
Number of iterations: 400
Value of γ of a score function: γ=sqrt(M(L′+1)) (M: number of frequency bins)
Frame tap: L′+1=2, 4, 8, 12

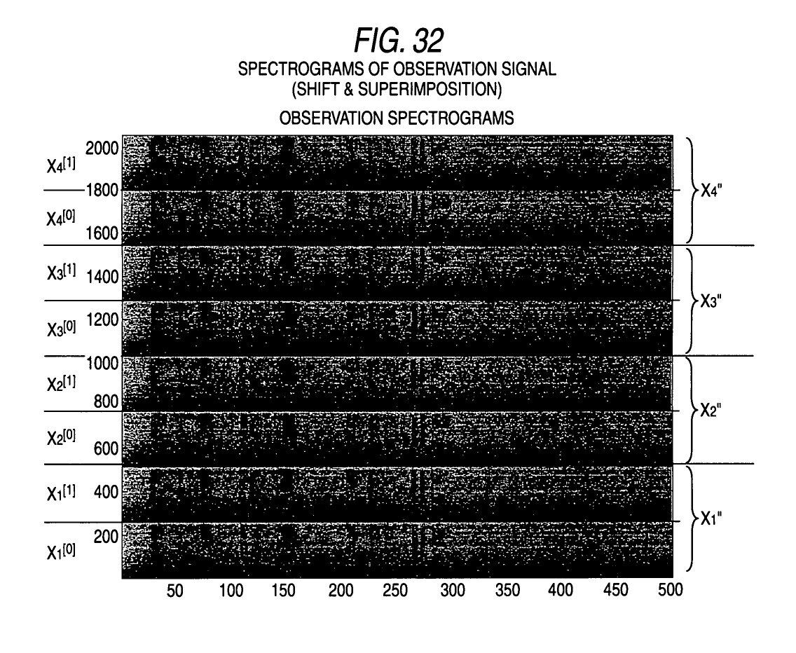

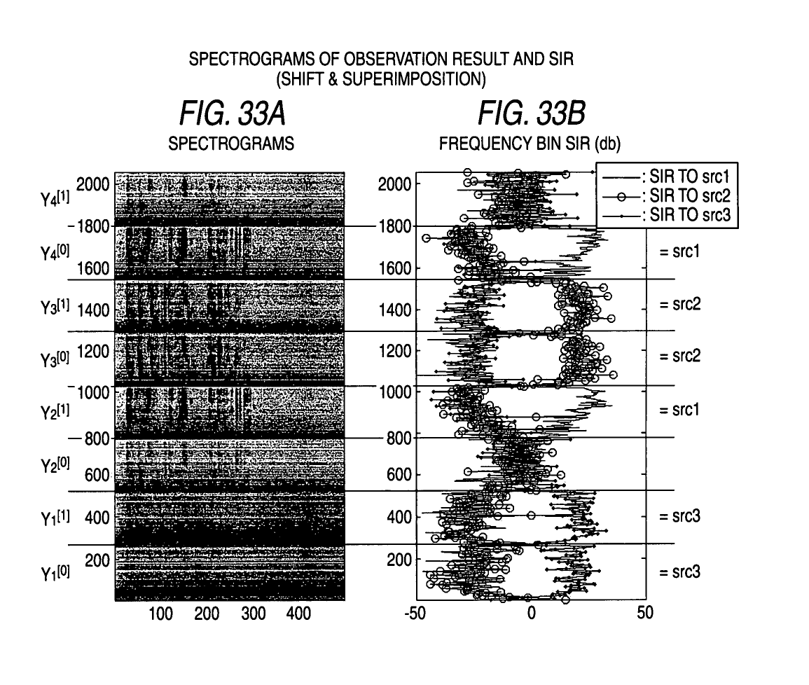

FIG. 32 and FIGS. 33A and 33B show results obtained by processing the observation signals shown in FIGS. 31A and 31B using the method 4. Results obtained by performing shift and superimposing (see FIGS. 11A and 11B) with L′=1 (i.e., two taps) are shown in FIG. 32. Results obtained by separating these observation signals as eight channels' observation signals are shown in FIGS. 33A and 33B. FIG. 33A shows spectrograms of separated results. FIG. 33B shows an SIR for each of frequency bins. The spectrograms of the separated results shown in FIG. 33A correspond to the original signals as described below.

Y₂^{[1]}, Y₄^{[0]}: sound source 1

y₃^{[0]}, Y₃^{[1]}: sound source 2

Y₁^{[0]}, Y₁^{[1]}: sound source 3

Y₂^{[0]}, Y₄^{[1]}: no corresponding sound source

As a scale representing a separation degree, an average of improved SIRS for each of the frequency bins was calculated. Referring to FIGS. 33A and 33B as an example, concerning respective channels (Y₁^{[0]} to Y₄^{[1]}) of separated results spectrograms shown in FIG. 33A, SIRs were calculated for sound sources that appeared most strongly and the SIRs were averaged in all the frequency bins. For example, in Y₂^{[1]}, since the sound source 1 appeared most strongly, an SIR to the sound source 1 was calculated. An SIR was calculated in the same manner for Y₄^{[0]}. A larger value of the SIRs was set as a separation degree for the sound source 1. Separation degrees were calculated for the sound sources 2 and 3 and the separation degrees were averaged among the three sound sources to obtain an overall separation degree. An improved SIR was calculated by subtracting an average SIR of the observation signal, i.e., a value obtained by averaging plots of SIRs for each of the frequency bins shown in FIG. 33B in all frequencies from a value of the separation degree.

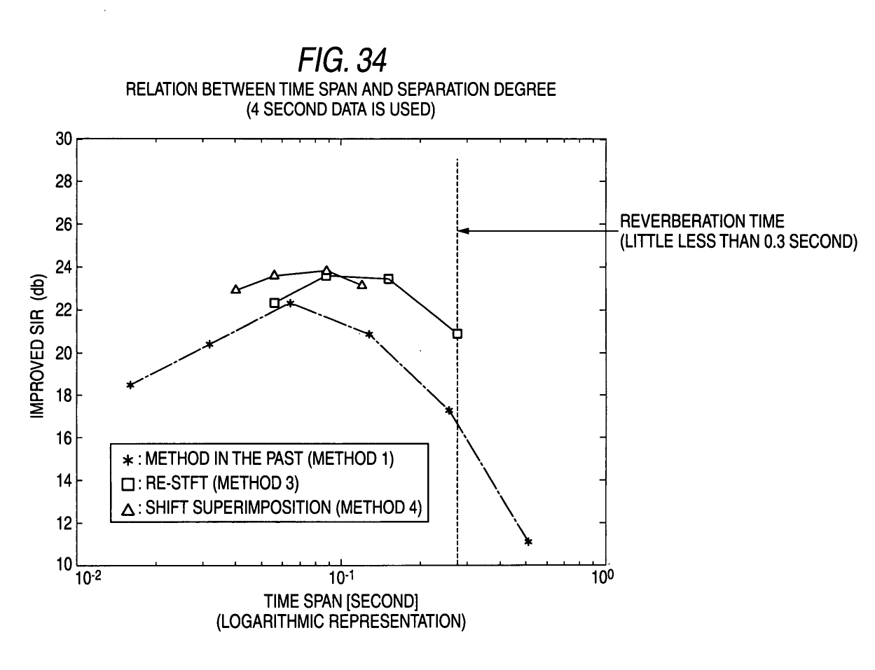

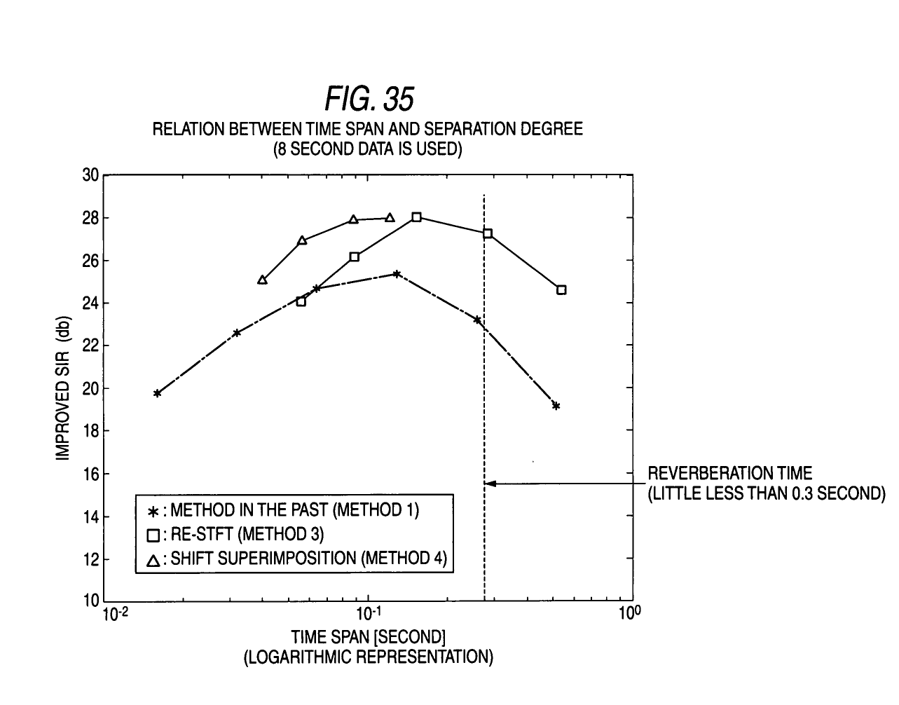

Finally, a separation degree for one experimental parameter was calculated by calculating an average of separation degrees among eight times of takes. These calculations for the observation signals with the length of four seconds and the observation signals with the length of eight seconds were separately summarized. Summarization results are as shown in FIGS. 34 and 35. FIG. 34 shows a summarization result obtained when the length of the observation signals is 4 seconds. FIG. 35 shows a summarization result obtained when the length of the observation signals is 8 seconds. In both the figures, the ordinate indicates an improved SIR and the abscissa indicates a time span (logarithmic scale). The vertical broken lines in both the figures indicate the reverberation time of the room, which is set to 0.275 second. Three bent lines correspond to the conventional method (the method 1), re-STFT (the method 3), and shift superimposition (the method 4).

As shown in FIGS. 34 and 35, in the conventional method, even if a window length of STFT (analysis frame length) is increased, separation accuracy reaches a peak at a certain value (which is 1024 when the length of the observation signals is 4 seconds and is 2048 when the length of the observation signals is 8 seconds). When the window length of STFT is further increased, the separation accuracy is deteriorated to the contrary. This is because, when the window is set too long, time resolution of STFT results falls. The fall in the time resolution has stronger influence when observation signals are shorter. Therefore, when the length of the observation signals is 4 seconds, the separation accuracy reaches a peak with a window length smaller than at the time when the length of the observation signals is 8 seconds. On the other hand, when the window length is short, although time resolution is high, the number of components extending over frames increases (reverberation does not fit within one frame). Therefore, sufficient separation accuracy is not obtained.

On the other hand, in the method 3 and the method 4 according to the embodiment of the present invention, results of STFT with the short window (in this experiment, 512) is further separated by using plural frames. Therefore, it is possible to cope with the components extending over plural frames while controlling the fall in time resolution. Therefore, when compared in the time span identical with that in the conventional method, it is possible attain higher separation accuracy. When compared in the peak separation accuracies, it is possible to attain higher separation accuracy in longer time span.

The present invention has been explained in detail with reference to the specific embodiment. However, it is obvious that those skilled in the art can make modifications and alterations of the embodiment without departing from the spirit of the present invention. The present invention has been disclosed in a form of illustration and should not be interpreted limitedly. To judge the gist of the present invention, patent claims should be taken into account.

A series of processing explained in this specification can be executed by hardware, software, or a combined configuration of the hardware and the software. In executing processing by software, it is possible to install a program having a processing sequence recorded therein in a memory in a computer built in dedicated hardware and cause the computer to execute the program or install the program in a general-purpose computer, which can execute various kinds of processing, and cause the computer to execute the program.

For example, the program can be recorded in a hard disk and a ROM (Read Only Memory), which serve as recording media, in advance. Alternatively, the program can be temporarily or permanently stored (recorded) in removable recording media such as a flexible disk, a CD-ROM (Compact Disc Read Only Memory), an MO (Magneto Optical) disk, a DVD (Digital Versatile Disc), a magnetic disk, and a semiconductor memory. Such removable recording media can be provided as so-called package software.

Besides installing the program from the removable recording media to the computer, it is also possible to transfer the program from a download site to the computer by radio or transfer the program to the computer by wire through networks such as a LAN (Local Area Network) and the Internet. The computer can receive the program transferred in this way and install the program in a recording medium such as a hard disk built therein.

The various kinds of processing described in this specification are not only executed in time series in accordance with the description. The processing may be executed in parallel or individually according to a processing ability of an apparatus that executes the processing or according to necessity. The system in this specification is a logical set of plural apparatuses and is not limited to a system in which apparatuses having respective configurations are provided in an identical housing.

As explained above, according to the embodiment of the present invention, input signals formed by mixing plural sound signals are converted into the time-frequency domain to generate observation spectrograms. In signal separation processing for generating separated results from the observation spectrograms, separated results are generated by processing for interpreting the observation spectrograms as observation signals subjected to convolutive mixtures in the time-frequency domain and solving convolutive mixtures in the time-frequency domain. Alternatively, modulation spectrograms are generated by short-time Fourier transform (STFT) in the temporal direction for the observation spectrograms, the modulation spectrograms is interpreted as instantaneous mixtures and an independent component analysis solving the instantaneous mixtures is performed to generate separated results. Therefore, highly accurate separation processing performed by taking into account a delay amount is realized for mixed sound signals having various delay amounts such as direct waves and reflected waves.

It should be understood by those skilled in the art that various modifications, combinations, sub-combinations, and alterations may occur depending on design requirements and other factors insofar as they are within the scope of the appended claims or the equivalents thereof.

What is claimed is:

1. A signal separating device that is inputted with signals formed by mixing plural signals and separates the signals into individual signals, the signal separating device comprising:
signal converting means for converting input signals into signals in the time-frequency domain and generating observation spectrograms; and
signal separating means for generating separated results from the observation spectrograms generated by the signal converting means, wherein
the signal separating means interprets the observation spectrograms as observation signals subjected to convolutive mixtures in the time-frequency domain and generates separated results by executing processing for solving convolutive mixtures in the time-frequency domain.

2. A signal separating device according to claim 1, wherein the signal converting means executes processing for executing short-time Fourier transform (STFT) on the input signals to convert the input signals into signals in the time-frequency domain and generating observation spectrograms.

3. A signal separating device according to claim 1, wherein the signal separating means sets separated signals Y(t) of a frame number (t) as convolutive mixtures of observation signals X(t−L′) to X(t) and generates separated results according to processing for improving independence of respective individual signal components Y1(t) to Yn(t) included in the separated signals Y(t).

4. A signal separating device according to claim 3, wherein the signal separating means generates separated results by performing, as the processing for improving independence of the respective individual signal components Y1(t) to Yn(t) included in the separated signals Y(t), update processing for a separation matrix for applying Kullback-Leiblar information I(Y) as an independence measure and minimizing the Kullback-Leiblar information I(Y).

5. A signal separating device according to claim 1, wherein the signal separating means generates the first separated results according to processing for applying an instantaneous mixing ICA (Independent Component Analysis) to the observation spectrograms, executes processing for removing zero or more unnecessary channels judged as corresponding to none of sound sources from the first separated results, and executes processing for solving convolutive mixtures in the time-frequency domain on the observation spectrograms remaining after the removal processing to generate separated results.

6. A signal separating device according to claim 5, wherein the processing for applying an instantaneous mixing ICA to the observation spectrograms is processing for generating separated signals in the time-frequency domain from observation signals in the time-frequency domain and a separation matrix, correcting the separation matrix until the generated separated signal in the time-frequency domain and a separation matrix calculated by a multidimensional score function derived from a multidimensional probability density function nearly converge, and applying the corrected separation matrix to generate separated signals in the time-frequency domain.

7. A signal separating device that is inputted with signals formed by mixing plural signals and separates the signals into individual signals, the signal separating device comprising:
first signal converting means for converting input signals into signals in the time-frequency domain and generating observation spectrograms;
second signal converting means for executing data conversion for the observation spectrograms generated by the first signal converting means and generating modulation spectrograms; and
signal separating means for generating separated results from the modulation spectrograms generated by the second signal converting means, wherein
the signal separating means interprets the modulation spectrograms as instantaneous mixtures and generates separated results.

8. A signal separating device according to claim 7, wherein the first signal converting means executes processing for executing short-time Fourier transform (STFT) on the input signals to convert the input signals into signals in the time-frequency domain and generating observation spectrograms.

9. A signal separating device according to claim 7, wherein
the second signal converting means generates modulation spectrograms as results of executing short-time Fourier transform (STFT) in the temporal direction on the observation spectrograms, and
the signal separating means generates separated results according to processing for improving independence of respective signal components Y1′ to Yn′ corresponding to separated signals included in the modulation spectrograms.

10. A signal separating device according to claim 9, wherein the signal separating means generates separated results by performing, as the processing for improving independence of the respective signal components Y1′ to Yn′ corresponding to the separated signals, update processing for a separation matrix for applying Kullback-Leiblar information as an independence measure and minimizing the Kullback-Leiblar information.

11. A signal separating device according to claim 7, further comprising inverse Fourier transform means for executing inverse Fourier transform on the respective signal components Y1′ to Yn′ corresponding to the separated signals obtained by the signal separating means and generating spectrograms Y1 to Yn corresponding to the separated signals.

12. A signal separating device according to claim 7, further comprising unnecessary-channel removing means for generating the first separated results according to processing for applying an instantaneous mixing ICA (Independent Component Analysis) to the observation spectrograms generated by the first signal converting means and executing processing for removing zero or more unnecessary channels judged as corresponding to none of sound sources from the first separated results, wherein
the second signal converting means and the signal separating means execute only processing for signals after unnecessary channel removal and generate separated results.

13. A signal separating device according to claim 12, wherein the processing for applying an instantaneous mixing ICA to the observation spectrograms is processing for generating separated signals in the time-frequency domain from observation signals in the time-frequency domain and a separation matrix, correcting the separation matrix until the generated separated signals in the time-frequency domain and a separation matrix calculated by a multidimensional score function derived from a multidimensional probability density function nearly converge, and applying the corrected separation matrix to generate separated signals in the time-frequency domain.

14. A signal separating device that is inputted with signals formed by mixing plural signals and separates the signals into individual signals, the signal separating device comprising:
signal converting means for converting input signals into signals in the time-frequency domain and generating observation spectrograms; and
signal separating means for generating separated results from the observation spectrograms generated by the signal converting means, wherein
the signal separating means shifts the observation spectrograms in the frame direction, generates a set of shifted observation spectrograms (observation spectrogram shift set) formed by superimposing data having different shift amounts, respectively, and generates separated results according to processing for applying an instantaneous mixing ICA (Independent Component Analysis) to the generated observation spectrogram shift set.

15. A signal separating device according to claim 14, wherein the processing for applying an instantaneous mixing ICA to the observation spectrogram shift set is processing for generating separated signals in the time-frequency domain from observation signals in the time-frequency domain and a separation matrix, correcting the separation matrix until the generated separated signals in the time-frequency domain and a separation matrix calculated by a multidimensional score function derived from a multidimensional probability density function nearly converge, and applying the corrected separation matrix to generate separated signals in the time-frequency domain.

16. A signal separating device according to claim 14, wherein the signal separating means applies the instantaneous mixing ICA to the observation spectrogram shift set corresponding to plural channels formed by superimposing plural observation spectrogram shift sets generated in association with respective observation signals of plural signal input sources and generates separated results.

17. A signal separating device according to claim 14, wherein the signal separating means sets zero or a value close to zero in a gap generated in the shift or copies values at both ends of the observation spectrograms and sets the values in the gap and generates the observation spectrogram shift set.

18. A signal separating device according to claim 14, wherein the signal separating means executes circular shift processing for copying data at one end pushed out from the observation spectrograms to the other end.

19. A signal separating device according to claim 14, wherein the signal separating means generates plural shift data with a minimum shift amount set as 0 and a maximum shift amount set as the number of frame taps [L′] in generating separated results from observation signals and generates the observation spectrogram shift set formed by superimposing the generated data having different shift amounts.

20. A signal separating device according to claim 14, wherein the signal separating means changes the number of frame taps [L′] according to a frequency and generates the observation spectrogram shift set.

21. A signal separating device according to claim 14, wherein the signal separating means generates the first separated results according to processing for applying an instantaneous mixing ICA (Independent Component Analysis) to the observation spectrograms, executes processing for removing zero or more unnecessary channels judged as corresponding to none of sound sources from the first separated results, shifts observation spectrograms remaining after the removal processing in the frame direction to generate the observation spectrogram shift set, and applies the instantaneous mixing ICA to the generated the observation spectrogram shift set to generate separated results.

22. A signal separating device that is inputted with signals formed by mixing plural signals and separates the signals into individual signals, the signal separating device comprising:
signal converting means for converting input signals into signals in the time-frequency domain and generating observation spectrograms; and
signal separating means for generating separated results from the observation spectrograms generated by the signal converting means, wherein
the signal separating means generates separated results Y1 to Yn according to processing for applying an instantaneous mixing ICA (Independent Component Analysis) to the observation spectrograms, shifts signal spectrograms corresponding to the respective separated results Y1 to Yn in the frame direction, generates the observation spectrogram shift set formed by superimposing data having different shift amounts, respectively, executes reverberation removal processing according to processing for applying an instantaneous mixing ICA (Independent Component Analysis) to the generated the observation spectrogram shift set, and generates separated results, from which reverberation is removed, according to processing for reverberation-removed integrating spectrograms.

23. A signal separating device according to claim 22, wherein the processing for applying an instantaneous mixing ICA to the observation spectrograms is processing for generating separated signals in the time-frequency domain from observation signals in the time-frequency domain and a separation matrix, correcting the separation matrix until the generated separated signals in the time-frequency domain and a separation matrix calculated by a multidimensional score function derived from a multidimensional probability density function nearly converge, and applying the corrected separation matrix to generate separated signals in the time-frequency domain.

24. A signal separating method of inputting signals formed by mixing plural signals and separating the signals into individual signals in a signal separating device, the signal separating method comprising:
a signal converting step in which signal converting means converts input signals into signals in the time-frequency domain and generates observation spectrograms; and
a signal separating step in which signal separating means generates separated results from the observation spectrograms generated in the signal converting step, wherein
the signal separating step is a step of interpreting the observation spectrograms as observation signals subjected to convolutive mixtures in the time-frequency domain and generating separated results by executing processing for solving convolutive mixtures in the time-frequency domain.

25. A signal separating method according to claim 24, wherein the signal converting step is a step of executing processing for executing short-time Fourier transform (STFT) on the input signals to convert the input signals into signals in the time-frequency domain and generating observation spectrograms.

26. A signal separating method according to claim 24, wherein the signal separating step is a step of setting separated signals Y(t) of a frame number (t) as convolutive mixtures of observation signals X(t−L′) to X(t) and generating separated results according to processing for improving independence of respective individual signal components Y1(t) to Yn(t) included in the separated signals Y(t).

27. A signal separating method according to claim 26, wherein, in the signal separating step, separated results are generated by performing, as the processing for improving independence of the respective individual signal components Y1(t) to Yn(t) included in the separated signals Y(t), update processing for a separation matrix for applying Kullback-Leiblar information I(Y) as an independence measure and minimizing the Kullback-Leiblar information I(Y).

28. A signal separating method according to claim 24, wherein the signal separating step is a step of generating the first separated results according to processing for applying an instantaneous mixing ICA (Independent Component Analysis) to the observation spectrograms, executing processing for removing zero or more unnecessary channels judged as corresponding to none of sound sources from the first separated results, and executing processing for solving convolutive mixtures in the time-frequency domain on the observation spectrograms remaining after the removal processing to generate separated results.

29. A signal separating method according to claim 28, wherein the processing for applying an instantaneous mixing ICA to the observation spectrograms is processing for generating separated signals in the time-frequency domain from observation signals in the time-frequency domain and a separation matrix, correcting the separation matrix until the generated separated signal in the time-frequency domain and a separation matrix calculated by a multidimensional score function derived from a multidimensional probability density function nearly converge, and applying the corrected separation matrix to generate separated signals in the time-frequency domain.

30. A signal separating method of inputting signals formed by mixing plural signals and separating the signals into individual signals in a signal separating device, the signal separating method comprising:
a first signal converting step in which first signal converting means converts input signals into signals in the time-frequency domain and generates observation spectrograms;
a second signal converting step in which second signal converting means executes data conversion for the observation spectrograms generated in the first signal converting step and generates modulation spectrograms; and
a signal separating step in which signal separating means generates separated results from the modulation spectrograms generated in the second signal converting step, wherein
the signal separating step is a step of interpreting the modulation spectrograms as instantaneous mixtures and generating separated results.

31. A signal separating method according to claim 30, wherein the first signal converting step is a step of executing processing for executing short-time Fourier transform (STFT) on the input signals to convert the input signals into signals in the time-frequency domain and generating observation spectrograms.

32. A signal separating method according to claim 30, wherein the second signal converting step is a step of generating modulation spectrograms as results of executing short-time Fourier transform (STFT) in the temporal direction on the observation spectrograms, and
in the signal separating step, separated results are generated according to processing for improving independence of respective signal components Y1′ to Yn′ corresponding to separated signals included in the modulation spectrograms.

33. A signal separating method according to claim 32, wherein, in the signal separating step, separated results are generated by performing, as the processing for improving independence of the respective signal components Y1′ to Yn′ corresponding to the separated signals, update processing for a separation matrix for applying Kullback-Leiblar information as an independence measure and minimizing the Kullback-Leiblar information.

34. A signal separating method according to claim 30, further comprising an inverse Fourier transform step in which inverse Fourier transform means executes inverse Fourier transform on the respective signal components Y1′ to Yn′ corresponding to the separated signals obtained in the signal separating step and generates spectrograms Y1 to Yn corresponding to the separated signals.

35. A signal separating method according to claim 30, further comprising an unnecessary-channel removing step in which unnecessary-channel removing means generates the first separated results according to processing for applying an instantaneous mixing ICA (Independent Component Analysis) to the observation spectrograms generated by the first signal converting means and executing processing for removing zero or more unnecessary channels judged as corresponding to none of sound sources from the first separated results, wherein
the second signal converting means and the signal separating means execute only processing for signals after unnecessary channel removal and generate separated results.

36. A signal separating method according to claim 35, wherein the processing for applying an instantaneous mixing ICA to the observation spectrograms is processing for generating separated signals in the time-frequency domain from observation signals in the time-frequency domain and a separation matrix, correcting the separation matrix until the generated separated signals in the time-frequency domain and a separation matrix calculated by a multidimensional score function derived from a multidimensional probability density function nearly converge, and applying the corrected separation matrix to generate separated signals in the time-frequency domain.

37. A signal separating method of inputting a signal formed by mixing plural signals and separating the signals into individual signals, the signal separating method comprising:
a signal converting step in which signal converting means converts input signals into signals in the time-frequency domain and generates observation spectrograms; and
a signal separating step in which signal separating means generates separated results from the observation spectrograms generated in the signal converting step, wherein
the signal separating step is a step of shifting the observation spectrograms in the frame direction, generating the observation spectrogram shift set formed by superimposing data having different shift amounts, respectively, and generating separated results according to processing for applying an instantaneous mixing ICA (Independent Component Analysis) to the generated observation spectrogram shift set.

38. A signal separating method according to claim 37, wherein the processing for applying an instantaneous mixing ICA to the observation spectrogram shift set is processing for generating separated signals in the time-frequency domain from observation signals in the time-frequency domain and a separation matrix, correcting the separation matrix until the generated separated signals in the time-frequency domain and a separation matrix calculated by a multidimensional score function derived from a multidimensional probability density function nearly converge, and applying the corrected separation matrix to generate separated signals in the time-frequency domain.

39. A signal separating method according to claim 37, wherein, in the signal separating step, the instantaneous mixing ICA is applied to the observation spectrogram shift set corresponding to plural channels formed by superimposing plural observation spectrogram shift sets generated in association with respective observation signals of plural signal input sources and generates separated results.

40. A signal separating method according to claim 37, wherein, in the signal separating step, zero or a value close to zero is set in a gap generated in the shift or values at both ends of the observation spectrograms are copied and set in the gap and the observation spectrogram shift set is generated.

41. A signal separating method according to claim 37, wherein, in the signal separating step, cyclic shift processing for copying data at one end pushed out from the observation spectrograms to the other end is executed.

42. A signal separating method according to claim 37, wherein, in the signal separating step, plural shift data with a minimum shift amount set as 0 and a maximum shift amount set as the number of frame taps [L′] in generating separated results from observation signals are generated and the observation spectrogram shift set formed by superimposing the generated data having different shift amounts is generated.

43. A signal separating method according to claim 37, wherein, in the signal separating step, the number of frame taps [L′] is changed according to a frequency to generate the observation spectrogram shift set.

44. A signal separating method according to claim 37, wherein the signal separating step is a step of generating the first separated results according to processing for applying an instantaneous mixing ICA (Independent Component Analysis) to the observation spectrograms, executing processing for removing zero or more unnecessary channels judged as corresponding to none of sound sources from the first separated results, shifting observation spectrograms remaining after the removal processing in the frame direction to generate the observation spectrogram shift set, and applying the instantaneous mixing ICA to the generated observation spectrogram shift set to generate separated results.

45. A signal separating method of inputting signals formed by mixing plural signals and separating the signals into individual signals, the signal separating method comprising:
a signal converting step in which signal converting means converts input signals into signals in the time-frequency domain and generates observation spectrograms; and
a signal separating step in which signal separating means generates separated results from the observation spectrograms generated in the signal converting step, wherein
in the signal separating step, separated results Y1 to Yn are generated according to processing for applying an instantaneous ICA (Independent Component Analysis) to the observation spectrograms, signal spectrograms corresponding to the respective separated results Y1 to Yn are shifted in the frame direction, the observation spectrogram shift set formed by superimposing data having different shift amounts, respectively, is generated, reverberation removal processing is executed according to processing for applying an instantaneous mixing ICA (Independent Component Analysis) to the generated observation spectrogram shift set, and generates separated results, from which reverberation is removed, according to processing for reverberation-removed integrating spectrograms.

46. A signal separating method according to claim 45, wherein the processing for applying an instantaneous mixing ICA to the observation spectrograms is processing for generating separated signals in the time-frequency domain from observation signals in the time-frequency domain and a separation matrix, correcting the separation matrix until the generated separated signals in the time-frequency domain and a separation matrix calculated by a multidimensional score function derived from a multidimensional probability density function nearly converge, and applying the corrected separation matrix to generate separated signals in the time-frequency domain.

47. A computer program for causing a signal separating device to execute signal separation processing for inputting signals formed by mixing plural signals and separating the signals into individual signals, the computer program causing the signal separating device to execute:
a signal converting step of causing signal converting means to convert input signals into the time-frequency domain and generate observation spectrograms; and
a signal separating step of causing signal separating means to generate separated results from the observation spectrograms generated in the signal converting step, wherein
the signal separating step is a step of interpreting the observation spectrograms as observation signals subjected to convolutive mixtures in the time-frequency domain and generating separated results by executing processing for solving convolutive mixtures in the time-frequency domain.

48. A computer program for causing a signal separating device to execute signal separation processing for inputting signals formed by mixing plural signals and separating the signals into individual signals, the computer program causing the signal separating device to execute:
a first signal converting step of causing first signal converting means to convert input signals into signals in the time-frequency domain and generate observation spectrograms;
a second signal converting step of causing second signal converting means to execute data conversion for the observation spectrograms generated in the first signal converting step and generate modulation spectrograms; and
a signal separating step of causing signal separating means to generate separated results from the modulation spectrograms generated in the second signal converting step, wherein
the signal separating step is a step of interpreting the modulation spectrograms as instantaneous mixtures and generating separated results.

49. A computer program for causing a signal separating device to execute signal separation processing for inputting signals formed by mixing plural signals and separating the signals into individual signals, the computer program causing the signal separating device to execute:
a signal converting step of causing signal converting means to convert input signals into signals in the time-frequency domain and generate observation spectrograms; and
a signal separating step of causing signal separating means to generate separated results from the observation spectrograms generated in the signal converting step, wherein
the signal separating step is a step of shifting the observation spectrograms in the frame direction, generating the observation spectrogram shift set formed by superimposing data having different shift amounts, respectively, and generating separated results according to processing for applying an instantaneous mixing ICA (Independent Component Analysis) to the generated observation spectrogram shift set.

50. A signal separating device that is inputted with a signal formed by mixing plural signals and separates the signals into individual signals, the signal separating device comprising:
a signal converting unit that converts input signals into signals in the time-frequency domain and generates observation spectrograms; and
a signal separating unit that generates separated results from the observation spectrograms generated by the signal converting unit, wherein
the signal separating unit interprets the observation spectrograms as observation signals subjected to convolutive mixtures in the time-frequency domain and generates separated results by executing processing for solving convolutive mixtures in the time-frequency domain.

51. A signal separating device that is inputted with signals formed by mixing plural signals and separates the signals into individual signals, the signal separating device comprising:
a first signal converting unit that converts input signals into signals in the time-frequency domain and generates observation spectrograms;
a second signal converting unit that executes data conversion for the observation spectrograms generated by the first signal converting unit and generates modulation spectrograms; and
a signal separating unit that generates separated results from the modulation spectrograms generated by the second signal converting unit, wherein
the signal separating unit interprets the modulation spectrograms as instantaneous mixtures and generates separated results.

52. A signal separating device that is inputted with signals formed by mixing plural signals and separates the signals into individual signals, the signal separating device comprising:
a signal converting unit that converts input signals into signals in the time-frequency domain and generates observation spectrograms; and
a signal separating unit that generates separated results from the observation spectrograms generated by the signal converting unit, wherein
the signal separating unit shifts the observation spectrograms in the frame direction, generates the observation spectrogram shift set formed by superimposing data having different shift amounts, respectively, and generates separated results according to processing for applying an instantaneous mixing ICA (Independent Component Analysis) to the generated observation spectrogram shift set.

53. A signal separating device that is inputted with signal formed by mixing plural signals and separates the signals into individual signals, the signal separating device comprising:
a signal converting unit that converts input signals into signals in the time-frequency domain and generates observation spectrograms; and
a signal separating unit that generates separated results from the observation spectrograms generated by the signal converting unit, wherein
the signal separating unit generates separated results Y1 to Yn according to processing for applying an instantaneous mixing ICA (Independent Component Analysis) to the observation spectrograms, shifts signal spectrograms corresponding to the respective separated results Y1 to Yn in the frame direction, generates the observation spectrogram shift set formed by superimposing data having different shift amounts, respectively, executes reverberation removal processing according to processing for applying an instantaneous mixing ICA (Independent Component Analysis) to the generated observation spectrogram shift set, and generates separated results, from which reverberation is removed, according to processing for reverberation-removed integrating spectrograms.
